(19) United States
(12) Patent Application Publication
(10) Pub. No.: US 2025/0163343 A1
(43) Pub. Date: May 22, 2025

(54) FRAGRANCE COMPOSITIONS FOR SLEEP IMPROVEMENT

(71) Applicant: International Flavors & Fragrances Inc., New York, NY (US)

(72) Inventors: Laura Anne French, London (GB); Valéry Jean Paul Claude, The Hague (NL); Anshul Jain, Keyport, NJ (US); Matthias Horst Tabert, Hamburg (DE)

(21) Appl. No.: 18/841,634

(22) PCT Filed: Mar. 3, 2023
(86) PCT No.: PCT/US2023/014489

§ 371 Date: Aug. 26, 2024

Related U.S. Application Data
(60) Provisional application No. 63/316,496, filed on Mar. 4, 2022.

(51) Int. Cl. C11B 9/00

(52) U.S. Cl. CPC C11B 9/0092; C11B 9/0019; C11B 9/0049; C11B 9/008

(57) ABSTRACT

Provided herein are fragrance compositions comprising heteroatom musk compounds, and/or acyclic musk compound that elicit a sleep improvement in a subject from exposure to the fragrance compositions. Also provided are consumer products containing such fragrance compositions and methods of uses thereof.

### CROSS-REFERENCE TO RELATED APPLICATION

This application claims priority from U.S. provisional application No. 63/316,496, filed Mar. 4, 2022, the contents of which are hereby incorporated by reference in their entirety.

### FIELD OF THE INVENTION

The present disclosure relates to fragrance compositions, more specifically musk containing fragrance compositions, that elicit a sleep improvement in a subject from exposure to the fragrance compositions. The disclosure also relates to consumer products containing such fragrance compositions and methods of uses thereof.

### BACKGROUND OF THE INVENTION

Sleep deprivation and/or poor sleep quality is a modern-day challenge negatively impacting the overall global health and productivity of society. It has been reported that up to 84% of the global population have experience some form of sleep difficulties. The United States CDC (Centers for Disease Control and Prevention) recommends adults aged 18 years and older should get 7 or more hours of sleep per night, as good sleep is correlated to numerous benefits including better mood, appearance, immune health and cognitive/physical functions (e.g., concentration, memory, etc.). Unfortunately, in recent years (especially during the COVID pandemic) we have seen epidemic levels of people reporting problems with sleep deprivation and/or poor sleep quality. In fact, according to a study published in the Harvard Business Review poor sleep among the employees across 4 companies costs a combined lost in productivity of $54 million USD per year.

One common approach to address this problem involves taking prescription medication (e.g., Zolpidem sold as Ambien) and/or OTC (over the counter) drugs (e.g., melatonin supplements). Problems with these solutions may include: (i) real risk of abuse and addictions to the sleep-aid pill Ambien, (ii) adverse side-effects, (iii) limited access to melatonin on account of different regulatory regime (e.g., melatonin sold as OTC in United States and is only available with a prescription in other countries), and/or (iv) these pharma solutions tend to only address select sleep problems (e.g., Ambien treats insomnia while melatonin helps with sleep-wake cycle).

Another approach involves the use of aromatherapy solutions to influence the sleep patterns of consumers. Commonly used aromas include lavender, rose, ylang ylang, geranium, clary sage, neroli, marjoram and the like, which are widely known as essential oils that have a soothing effect (JP5019016B2, Takasago). However, the drawbacks of these natural oils may include: (i) that they each have a characteristic/distinctive aroma and their palatability across different consumers tend not to be universal leading another person nearby to experience aversion, irritation or the like, and/or (ii) essential oils tend to have varying degrees of efficacy. US 2021/0008082A1 (Takasago) discloses fragrance compositions useful for improving sleep that comprise at least one floral compound and at least one musk compound selected from Ambroxan®, Ambretone®, L-Muscone, Habanolide® and Musk T®. US 2020/0048578A1 (Givaudan SA) describes a method for preparing a perfume composition adapted to address sleep quality, wherein the composition comprises a long list of fragrance ingredients, including 0.01-50 wt % of at least one musk ingredient (B15) selected from Ambrettolide, Cashmeran®, Cosmone®, Cyclopentadecanolide, Ethylene Brassylate, Galaxolide®, Galaxolide S, Habanolide®, Muscenone, Musk C14, Serenolide®, Silvanone® Supra, Sylkolide® and Velvione®. These attempts have advocated the use of such musk compounds indiscriminately without regard to the classification of the musk compounds and/or their impacts on the sleep benefits. As results, these attempts, while disclosing the use of musk compounds in fragrance compositions for sleep quality, they do not teach the particular classes of musk compounds or levels of those classes of musk compounds to include for delivering the benefits of improvements to sleep quantity and/or quality.

Accordingly, there remains a need to identify fragrance compositions that effectively improve the quantity and/or quality of sleep of an individual, especially safely, is not a drug and/or is non-invasive. It is desirable that the fragrance compositions can be used in consumer products to improve the sleep benefits to a subject. The present disclosure addresses these and other needs as disclosed in further details below.

### SUMMARY OF THE INVENTION

The invention is based, inter alia, on the discovery that combinations of musk compounds, specifically heteroatom and/or acyclic musk compounds, can be formulated into fragrance compositions (possibly containing MCM and linear musk compounds, and/or additional heteroatom musk compounds) that deliver sleep improvement, preferably of at least one sleep benefit in a subject. It was also discovered that chemical compounds having certain backbone structures are useful for improving sleep. For example, compounds containing such backbones may improve one or more sleep benefits. Such compounds may be formulated in fragrance compositions that deliver a sleep improvement. Furthermore, the fragrance compositions of the present disclosure demonstrate improved sleep benefits in a novel olfactive direction (i.e., away from the traditional lavender) with no observable adverse effects and/or with high consumer acceptance for use alone or as part of a holistic sleep solution, for example when applied as a pillowcase spray in a nighttime routine.

In an aspect is provided a fragrance composition including one or more compounds having a backbone structure of formula (I):

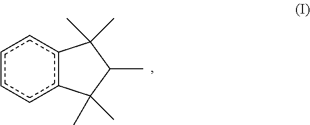

where each open position of the backbone structure is, independently, optionally substituted; [symbol] is a single bond or double bond; and the six-membered ring of formula (I) has 0-3 double bonds; and where the one or more compounds having the backbone structure of formula (I) are present at a total concentration of greater than 0.05 wt % of the total weight of the composition.

In an aspect is provided a fragrance composition for sleep improvement including one or more heteroatom musk compounds, wherein the one or more heteroatom musk compounds are present at a total concentration greater than 0.05 wt % of the total weight of the composition.

In an aspect is provided a fragrance composition for sleep improvement comprising at least 4 fragrance ingredients comprising: (i) at least 3 heteroatom musk compounds; and (ii) at least 1 acyclic musk compound, 7,7,8,9,9-pentamethyl-6,7,8,9-tetrahydro-5H-cyclopenta[h]quinazoline, or 2,2,6,6,7,8,8-heptamethyl-3a,5,6,7,8,8b-hexahydro-4H-indeno[4,5-d][1,3]dioxole. In an aspect is provided a fragrance composition for sleep improvement comprising at least 4 fragrance ingredients comprising: (i) at least 3 heteroatom musk compounds; and (ii) at least 1 acyclic musk compound or 7,7,8,9,9-pentamethyl-6,7,8,9-tetrahydro-5H-cyclopenta[h]quinazoline. The fragrance composition optionally comprises a solvent selected from Dipropylene glycol (DPG), isopropyl myristate, ethanol, triethyl citrate or combination thereof.

In another aspect, the present disclosure is directed to a consumer product comprising the fragrance composition as described herein, wherein the consumer product is an air care product, home care product, personal care product, a sanitary product, a pet care product, a fine fragrance, a hair care product or a beauty care product. In an aspect, the present disclosure is directed to a consumer product comprising the fragrance composition as described herein, wherein the consumer product is an air care product, home care product, a fabric care product, personal care product, a sanitary product, a pet care product, a fine fragrance, a hair care product or a beauty care product. In particular embodiments, the present disclosure relates to an air care product, wherein the fragrance composition is triggered released biometrically, preferably by the consumer's biometric readings. In some embodiments, the air care product containing the fragrance composition releases the fragrance composition in response to biometric readings, e.g., the consumer's biometric readings. In this way, for example, release of the fragrance composition is triggered by biometric data.

In yet another aspect, the present disclosure is directed to a method for improving at least one sleep benefit in a subject, wherein the method comprises: providing a fragrance composition as described herein or a consumer product as described herein to the subject in an amount effective to improve the at least one sleep benefit. Preferably, the fragrance composition or the consumer product is: (i) sprayed or applied onto a subject; (ii) sprayed or applied onto upholstery or fabric, preferably bedding, laundry, blanket or pillow-case; and/or (iii) dispersed or diffused into the air.

Thus, it is an advantage of the present disclosure to provide new design guidelines for formulating a fragrance composition intended for sleep improvement. In particular, the design guidelines identify select musk compounds intended to be formulated into a fragrance composition to provide one or more sleep benefits to a subject in need thereof by administering a fragrance composition disclosed herein to the subject in an amount effective to provide one or more of the sleep benefits. In embodiments, the design guidelines identify chemical compounds having backbone structures as described herein intended to be formulated into a fragrance composition to provide one or more sleep benefits to a subject in need thereof by administering a fragrance composition disclosed herein to the subject in an amount effective to provide one or more of the sleep benefits. It is yet a further advantage to be able to create new fragrance profiles for delivering improvements to sleep.

All parts, percentages and proportions referred to herein and in the claims are by weight unless otherwise indicated.

The values and dimensions disclosed herein are not to be understood as being strictly limited to the exact numerical values recited. Instead, unless otherwise specified, each such value is intended to mean both the recited value and a functionally equivalent range surrounding that value. For example, a value disclosed as “50%” is intended to mean “about 50%” or alternatively, for example, about +2%, +5%, +10% or +15% of that value.

The details of one or more aspects of the disclosure are set forth in the description below. Each of the aspects and embodiments described herein are capable of being used together, unless excluded either explicitly or clearly from the context of the embodiment or aspect. Other features, objects, and advantages of the disclosure will be apparent to those skilled in the art from the detailed description and the drawing.

### BRIEF DESCRIPTION OF THE DRAWING

While the specification concludes with claims particularly pointing out and distinctly claiming the invention, it is believed that the invention will be better understood from the following description of the accompanying figures wherein:

FIG. 1 shows a timetable of the overview design for the sleep monitoring studies described in Example 2.

FIG. 2 provides the bedtime questionnaire completed just before bedtime by the participants in the studies described in Example 2.

FIG. 3 provides the morning questionnaire completed once participants are fully awake in the studies described in Example 2.

FIGS. 4A and 4B provide the product use questionnaire completed by participants based on their experience of the product used in the prior nights in the studies described in Example 2.

FIG. 5 shows a timetable of the overview design for the sleep monitoring studies described in Example 4.

### DETAILED DESCRIPTION OF THE INVENTION

### Definitions

As used herein, articles such as “a” and “an” when used in a claim, are understood to mean one or more of what is claimed or described.

The terms “comprising”, “comprises” and “comprised of” as used herein are synonymous with “including”, “includes”, “containing”, “contains”, and grammatical variants thereof, are inclusive or open-ended and do not exclude additional, non-recited members, elements, or method steps. The terms “comprising”, “comprises” and “comprised of”, “including”, “includes” or “containing”, “contains”, and grammatical variants thereof also include the term “consisting of”.

As used herein, the term “acyclic musk compound” (ACM) refers to a class of synthetic musk compounds consisting of a single ring composed of 6 carbons or less. Non-limiting example of acyclic musk compound is Helvimor (i.e., Helvetolide®).

As used herein, the term “administering” refers to introducing or delivering to a subject a fragrance composition or fragrance compound to perform its intended function (e.g., aid in sleep). Administration can be by inhalation, smelling, and/or inbreathing. Administering or administration includes self-administration and the administration by another. In some embodiments, the administration may be by a device, e.g., a smart device.

As used herein, the term “bedtime” refers to the time at which a subject typically gets into bed in order to sleep.

As used herein, the term “biometrically measured or perceived” refers to statistically validated and rigorously executed in-context sleep studies designed and approved by sleep experts to measure sleep benefits based on biometric or self-reporting assessments.

As used herein, the term “deep sleep” refers to Stage N3 and/or Stage N4 sleep, i.e., the body is less responsive to outside stimulus, breathing slows, muscle relax, and heart rate becomes more regular. Deep sleep is reported both as absolute duration spent in deep sleep in minutes and as a percentage (on scale of 0-100) of the total sleep duration spent in deep sleep.

As used herein, the term “fragrance composition” refers to a mixture comprising one or more fragrance compounds for improving sleep benefits. In some embodiments, the fragrance composition consists of only the fragrance compounds for improving sleep benefits. In other embodiments, the fragrance composition comprises the fragrance compounds for improving sleep benefits and one or more other fragrance compounds, preferably in order to impart an olfactory note.

As used herein, the terms “fragrance material(s)”, “fragrance ingredient(s)” and “fragrance compound(s)” are used interchangeably and relate to a perfume raw material (“PRM”), or a mixture of perfume raw materials (“PRMs”), that are used to impart an overall pleasant odor or fragrance profile to a composition. “Fragrance materials” can encompass any suitable perfume raw materials for fragrance uses, including materials such as, for example, alcohols, aldehydes, ketones, esters, ethers, acetates, nitriles, terpene hydrocarbons, nitrogenous or sulfurous heterocyclic compounds and essential oils. However, naturally occurring plant and animal oils and exudates comprising complex mixtures of various chemical components are also known for use as “fragrance materials”. The individual perfume raw materials which comprise a known natural oil can be found by reference to Journals commonly used by those skilled in the art such as “Perfume and Flavourist” or “Journal of Essential Oil Research”, or listed in reference texts such as the book by S. Arctander, Perfume and Flavor Chemicals, 1969, Montclair, New Jersey, USA and more recently re-published by Allured Publishing Corporation Illinois (1994). Additionally, some perfume raw materials are supplied by the fragrance houses (Firmenich, International Flavors & Fragrances, Givaudan, Symrise) as mixtures in the form of proprietary specialty accords. Non-limiting examples of the fragrance materials useful herein include pro-fragrances such as acetal pro-fragrances, ketal pro-fragrances, ester pro-fragrances, hydrolyzable inorganic-organic pro-fragrances, and mixtures thereof. The fragrance materials may be released from the pro-fragrances in a number of ways. For example, the fragrance may be released as a result of simple hydrolysis, or by a shift in an equilibrium reaction, or by a pH-change, or by enzymatic release.

As used herein, the term “increase” with reference to sleep benefits means positive alterations by at least about 0.05% including but not limited to, positive alterations by about 0.05%, by about 0.5%, by about 1%, by about 2%, by about 5%, by about 10%, by about 25%, by about 30%, by about 50%, by about 75%, or by about 100%.

As used herein, the term “light sleep” refers to Stage N1 and/or Stage N2 sleep, when people become less aware of their surroundings, body temperature drops, breathing and heart rate become more regular. Light sleep is reported both as absolute duration spent in light sleep in minutes and as a percentage (on scale of 0-100) of the total sleep duration spent in light sleep.

As used herein, the term “macrocyclic musk compound” (MCM) refers to a class of synthetic musk compounds consisting of a single ring composed of more than 6 carbons (often 10-15 carbons). Non-limiting examples of macrocyclic musk compound includes: Ambretone®, Ambrettolide, Cosmone®, Cyclopentadecanolide, Ethylene Brassylate, Habanolide®, L-Muscone, Muscenone, Musk C14, Musk T®, Silvanone® Supra, and Velvione®.

As used herein, the term “heteroatom musk compound” (HMC) refers to a class of synthetic musk compounds consisting of a two or more rings comprising of carbons and/or heteroatoms (e.g., N, O). Non-limiting examples of heteroatom musk compound includes: Ambertonic™, Cashmeran®, and Nebulone.

As used herein, the term “reduce” with reference to sleep benefits means decrease and equivalent terminologies refer to decrease by at least about 0.05%, including but not limited to, decrease by about 0.05%, by about 0.5%, by about 1%, by about 2%, by about 5%, by about 10%, by about 25%, by about 30%, by about 50%, by about 75%, or by about 100%.

As used herein, the term “REM sleep” refers to Rapid Eye Movement (REM) sleep, i.e., the stage of sleep when most dreaming happens. During REM sleep, the muscles (except for the eye and breathing muscles) are actively paralyzed, heart rate increases, and breathing is more irregular. REM sleep is reported both as absolute duration spent in REM sleep in minutes and as a percentage (on scale of 0-100) of the total sleep duration spent in REM sleep.

As used herein, the term “sleep benefit” refers to one or more of the following: (1) improvement in biometrically measured or perceived sleep quality; (2) increase total sleep time; (3) decrease in wake after sleep onset (WASO); (4) decrease in proportion of time awake after sleep onset (% Wake); (5) increase in deep sleep (N3/N4) duration; (6) increase in proportion of time spent in deep sleep (N3/N4); (7) increase in REM sleep duration; (8) increase in proportion of time spent in REM Sleep; (9) increase in light sleep (N1/N2) duration; (10) increase in proportion of time spent in light sleep (N1/N2); (11) increase in sleep efficiency; (12) increase in sleep maintenance; (13) decrease in number of awakenings during sleep; (14) decrease in sleep onset; (15) increase in feeling of being well-rested; (15) increase in feeling of being refreshed upon awakening and/or after wakening; (16) increase in feeling of being recharged; (17) increase in feeling of being ready for the day; and (18) decrease in feeling of daytime sleepiness. Preferably, the sleep benefits arc biometrically measured or perceived.

As used herein, the term “sleep efficiency” refers to a percentage of time in bed spent asleep during the night. Sleep efficiency is calculated according to the formula and reported on a scale of 0-100:

$$Sleep efficiency = \frac{100 * total time asleep}{time in bed}$$

As used herein, the term “sleep maintenance” refers to the amount or percentage of time in bed spent asleep during the night after excluding the time for sleep onset from time in bed. Sleep maintenance is reported on a scale of 0-100.

As used herein, the term “sleep onset latency” refers to time taken to fall asleep. May also be simply referred to as sleep onset.

As used herein, the term “sleep quality” refers to responses by participants in a sleep study. The participants provide daily self-reports of sleep quality via questionnaires on a Likert scale of 1-10.

As used herein, the term “subject” refers to the user of the fragrance composition (or fragrance compound) and/or the intended recipient of the fragrance composition (or fragrance compound) when it is administered by another. The term “subject” refers to a human or non-human subject. Non-limiting examples of non-human subjects include non-human primates, dogs, cats, mice, rats, guinea pigs, rabbits, pigs, fowl, horses, cows, goats, sheep, cetaceans, etc.

As used herein, the term “substantially free” in reference to a material means that the indicated material is present in an amount of from 0 wt % to about 1 wt %, preferably from 0 wt % to about 0.5 wt %, or more preferably from 0 wt % to 0.2 wt %. The term “essentially free” means that the indicated material is present in an amount of from 0 wt % to about 0.1 wt %, preferably from 0 wt % to about 0.01 wt %, or more preferably it is not present at analytically detectable levels.

As used herein, the term “wake after sleep onset” (WASO) refers to the total duration of time spent awake during the night after initially falling asleep. WASO may also refer to the portion of time spent awake during the night after initially falling asleep (% Wake), which would then be reported as a percentage on a scale of 0-100.

As used herein, the terms “g,” “mg,” and “μg” refer to “gram,” “milligram,” and “microgram,” respectively. The terms “L” and “mL” refer to “liter” and “milliliter,” respectively.

As used herein, the terms “include”, “includes” and “including” are meant to be non-limiting.

All percentages are weight/weight percentages unless otherwise indicated. Except in the operating and comparative examples, or where otherwise explicitly indicated, all numbers in this description indicating amounts of material or conditions of reaction, physical properties of materials and/or use are to be understood as modified by the word “about”. Numerical ranges expressed in the format “from x to y” are understood to include x and y. When for a specific feature multiple preferred ranges are described in the form “from x to y”, it is understood that all ranges combining the different endpoints are also contemplated.

All of the features disclosed in this specification may be combined in any combination. Each feature disclosed in this specification may be replaced by an alternative feature serving the same, equivalent, or similar purpose. Thus, unless expressly stated otherwise, each feature disclosed is only an example of a generic series of equivalent or similar features.

It is understood that the test methods that are disclosed in the Test Methods Section of the present application must be used to determine the respective values of the parameters of the invention as described and claimed herein.

### Fragrance Compositions

Through the combination of neuroscience, consumer perception and the use of IFF's proprietary artificial intelligence tools, in partnership with a sleep expert to enhance in-context and biometric capabilities, the Applicant surprisingly discovered musk fragrance compositions that can improve sleep quantity and/or quality, and positively improve the lives of consumers suffering from sleep problems globally. In particular, Applicant has surprisingly discovered that fragrance compositions that adhere to a set of design guidelines for the inclusion of certain types of heteroatom and/or acyclic musk fragrance ingredients are useful in improving at least one or more sleep benefits. Applicants further surprisingly identified chemical compounds having certain backbone structures that are useful for improving sleep, e.g., improving one or more sleep benefits. Thus, in some embodiments, the fragrance composition includes compounds having a backbone structure useful for improving one or more sleep benefits. Because of the fragrance composition's pleasant odor profile, the fragrance compositions can be readily incorporated into consumer products for various applications.

In an aspect is provided a fragrance composition including one or more compounds having a backbone structure of formula (I):

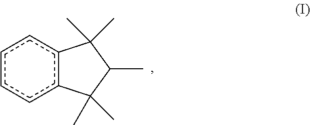

where each open position of the backbone structure is, independently, optionally substituted; [symbol] is a single bond or double bond; and the six-membered ring of formula (I) comprises 0-3 double bonds; and where the one or more compounds having the backbone structure of formula (I) are present at a total concentration greater than 0.05 wt % of the total weight of the composition. In some embodiments, each open position of the six-membered ring of the backbone structure of formula (I) is, independently, optionally substituted. In some embodiments, substitutions are present only on the six-membered ring. In some embodiments, all or a subset of the open positions of the six-membered ring of the backbone structure of formula (I) are substituted. In some embodiments, all or a subset of the open positions of the six-membered ring of the backbone structure of formula (I) are unsubstituted. In some embodiments, the one or more compounds having the backbone structure of formula (I) are present at a total concentration of at least 0.1 wt % of the total weight of the composition.

In some embodiments, the backbone structure of formula (I) is the structure of formula (II):

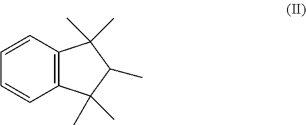

(pentamethyl indan (PMI)). In some embodiments, each open position of the backbone structure of formula (II) is, independently, optionally substituted. In some embodiments, all or a subset of the open positions of formula (II) are substituted. In some embodiments, all or a subset of the open positions of formula (II) are unsubstituted. In some embodiments, each open position of the six-membered ring of the backbone structure of formula (II) is, independently, optionally substituted. In some embodiments, substitutions are present only on the six-membered ring. In some embodiments, all or a subset of the open positions of the six-membered ring of the backbone structure of formula (II) arc substituted. In some embodiments, all or a subset of the open positions of the six-membered ring of the backbone structure of formula (II) are unsubstituted.

In some embodiments, the backbone structure of formula (I) is the structure of formula (III):

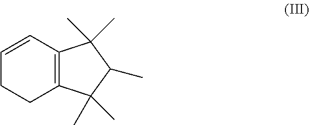

(dihydro pentamethyl indan (DHPMI)). In some embodiments, each open position of the backbone structure of formula (III) is, independently, optionally substituted. In some embodiments, all or a subset of the open positions of formula (III) are substituted. In some embodiments, all or a subset of the open positions of formula (III) are unsubstituted. In some embodiments, each open position of the six-membered ring of the backbone structure of formula (III) is, independently, optionally substituted. In some embodiments, substitutions are present only on the six-membered ring. In some embodiments, all or a subset of the open positions of the six-membered ring of the backbone structure of formula (III) are substituted. In some embodiments, all or a subset of the open positions of the six-membered ring of the backbone structure of formula (III) are unsubstituted.

In some embodiments, the backbone structure of formula (I) is the structure of formula (IV):

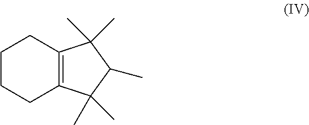

(tetrahydro pentamethyl indan (THPMI)). In some embodiments, each open position of the backbone structure of formula (IV) is, independently, optionally substituted. In some embodiments, all or a subset of the open positions of formula (IV) are substituted. In some embodiments, all or a subset of the open positions of formula (IV) are unsubstituted. In some embodiments, each open position of the six-membered ring of the backbone structure of formula (IV) is, independently, optionally substituted. In some embodiments, substitutions are present only on the six-membered ring. In some embodiments, all or a subset of the open positions of the six-membered ring of the backbone structure of formula (IV) are substituted. In some embodiments, all or a subset of the open positions of the six-membered ring of the backbone structure of formula (IV) are unsubstituted.

In some embodiments, the backbone structure of formula (I) is the structure of formula (V):

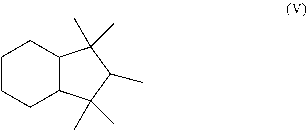

(hexahydro pentamethyl indan (HHPMI)). In some embodiments, each open position of the backbone structure of formula (V) is, independently, optionally substituted. In some embodiments, all or a subset of the open positions of formula (V) are substituted. In some embodiments, all or a subset of the open positions of formula (V) are unsubstituted. In some embodiments, each open position of the six-membered ring of the backbone structure of formula (V) is, independently, optionally substituted. In some embodiments, substitutions are present only on the six-membered ring. In some embodiments, all or a subset of the open positions of the six-membered ring of the backbone structure of formula (V) are substituted. In some embodiments, all or a subset of the open positions of the six-membered ring of the backbone structure of formula (V) are unsubstituted.

In some embodiments, when more than one compound having a backbone structure of formula (I) is present in the fragrance composition, each of the one or more compounds having the backbone structure of formula (I) in the fragrance composition has the same backbone structure of formula (I). For example, in some cases, each compound having the backbone structure of formula (I) in the fragrance composition has the backbone structure of one of formula (II), (III), (IV), or (V). In some embodiments, when more than one compound having a backbone structure of formula (I) is present in the fragrance composition, the compounds have different backbone structures. For example, in some cases, each of the two or more compounds has a different backbone structure of formula (I), e.g., two or more of formula (II), (III), (IV), or (V). Any mixture of compounds having the same or different backbone structures of formula (I) is contemplated herein.

In some embodiments, at least one of the one or more compounds having the backbone structure of formula (I) is a heteroatom musk compound. For example, in some embodiments, the compound having the backbone structure of formula (I) is substituted at an open position and the substitution is or includes a heteroatom. In some embodiments, the compound having the backbone structure of formula (I) is substituted at an open position on the six-membered ring and the substitution is or includes a heteroatom. In some embodiments, the heteroatom is oxygen or nitrogen. In some embodiments, the heteroatom is oxygen. In some embodiments, the heteroatom is nitrogen.

In some embodiments, the fragrance composition includes at least 2, 3, 4, or 5 compounds having the backbone structure of formula (I). In some embodiments, the fragrance composition includes at least 3 compounds having the backbone structure of formula (I). In some embodiments, the fragrance composition includes at least 4 compounds having the backbone structure of formula (I).

In some embodiments, the one or more compounds having the backbone structure of formula (I) are one or more of 7,7,8,9,9-pentamethyl-6,6a,7,8,9,9a-hexahydro-5H-cyclopenta[h]quinazoline; Indeno[4,5-d]-1,3-dioxin,4,4a,5,6,7,8,9,9b-octahydro-7,7,8,9,9-pentamethyl; 1,1,2,3,3-pentamethyl-2,5,6,7-tetrahydroinden-4-one; 7,7,8,9,9-pentamethyl-6,7,8,9-tetrahydro-5H-cyclopenta[h]quinazoline; 2,2,6,6,7,8,8-heptamethyl-3a,5,6,7,8,8b-hexahydro-4H-indeno[4,5-d][1,3]dioxole; 4,6,6,7,8,8-Hexamethyl-1,3,4,6,7,8-hexahydrocyclopenta[g]isochromene; 2,2,6,6,7,8,8-heptamethyldecahydro-2H-indeno[4,5-b]furan; 2,6,6,7,8,8-hexamethyldecahydro-2H-indeno[4,5-b]furan; or stereoisomers of any of the foregoing. In some embodiments, the one or more compounds having the backbone structure of formula (I) are one or more of 7,7,8,9,9-pentamethyl-6,6a,7,8,9,9a-hexahydro-5H-cyclopenta[h]quinazoline; Indeno[4,5-d]-1,3-dioxin,4,4a,5,6,7,8,9,9b-octahydro-7,7,8,9,9-pentamethyl; 1,1,2,3,3-pentamethyl-2,5,6,7-tetrahydroinden-4-one; 7,7,8,9,9-pentamethyl-6,7,8,9-tetrahydro-5H-cyclopenta[h]quinazoline; 2,2,6,6,7,8,8-heptamethyl-3a,5,6,7,8,8b-hexahydro-4H-indeno[4,5-d][1,3]dioxole; 4,6,6,7,8,8-Hexamethyl-1,3,4,6,7,8-hexahydrocyclopenta[g]isochromene; 2,2,6,6,7,8,8-heptamethyldecahydro-2H-indeno[4,5-b]furan; or stereoisomers of any of the foregoing. In some embodiments, the one or more compounds having the backbone structure of formula (I) are one or more of 7,7,8,9,9-pentamethyl-6,6a,7,8,9,9a-hexahydro-5H-cyclopenta[h]quinazoline; Indeno[4,5-d]-1,3-dioxin,4,4a,5,6,7,8,9,9b-octahydro-7,7,8,9,9-pentamethyl; 1,1,2,3,3-pentamethyl-2,5,6,7-tetrahydroinden-4-one; 7,7,8,9,9-pentamethyl-6,7,8,9-tetrahydro-5H-cyclopenta[h]quinazoline; 2,2,6,6,7,8,8-heptamethyl-3a,5,6,7,8,8b-hexahydro-4H-indeno[4,5-d][1,3]dioxole; 4,6,6,7,8,8-Hexamethyl-1,3,4,6,7,8-hexahydrocyclopenta[g]isochromene; or stereoisomers of any of the foregoing. In some embodiments, the one or more compounds having the backbone structure of formula (I) are one or more of 7,7,8,9,9-pentamethyl-6,6a,7,8,9,9a-hexahydro-5H-cyclopenta[h]quinazoline; Indeno[4,5-d]-1,3-dioxin,4,4a,5,6,7,8,9,9b-octahydro-7,7,8,9,9-pentamethyl; 1,1,2,3,3-pentamethyl-2,5,6,7-tetrahydroindan-4-one; 7,7,8,9,9-pentamethyl-6,7,8,9-tetrahydro-5H-cyclopenta[h]quinazoline; 2,2,6,6,7,8,8-heptamethyl-3a,5,6,7,8,8b-hexahydro-4H-indeno[4,5-d][1,3]dioxole; or stereoisomers of any of the foregoing. In some embodiments, the one or more compounds having the backbone structure of formula (I) are one or more of 7,7,8,9,9-pentamethyl-6,6a,7,8,9,9a-hexahydro-5H-cyclopenta[h]quinazoline; Indeno[4,5-d]-1,3-dioxin,4,4a,5,6,7,8,9,9b-octahydro-7,7,8,9,9-pentamethyl; 1,1,2,3,3-pentamethyl-2,5,6,7-tetrahydroinden-4-one; 7,7,8,9,9-pentamethyl-6,7,8,9-tetrahydro-5H-cyclopenta[h]quinazoline; or stereoisomers of any of the foregoing. In some embodiments, the one or more compounds having the backbone structure of formula (I) are one or more of 7,7,8,9,9-pentamethyl-6,6a,7,8,9,9a-hexahydro-5H-cyclopenta[h]quinazoline; Indeno[4,5-d]-1,3-dioxin,4,4a,5,6,7,8,9,9b-octahydro-7,7,8,9,9-pentamethyl; 1,1,2,3,3-pentamethyl-2,5,6,7-tetrahydroinden-4-one; or stereoisomers of any of the foregoing. In some embodiments, the one or more compounds having the backbone structure of formula (I) are one or more of 7,7,8,9,9-pentamethyl-6,6a,7,8,9,9a-hexahydro-5H-cyclopenta[h]quinazoline; Indeno[4,5-d]-1,3-dioxin,4,4a,5,6,7,8,9,9b-octahydro-7,7,8,9,9-pentamethyl; or stereoisomers of any of the foregoing. In some embodiments, the one or more compounds having the backbone structure of formula (I) include 7,7,8,9,9-pentamethyl-6,6a,7,8,9,9a-hexahydro-5H-cyclopenta[h]quinazoline (Ambertonic™) and/or stereoisomers thereof. In some embodiments, the one or more compounds having the backbone structure of formula (I) include Indeno[4,5-d]-1,3-dioxin,4,4a,5,6,7,8,9,9b-octahydro-7,7,8,9,9-pentamethyl (Nebulone®) and/or stereoisomers thereof. In some embodiments, the one or more compounds having the backbone structure of formula (I) include 1,1,2,3,3-pentamethyl-2,5,6,7-tetrahydroinden-4-one (Cashmeran®) and/or stereoisomers thereof. In some embodiments, the one or more compounds having the backbone structure of formula (I) are include 7,7,8,9,9-pentamethyl-6,7,8,9-tetrahydro-5H-cyclopenta[h]quinazoline (Sinfonide™) and/or stereoisomers thereof. In some embodiments, the one or more compounds having the backbone structure of formula (I) include 2,2,6,6,7,8,8-heptamethyl-3a,5,6,7,8,8b-hexahydro-4H-indeno[4,5-d][1,3]dioxole (Operanide™) and/or stereoisomers thereof. In some embodiments, the one or more compounds having the backbone structure of formula (I) include 4,6,6,7,8,8-Hexamethyl-1,3,4,6,7,8-hexahydrocyclopenta[g]isochromene (Galaxolide®) and/or stereoisomers thereof. In some embodiments, the one or more compounds having the backbone structure of formula (I) include 2,2,6,6,7,8,8-heptamethyldecahydro-2H-indeno[4,5-b]furan (Amber Xtreme™) and/or stereoisomers thereof. In some embodiments, the one or more compounds having the backbone structure of formula (I) include 2,6,6,7,8,8-hexamethyldecahydro-2H-indeno[4,5-b]furan (TrisAmber™) and/or stereoisomers thereof.

In some embodiments, the fragrance composition includes one or more compounds having the backbone structure of formula (I) at a total concentration of at least about 0.15, 0.2, 0.3, 0.4, 0.5, 1, 2, 3, 4, 5, 10, 20, 30, 40, 50, 60, 70, 80, 90 wt % or more or 100 wt % of the total weight of the composition. In some embodiments, the fragrance composition includes one or more compounds having the backbone structure of formula (I) at a total concentration of at least about 0.15 wt % or more of the total weight of the composition. In some embodiments, the fragrance composition includes one or more compounds having the backbone structure of formula (I) at a total concentration of at least about 0.2 wt % or more of the total weight of the composition. In some embodiments, the fragrance composition includes one or more compounds having the backbone structure of formula (I) at a total concentration of at least about 0.3 wt % or more of the total weight of the composition. In some embodiments, the fragrance composition includes one or more compounds having the backbone structure of formula (I) at a total concentration of at least about 0.4 wt % or more of the total weight of the composition. In some embodiments, the fragrance composition includes one or more compounds having the backbone structure of formula (I) at a total concentration of at least about 0.5 wt % or more of the total weight of the composition. In some embodiments, the fragrance composition includes one or more compounds having the backbone structure of formula (I) at a total concentration of at least about 1 wt % or more of the total weight of the composition. In some embodiments, the fragrance composition includes one or more compounds having the backbone structure of formula (I) at a total concentration of at least about 10 wt % or more of the total weight of the composition. In some embodiments, the fragrance composition includes one or more compounds having the backbone structure of formula (I) at a total concentration of at least about 40 wt % or more of the total weight of the composition. In some embodiments, the fragrance composition includes one or more compounds having the backbone structure of formula (I) at a total concentration of at least about 50 wt % or more of the total weight of the composition. In some embodiments, the fragrance composition includes one or more compounds having the backbone structure of formula (I) at a total concentration of at least about 75 wt % or more of the total weight of the composition. In some embodiments, the fragrance composition includes one or more compounds having the backbone structure of formula (I) at a total concentration of at least about 90 wt % or more of the total weight of the composition.

In some embodiments, the fragrance composition includes one or more compounds having the backbone structure of formula (I) at a total concentration in the range of about 0.1 wt % to about 100 wt % of the total weight of the composition. In some embodiments, the fragrance composition includes one or more compounds having the backbone structure of formula (I) at a total concentration in the range of about 0.5 wt % to about 100 wt % of the total weight of the composition. In some embodiments, the fragrance composition includes one or more compounds having the backbone structure of formula (I) at a total concentration in the range of about 1 wt % to about 100 wt % of the total weight of the composition. In some embodiments, the fragrance composition includes one or more compounds having the backbone structure of formula (I) at a total concentration in the range of about 5 wt % to about 100 wt % of the total weight of the composition. In some embodiments, the fragrance composition includes one or more compounds having the backbone structure of formula (I) at a total concentration in the range of about 10 wt % to about 100 wt % of the total weight of the composition. In some embodiments, the fragrance composition includes one or more compounds having the backbone structure of formula (I) at a total concentration in the range of about 25 wt % to about 100 wt % of the total weight of the composition. In some embodiments, the fragrance composition includes one or more compounds having the backbone structure of formula (I) at a total concentration in the range of about 50 wt % to about 100 wt % of the total weight of the composition. In some embodiments, the fragrance composition includes one or more compounds having the backbone structure of formula (I) at a total concentration in the range of about 75 wt % to about 100 wt % of the total weight of the composition. In some embodiments, the fragrance composition includes one or more compounds having the backbone structure of formula (I) at a total concentration in the range of about 90 wt % to about 100 wt % of the total weight of the composition. In some embodiments, the fragrance composition includes one or more compounds having the backbone structure of formula (I) at a total concentration in the range of about 95 wt % to about 100 wt % of the total weight of the composition.

In some embodiments, the fragrance composition includes one or more compounds having the backbone structure of formula (I) at a total concentration in the range of about 0.1 wt % to about 95 wt % of the total weight of the composition. In some embodiments, the fragrance composition includes one or more compounds having the backbone structure of formula (I) at a total concentration in the range of about 0.1 wt % to about 90 wt % of the total weight of the composition. In some embodiments, the fragrance composition includes one or more compounds having the backbone structure of formula (I) at a total concentration in the range of about 0.1 wt % to about 75 wt % of the total weight of the composition. In some embodiments, the fragrance composition includes one or more compounds having the backbone structure of formula (I) at a total concentration in the range of about 0.1 wt % to about 50 wt % of the total weight of the composition. In some embodiments, the fragrance composition includes one or more compounds having the backbone structure of formula (I) at a total concentration in the range of about 0.1 wt % to about 25 wt % of the total weight of the composition. In some embodiments, the fragrance composition includes one or more compounds having the backbone structure of formula (I) at a total concentration in the range of about 0.1 wt % to about 10 wt % of the total weight of the composition. In some embodiments, the fragrance composition includes one or more compounds having the backbone structure of formula (I) at a total concentration in the range of about 0.1 wt % to about 5 wt % of the total weight of the composition. In some embodiments, the fragrance composition includes one or more compounds having the backbone structure of formula (I) at a total concentration in the range of about 0.1 wt % to about 1 wt % of the total weight of the composition. In some embodiments, the fragrance composition includes one or more compounds having the backbone structure of formula (I) at a total concentration in the range of about 0.1 wt % to about 0.5 wt % of the total weight of the composition.

In an aspect is provided a fragrance composition for sleep improvement including one or more heteroatom musk compounds, wherein the one or more heteroatom musk compounds are present at a total concentration greater than 0.05 wt % of the total weight of the composition. In some embodiments, the one or more heteroatom musk compounds are present at a total concentration of at least 0.1 wt % of the total weight of the composition. In some embodiments, the heteroatom is oxygen. In some embodiments, the heteroatom is nitrogen. In some embodiments, the fragrance composition includes at least 2, 3, 4, or 5 heteroatom musk compounds. In some embodiments, the fragrance composition includes at least 3 heteroatom musk compounds. In some embodiments, the fragrance composition includes at least 4 heteroatom musk compounds.

In some embodiments, at least one of the one or more heteroatom musk compounds comprises a backbone structure of formula (I), described above, where each open position of said backbone structure is, independently, optionally substituted; [symbol] is a single bond or double bond; and the six-membered ring of formula (I) comprises 0-3 double bonds. In some embodiments, the open positions of the six-membered ring of the backbone structure of formula (I) are, independently, optionally substituted. In some embodiments, all or a subset of the open positions of the six-membered ring of the backbone structure of formula (I) are substituted. In some embodiments, all or a subset of the open positions of the six-membered ring of the backbone structure of formula (I) are unsubstituted. In some embodiments, the backbone structure of formula (I) is any one of formula (II) (PMI), formula (III) (DHPMI), formula (IV) (THPMI), or formula (V) (HHPMI), e.g., as described above. In some embodiments, at least 2, 3, 4, or 5 of the one more heteroatom musk compounds have the backbone structure of formula (I). In some embodiments, at least 3 heteroatom musk compounds have the backbone structure of formula (I). In some embodiments, at least 4 heteroatom musk compounds have the backbone structure of formula (I).

In some embodiments, the one or more heteroatom musk compounds are one or more of 7,7,8,9,9-pentamethyl-6,6a,7,8,9,9a-hexahydro-5H-cyclopenta[h]quinazoline; Indeno[4,5-d]-1,3-dioxin,4,4a,5,6,7,8,9,9b-octahydro-7,7,8,9,9-pentamethyl; 1,1,2,3,3-pentamethyl-2,5,6,7-tetrahydroinden-4-one; 7,7,8,9,9-pentamethyl-6,7,8,9-tetrahydro-5H-cyclopenta[h]quinazoline; 2,2,6,6,7,8,8-heptamethyl-3a,5,6,7,8,8b-hexahydro-4H-indeno[4,5-d][1,3]dioxole; 4,6,6,7,8,8-Hexamethyl-1,3,4,6,7,8-hexahydrocyclopenta[g]isochromene; 2,2,6,6,7,8,8-heptamethyldecahydro-2H-indeno[4,5-b]furan; 2,6,6,7,8,8-hexamethyldecahydro-2H-indeno[4,5-b]furan; or stereoisomers of any of the foregoing. In some embodiments, the one or more heteroatom musk compounds are one or more of 7,7,8,9,9-pentamethyl-6,6a,7,8,9,9a-hexahydro-5H-cyclopenta[h]quinazoline; Indeno[4,5-d]-1,3-dioxin,4,4a,5,6,7,8,9,9b-octahydro-7,7,8,9,9-pentamethyl; 1,1,2,3,3-pentamethyl-2,5,6,7-tetrahydroinden-4-one; 7,7,8,9,9-pentamethyl-6,7,8,9-tetrahydro-5H-cyclopenta[h]quinazoline; 2,2,6,6,7,8,8-heptamethyl-3a,5,6,7,8,8b-hexahydro-4H-indeno[4,5-d][1,3]dioxole; 4,6,6,7,8,8-Hexamethyl-1,3,4,6,7,8-hexahydrocyclopenta[g]isochromene; 2,2,6,6,7,8,8-heptamethyldecahydro-2H-indeno[4,5-b]furan; or stereoisomers of any of the foregoing. In some embodiments, the one or more heteroatom musk compounds arc one or more of 7,7,8,9,9-pentamethyl-6,6a,7,8,9,9a-hexahydro-5H-cyclopenta[h]quinazoline; Indeno[4,5-d]-1,3-dioxin,4,4a,5,6,7,8,9,9b-octahydro-7,7,8,9,9-pentamethyl; 1,1,2,3,3-pentamethyl-2,5,6,7-tetrahydroinden-4-one; 7,7,8,9,9-pentamethyl-6,7,8,9-tetrahydro-5H-cyclopenta[h]quinazoline; 2,2,6,6,7,8,8-heptamethyl-3a,5,6,7,8,8b-hexahydro-4H-indeno[4,5-d][1,3]dioxole; 4,6,6,7,8,8-Hexamethyl-1,3,4,6,7,8-hexahydrocyclopenta[g]isochromene; or stereoisomers of any of the foregoing. In some embodiments, the one or more heteroatom musk compounds are one or more of 7,7,8,9,9-pentamethyl-6,6a,7,8,9,9a-hexahydro-5H-cyclopenta[h]quinazoline; Indeno[4,5-d]-1,3-dioxin,4,4a,5,6,7,8,9,9b-octahydro-7,7,8,9,9-pentamethyl; 1,1,2,3,3-pentamethyl-2,5,6,7-tetrahydroinden-4-one; 7,7,8,9,9-pentamethyl-6,7,8,9-tetrahydro-5H-cyclopenta[h]quinazoline; 2,2,6,6,7,8,8-heptamethyl-3a,5,6,7,8,8b-hexahydro-4H-indeno[4,5-d][1,3]dioxole; or stereoisomers of any of the foregoing. In some embodiments, the one or more heteroatom musk compounds are one or more of 7,7,8,9,9-pentamethyl-6,6a,7,8,9,9a-hexahydro-5H-cyclopenta[h]quinazoline; Indeno[4,5-d]-1,3-dioxin,4,4a,5,6,7,8,9,9b-octahydro-7,7,8,9,9-pentamethyl; 1,1,2,3,3-pentamethyl-2,5,6,7-tetrahydroinden-4-one; 7,7,8,9,9-pentamethyl-6,7,8,9-tetrahydro-5H-cyclopenta[h]quinazoline; or stereoisomers of any of the foregoing. In some embodiments, the one or more heteroatom musk compounds are one or more of 7,7,8,9,9-pentamethyl-6,6a,7,8,9,9a-hexahydro-5H-cyclopenta[h]quinazoline; Indeno[4,5-d]-1,3-dioxin,4,4a,5,6,7,8,9,9b-octahydro-7,7,8,9,9-pentamethyl; 1,1,2,3,3-pentamethyl-2,5,6,7-tetrahydroinden-4-one; or stereoisomers of any of the foregoing. In some embodiments, the one or more heteroatom musk compounds are one or more of 7,7,8,9,9-pentamethyl-6,6a,7,8,9,9a-hexahydro-5H-cyclopenta[h]quinazoline; Indeno[4,5-d]-1,3-dioxin,4,4a,5,6,7,8,9,9b-octahydro-7,7,8,9,9-pentamethyl; or stereoisomers of any of the foregoing. In some embodiments, the one or more heteroatom musk compounds include 7,7,8,9,9-pentamethyl-6,6a,7,8,9,9a-hexahydro-5H-cyclopenta[h]quinazoline and/or stereoisomers thereof. In some embodiments, the one or more heteroatom musk compounds include Indeno[4,5-d]-1,3-dioxin,4,4a,5,6,7,8,9,9b-octahydro-7,7,8,9,9-pentamethyl and/or stereoisomers thereof. In some embodiments, the one or more heteroatom musk compounds include 1,1,2,3,3-pentamethyl-2,5,6,7-tetrahydroinden-4-one and/or stereoisomers thereof. In some embodiments, the one or more heteroatom musk compounds include 7,7,8,9,9-pentamethyl-6,7,8,9-tetrahydro-5H-cyclopenta[h]quinazoline and/or stereoisomers thereof. In some embodiments, the one or more heteroatom musk compounds include 2,2,6,6,7,8,8-heptamethyl-3a,5,6,7,8,8b-hexahydro-4H-indeno[4,5-d][1,3]dioxole and/or stereoisomers thereof. In some embodiments, the one or more heteroatom musk compounds include 4,6,6,7,8,8-Hexamethyl-1,3,4,6,7,8-hexahydrocyclopenta[g]isochromene and/or stereoisomers thereof. In some embodiments, the one or more heteroatom musk compounds include 2,2,6,6,7,8,8-heptamethyldecahydro-2H-indeno[4,5-b]furan and/or stereoisomers thereof. In some embodiments, the one or more heteroatom musk compounds include 2,6,6,7,8,8-hexamethyldecahydro-2H-indeno[4,5-b]furan and/or stereoisomers thereof.

In some embodiments, the fragrance composition includes one or more heteroatom musk compounds at a total concentration of at least about 0.15, 0.2, 0.3, 0.4, 0.5, 1, 2, 3, 4, 5, 10, 20, 30, 40, 50, 60, 70, 80, 90, or 100 wt % or more of the total weight of the composition. In some embodiments, the fragrance composition includes one or more heteroatom musk compounds at a total concentration of at least about 0.15 wt % or more of the total weight of the composition. In some embodiments, the fragrance composition includes one or more heteroatom musk compounds at a total concentration of at least about 0.2 wt % or more of the total weight of the composition. In some embodiments, the fragrance composition includes one or more heteroatom musk compounds at a total concentration of at least about 0.3 wt % or more of the total weight of the composition. In some embodiments, the fragrance composition includes one or more heteroatom musk compounds at a total concentration of at least about 0.4 wt % or more of the total weight of the composition. In some embodiments, the fragrance composition includes one or more compounds heteroatom musk compounds at a total concentration of at least about 0.5 wt % or more of the total weight of the composition. In some embodiments, the fragrance composition includes one or more heteroatom musk compounds at a total concentration of at least about 1 wt % or more of the total weight of the composition. In some embodiments, the fragrance composition includes one or more heteroatom musk compounds at a total concentration of at least about 10 wt % or more of the total weight of the composition. In some embodiments, the fragrance composition includes one or more heteroatom musk compounds at a total concentration of at least about 40 wt % or more of the total weight of the composition. In some embodiments, the fragrance composition includes one or more heteroatom musk compounds at a total concentration of at least about 50 wt % or more of the total weight of the composition.

In some embodiments, the fragrance composition includes one or more heteroatom musk compounds at a total concentration in the range of about 0.1 wt % to about 100 wt % of the total weight of the composition. In some embodiments, the fragrance composition includes one or more heteroatom musk compounds at a total concentration in the range of about 0.5 wt % to about 100 wt % of the total weight of the composition. In some embodiments, the fragrance composition includes one or more heteroatom musk compounds at a total concentration in the range of about 1 wt % to about 100 wt % of the total weight of the composition. In some embodiments, the fragrance composition includes one or more heteroatom musk compounds at a total concentration in the range of about 5 wt % to about 100 wt % of the total weight of the composition. In some embodiments, the fragrance composition includes one or more heteroatom musk compounds at a total concentration in the range of about 10 wt % to about 100 wt % of the total weight of the composition. In some embodiments, the fragrance composition includes one or more heteroatom musk compounds at a total concentration in the range of about 25 wt % to about 100 wt % of the total weight of the composition. In some embodiments, the fragrance composition includes one or more heteroatom musk compounds at a total concentration in the range of about 50 wt % to about 100 wt % of the total weight of the composition. In some embodiments, the fragrance composition includes one or more heteroatom musk compounds at a total concentration in the range of about 75 wt % to about 100 wt % of the total weight of the composition. In some embodiments, the fragrance composition includes one or more heteroatom musk compounds at a total concentration in the range of about 90 wt % to about 100 wt % of the total weight of the composition. In some embodiments, the fragrance composition includes one or more heteroatom musk compounds at a total concentration in the range of about 95 wt % to about 100 wt % of the total weight of the composition.

In some embodiments, the fragrance composition includes one or more heteroatom musk compounds at a total concentration in the range of about 0.1 wt % to about 95 wt % of the total weight of the composition. In some embodiments, the fragrance composition includes one or more heteroatom musk compounds at a total concentration in the range of about 0.1 wt % to about 90 wt % of the total weight of the composition. In some embodiments, the fragrance composition includes one or more heteroatom musk compounds at a total concentration in the range of about 0.1 wt % to about 75 wt % of the total weight of the composition. In some embodiments, the fragrance composition includes one or more heteroatom musk compounds at a total concentration in the range of about 0.1 wt % to about 50 wt % of the total weight of the composition. In some embodiments, the fragrance composition includes one or more heteroatom musk compounds at a total concentration in the range of about 0.1 wt % to about 25 wt % of the total weight of the composition. In some embodiments, the fragrance composition includes one or more heteroatom musk compounds at a total concentration in the range of about 0.1 wt % to about 10 wt % of the total weight of the composition. In some embodiments, the fragrance composition includes one or more heteroatom musk compounds at a total concentration in the range of about 0.1 wt % to about 5 wt % of the total weight of the composition. In some embodiments, the fragrance composition includes one or more heteroatom musk compounds at a total concentration in the range of about 0.1 wt % to about 1 wt % of the total weight of the composition. In some embodiments, the fragrance composition includes one or more heteroatom musk compounds at a total concentration in the range of about 0.1 wt % to about 0.5 wt % of the total weight of the composition.

In some embodiments, the fragrance compositions for sleep improvement described herein further comprise an acyclic musk compound. In some embodiments, the fragrance composition includes at least one acyclic musk compound. In some embodiments, the acyclic musk compound is a linear musk compound. In some embodiments, the acyclic musk compound is present at a total concentration of at least or about 0.0025 wt % of the total weight of the composition. In some embodiments, the acyclic musk compound is present at a total concentration of at least or about 0.01 wt % of the total weight of the composition. In some embodiments, the acyclic musk compound is present at a total concentration of at least or about 0.1 wt % of the total weight of the composition. In some embodiments, the acyclic musk compound is present at a total concentration of at least or about 0.5 wt % of the total weight of the composition. In some embodiments, the acyclic musk compound is present at a total concentration of at least or about 1 wt % of the total weight of the composition. In some embodiments, the acyclic musk compound is present at a total concentration of at least or about 5 wt % of the total weight of the composition. In some embodiments, the acyclic musk compound is present at a total concentration of at least or about 10 wt % of the total weight of the composition. In some embodiments, the acyclic musk compound is present at a total concentration of at least or about 20 wt % of the total weight of the composition. In some embodiments, the acyclic musk compound is present at a total concentration of at least or about 30 wt % of the total weight of the composition. In some embodiments, the acyclic musk compound is present at a total concentration of at least or about 40 wt % of the total weight of the composition. In some embodiments, the acyclic musk compound is present at a total concentration of at least or about 50 wt % of the total weight of the composition.

In some embodiments, the acyclic musk is one or more of:

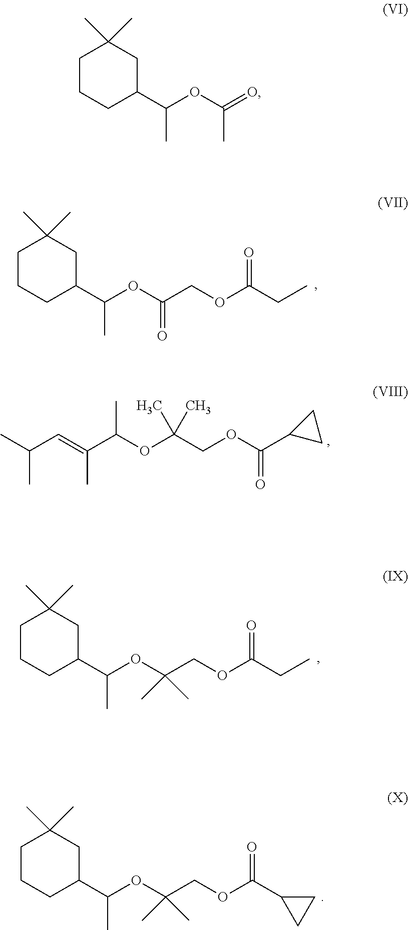

In some embodiments, the acyclic musk compound is the compound of formula (VI). In some embodiments, the acyclic musk compound is the compound of formula (VII). In some embodiments, the acyclic musk compound is the compound of formula (VIII). In some embodiments, the acyclic musk compound is the compound of formula (IX). In some embodiments, the acyclic musk compound is the compound of formula (X). In some embodiments, the acyclic musk compound is 1-Propanol, 2-[1-(3,3-dimethylcyclohexyl)ethoxy]-2-methyl-, 1-propanoate (Helvimor™). In some embodiments, the acyclic musk compound is 1-(3,3-dimethylcyclohexyl)ethyl acetate (Rosamusk™). In some embodiments, the acyclic musk compound is 2-(1-(3,3-dimethylcyclohexyl)ethoxy)-2-oxoethyl propionate (Romanolide®). In some embodiments, the acyclic musk compound is 2-(1-(3,3-dimethylcyclohexyl)ethoxy)-2-methylpropyl cyclopropanecarboxylate (Serenolide®). In some embodiments, the acyclic musk compound is 2-((3,5-dimethylhex-3-en-2-yl)oxy)-2-methylpropyl cyclopropanecarboxylate (Sylkolide®).

In some embodiments, the acyclic musk compound is present at a mass ratio to the one or more of heteroatom musk compounds. In some embodiments, the acyclic musk compound is present at a mass ratio to the one or more compounds comprising the backbone structure of formula (I). In some embodiments, the mass ratio is between about 55:1 to 45:1. In some embodiments, the mass ratio between about 54:1 to 46:1. In some embodiments, the mass ratio between about 53:1 to 46:1. In some embodiments, the mass ratio between about 52:1 to 47:1.

In some embodiments, the fragrance composition includes 1,1,2,3,3-pentamethyl-2,5,6,7-tetrahydroinden-4-one at a concentration of at least or about 0.01, 0.02, 0.05, 0.1, 0.2, 0.3, 0.4, 0.5, 1, 2, 3, 4, 5, 10, 15, or 20 wt %. In some embodiments, the fragrance composition includes 1,1,2,3,3-pentamethyl-2,5,6,7-tetrahydroinden-4-one at a concentration of at least or about 0.01 wt %. In some embodiments, the fragrance composition includes 1,1,2,3,3-pentamethyl-2,5,6,7-tetrahydroinden-4-one at a concentration of at least or about 0.0125 wt %. In some embodiments, the fragrance composition includes 1,1,2,3,3-pentamethyl-2,5,6,7-tetrahydroinden-4-one at a concentration of at least or about 0.015 wt %. In some embodiments, the fragrance composition includes 1,1,2,3,3-pentamethyl-2,5,6,7-tetrahydroinden-4-one at a concentration of at least or about 0.02 wt %. In some embodiments, the fragrance composition includes 1,1,2,3,3-pentamethyl-2,5,6,7-tetrahydroinden-4-one at a concentration of at least or about 0.25 wt %. In some embodiments, the fragrance composition includes 1,1,2,3,3-pentamethyl-2,5,6,7-tetrahydroinden-4-one at a concentration of at least or about 0.05 wt %. In some embodiments, the fragrance composition includes 1,1,2,3,3-pentamethyl-2,5,6,7-tetrahydroinden-4-one at a concentration of at least or about 1 wt %. In some embodiments, the fragrance composition includes 1,1,2,3,3-pentamethyl-2,5,6,7-tetrahydroinden-4-one at a concentration of at least or about 5 wt %. In some embodiments, the fragrance composition includes 1,1,2,3,3-pentamethyl-2,5,6,7-tetrahydroinden-4-one at a concentration of at least or about 10 wt %. In some embodiments, the fragrance composition includes 1,1,2,3,3-pentamethyl-2,5,6,7-tetrahydroinden-4-one at a concentration of at least or about 15 wt %. In some embodiments, the fragrance composition includes 1,1,2,3,3-pentamethyl-2,5,6,7-tetrahydroinden-4-one at a concentration of at least or about 20 wt %.

In some embodiments, the fragrance composition includes 7,7,8,9,9-pentamethyl-6,6a, 7,8,9,9a-hexahydro-5H-cyclopenta[h]quinazoline at a concentration of at least or about 0.01, 0.02, 0.05, 0.1, 0.2, 0.3, 0.4, 0.5, 1, 5, 10, 20, 30, 40, or 50 wt %. In some embodiments, the fragrance composition includes 7,7,8,9,9-pentamethyl-6,6a,7,8,9,9a-hexahydro-5H-cyclopenta[h]quinazoline at a concentration of at least or about 0.05 wt %. In some embodiments, the fragrance composition includes 7,7,8,9,9-pentamethyl-6,6a,7,8,9,9a-hexahydro-5H-cyclopenta[h]quinazoline at a concentration of at least or about 1 wt %. In some embodiments, the fragrance composition includes 7,7,8,9,9-pentamethyl-6,6a,7,8,9,9a-hexahydro-5H-cyclopenta[h]quinazoline at a concentration of at least or about 5 wt %. In some embodiments, the fragrance composition includes 7,7,8,9,9-pentamethyl-6,6a,7,8,9,9a-hexahydro-5H-cyclopenta[h]quinazoline at a concentration of at least or about 10 wt %. In some embodiments, the fragrance composition includes 7,7,8,9,9-pentamethyl-6,6a,7,8,9,9a-hexahydro-5H-cyclopenta[h]quinazoline at a concentration of at least or about 20 wt %. In some embodiments, the fragrance composition includes 7,7,8,9,9-pentamethyl-6,6a,7,8,9,9a-hexahydro-5H-cyclopenta[h]quinazoline at a concentration of at least or about 50 wt %.

In some embodiments, the fragrance composition includes Indeno[4,5-d]-1,3-dioxin,4,4a,5,6,7,8,9,9b-octahydro-7,7,8,9,9-pentamethyl at a concentration of at least or about 0.01, 0.02, 0.05, 0.1, 0.2, 0.3, 0.4, 0.5, 1, 5, 10, 20, 30, 40, or 50 wt %. In some embodiments, the fragrance composition includes Indeno[4,5-d]-1,3-dioxin,4,4a,5,6,7,8,9,9b-octahydro-7,7,8,9,9-pentamethyl at a concentration of at least or about 0.05 wt %. In some embodiments, the fragrance composition includes Indeno[4,5-d]-1,3-dioxin,4,4a,5,6,7,8,9,9b-octahydro-7,7,8,9,9-pentamethyl at a concentration of at least or about 1 wt %. In some embodiments, the fragrance composition includes Indeno[4,5-d]-1,3-dioxin,4,4a,5,6,7,8,9,9b-octahydro-7,7,8,9,9-pentamethyl at a concentration of at least or about 5 wt %. In some embodiments, the fragrance composition includes Indeno[4,5-d]-1,3-dioxin,4,4a,5,6,7,8,9,9b-octahydro-7,7,8,9,9-pentamethyl at a concentration of at least or about 10 wt %. In some embodiments, the fragrance composition includes Indeno[4,5-d]-1,3-dioxin,4,4a,5,6,7,8,9,9b-octahydro-7,7,8,9,9-pentamethyl at a concentration of at least or about 20 wt %. In some embodiments, the fragrance composition includes Indeno[4,5-d]-1,3-dioxin,4,4a,5,6,7,8,9,9b-octahydro-7,7,8,9,9-pentamethyl at a concentration of at least or about 50 wt %.

In some embodiments, the fragrance composition includes (a) 1,1,2,3,3-pentamethyl-2,5,6,7-tetrahydroinden-4-one, (b) 7,7,8,9,9-pentamethyl-6,6a,7,8,9,9a-hexahydro-5H-cyclopenta[h]quinazoline, and (c) Indeno[4,5-d]-1,3-dioxin,4,4a,5,6,7,8,9,9b-octahydro-7,7,8,9,9-pentamethyl at a ratio (a:b:c) in the range of about 1:1.5:1.5 to 1:20:20. In some embodiments, the fragrance composition includes (a) 1,1,2,3,3-pentamethyl-2,5,6,7-tetrahydroinden-4-one, (b) 7,7,8,9,9-pentamethyl-6,6a,7,8,9,9a-hexahydro-5H-cyclopenta[h]quinazoline, and (c) Indeno[4,5-d]-1,3-dioxin,4,4a,5,6,7,8,9,9b-octahydro-7,7,8,9,9-pentamethyl at a ratio (a:b:c) in the range of about 1:2:2 to 1:10:10. In some embodiments, the fragrance composition includes (a) 1,1,2,3,3-pentamethyl-2,5,6,7-tetrahydroinden-4-one, (b) 7,7,8,9,9-pentamethyl-6,6a,7,8,9,9a-hexahydro-5H-cyclopenta[h]quinazoline, and (c) Indeno[4,5-d]-1,3-dioxin,4,4a,5,6,7,8,9,9b-octahydro-7,7,8,9,9-pentamethyl at a ratio (a:b:c) in the range of about 1:2:2 to 1:5:5. In some embodiments, the fragrance composition includes (a) 1,1,2,3,3-pentamethyl-2,5,6,7-tetrahydroinden-4-one, (b) 7,7,8,9,9-pentamethyl-6,6a,7,8,9,9a-hexahydro-5H-cyclopenta[h]quinazoline, and (c) Indeno[4,5-d]-1,3-dioxin,4,4a,5,6,7,8,9,9b-octahydro-7,7,8,9,9-pentamethyl at a ratio (a:b:c) of 1:1.5:1.5, 1:2:2, 1:4:4, 1:5:5, 1:10:10, or 1:20:20. In some embodiments, the fragrance composition includes (a) 1,1,2,3,3-pentamethyl-2,5,6,7-tetrahydroinden-4-one, (b) 7,7,8,9,9-pentamethyl-6,6a,7,8,9,9a-hexahydro-5H-cyclopenta[h]quinazoline, and (c) Indeno[4,5-d]-1,3-dioxin,4,4a,5,6,7,8,9,9b-octahydro-7,7,8,9,9-pentamethyl at a ratio (a:b:c) of 1:2:2 or 1:4:4. In some embodiments, the fragrance composition includes (a) 1,1,2,3,3-pentamethyl-2,5,6,7-tetrahydroinden-4-one, (b) 7,7,8,9,9-pentamethyl-6,6a,7,8,9,9a-hexahydro-5H-cyclopenta[h]quinazoline, and (c) Indeno[4,5-d]-1,3-dioxin,4,4a,5,6,7,8,9,9b-octahydro-7,7,8,9,9-pentamethyl at a ratio (a:b:c) of 1:4:4.

In some embodiments, the fragrance composition includes 7,7,8,9,9-pentamethyl-6,7,8,9-tetrahydro-5H-cyclopenta[h]quinazoline at a concentration of at least or about 0.001, 0.005, 0.01, 0.05, 0.1, 0.5, 1, 2, 3, 4, or 5 wt %. In some embodiments, the fragrance composition includes 7,7,8,9,9-pentamethyl-6,7,8,9-tetrahydro-5H-cyclopenta[h]quinazoline at a concentration of at least or about 0.001 wt %. In some embodiments, the fragrance composition includes 7,7,8,9,9-pentamethyl-6,7,8,9-tetrahydro-5H-cyclopenta[h]quinazoline at a concentration of at least or about 0.00125 wt %. In some embodiments, the fragrance composition includes 7,7,8,9,9-pentamethyl-6,7,8,9-tetrahydro-5H-cyclopenta[h]quinazoline at a concentration of at least or about 0.005 wt %. In some embodiments, the fragrance composition includes 7,7,8,9,9-pentamethyl-6,7,8,9-tetrahydro-5H-cyclopenta[h]quinazoline at a concentration of at least or about 0.01 wt %. In some embodiments, the fragrance composition includes 7,7,8,9,9-pentamethyl-6,7,8,9-tetrahydro-5H-cyclopenta[h]quinazoline at a concentration of at least or about 0.05 wt %. In some embodiments, the fragrance composition includes 7,7,8,9,9-pentamethyl-6,7,8,9-tetrahydro-5H-cyclopenta[h]quinazoline at a concentration of at least or about 0.1 wt %. In some embodiments, the fragrance composition includes 7,7,8,9,9-pentamethyl-6,7,8,9-tetrahydro-5H-cyclopenta[h]quinazoline at a concentration of at least or about 0.5 wt %. In some embodiments, the fragrance composition includes 7,7,8,9,9-pentamethyl-6,7,8,9-tetrahydro-5H-cyclopenta[h]quinazoline at a concentration of at least or about 1 wt %.

In some embodiments, the fragrance composition includes (a) 1,1,2,3,3-pentamethyl-2,5,6,7-tetrahydroinden-4-one, (b) 7,7,8,9,9-pentamethyl-6,6a,7,8,9,9a-hexahydro-5H-cyclopenta[h]quinazoline, (c) Indeno[4,5-d]-1,3-dioxin,4,4a,5,6,7,8,9,9b-octahydro-7,7,8,9,9-pentamethyl, and (d) 7,7,8,9,9-pentamethyl-6,7,8,9-tetrahydro-5H-cyclopenta[h]quinazoline at a ratio (a:b:c:d) in the range of about 5:20:20:1 to 20:80:80:1. In some embodiments, the fragrance composition includes (a) 1,1,2,3,3-pentamethyl-2,5,6,7-tetrahydroinden-4-one, (b) 7,7,8,9,9-pentamethyl-6,6a,7,8,9,9a-hexahydro-5H-cyclopenta[h]quinazoline, (c) Indeno[4,5-d]-1,3-dioxin,4,4a,5,6,7,8,9,9b-octahydro-7,7,8,9,9-pentamethyl, and (d) 7,7,8,9,9-pentamethyl-6,7,8,9-tetrahydro-5H-cyclopenta[h]quinazoline at a ratio (a:b:c:d) of or of about 5:20:20:1 or 10:40:40:1. In some embodiments, the fragrance composition includes (a) 1,1,2,3,3-pentamethyl-2,5,6,7-tetrahydroinden-4-one, (b) 7,7,8,9,9-pentamethyl-6,6a,7,8,9,9a-hexahydro-5H-cyclopenta[h]quinazoline, (c) Indeno[4,5-d]-1,3-dioxin,4,4a,5,6,7,8,9,9b-octahydro-7,7,8,9,9-pentamethyl, and (d) 7,7,8,9,9-pentamethyl-6,7,8,9-tetrahydro-5H-cyclopenta[h]quinazoline at a ratio (a:b:c:d) of or of about 10:40:40:1.

In some embodiments, the fragrance composition includes 2,2,6,6,7,8,8-heptamethyl-3a,5,6,7,8,8b-hexahydro-4H-indeno[4,5-d][1,3]dioxole at a concentration of at least or about 0.001, 0.005, 0.01, 0.05, 0.1, 0.5, 1, 2, 3, 4, or 5 wt %. In some embodiments, the fragrance composition includes 2,2,6,6,7,8,8-heptamethyl-3a,5,6,7,8,8b-hexahydro-4H-indeno[4,5-d][1,3]dioxole at a concentration of at least or about 0.001 wt %. In some embodiments, the fragrance composition includes 2,2,6,6,7,8,8-heptamethyl-3a,5,6,7,8,8b-hexahydro-4H-indeno[4,5-d][1,3]dioxole at a concentration of at least or about 0.00125 wt %. In some embodiments, the fragrance composition includes 2,2,6,6,7,8,8-heptamethyl-3a,5,6,7,8,8b-hexahydro-4H-indeno[4,5-d][1,3]dioxole at a concentration of at least or about 0.005 wt %. In some embodiments, the fragrance composition includes 2,2,6,6,7,8,8-heptamethyl-3a,5,6,7,8,8b-hexahydro-4H-indeno[4,5-d][1,3]dioxole at a concentration of at least or about 0.01 wt %. In some embodiments, the fragrance composition includes 2,2,6,6,7,8,8-heptamethyl-3a,5,6,7,8,8b-hexahydro-4H-indeno[4,5-d][1,3]dioxole at a concentration of at least or about 0.05 wt %. In some embodiments, the fragrance composition includes 2,2,6,6,7,8,8-heptamethyl-3a,5,6,7,8,8b-hexahydro-4H-indeno[4,5-d][1,3]dioxole at a concentration of at least or about 0.1 wt %. In some embodiments, the fragrance composition includes 2,2,6,6,7,8,8-heptamethyl-3a,5,6,7,8,8b-hexahydro-4H-indeno[4,5-d][1,3]dioxole at a concentration of at least or about 0.5 wt %. In some embodiments, the fragrance composition includes 2,2,6,6,7,8,8-heptamethyl-3a,5,6,7,8,8b-hexahydro-4H-indeno[4,5-d][1,3]dioxole at a concentration of at least or about 1 wt %.

In some embodiments, the fragrance composition includes (a) 1,1,2,3,3-pentamethyl-2,5,6,7-tetrahydroinden-4-one, (b) 7,7,8,9,9-pentamethyl-6,6a,7,8,9,9a-hexahydro-5H-cyclopenta[h]quinazoline, (c) Indeno[4,5-d]-1,3-dioxin,4,4a,5,6,7,8,9,9b-octahydro-7,7,8,9,9-pentamethyl, and (d) 2,2,6,6,7,8,8-heptamethyl-3a,5,6,7,8,8b-hexahydro-4H-indeno[4,5-d][1,3]dioxole at a ratio (a:b:c:d) in the range of about 5:20:20:1 to 20:80:80:1. In some embodiments, the fragrance composition includes (a) 1,1,2,3,3-pentamethyl-2,5,6,7-tetrahydroinden-4-one, (b) 7,7,8,9,9-pentamethyl-6,6a,7,8,9,9a-hexahydro-5H-cyclopenta[h]quinazoline, (c) Indeno[4,5-d]-1,3-dioxin,4,4a,5,6,7,8,9,9b-octahydro-7,7,8,9,9-pentamethyl, and (d) 2,2,6,6,7,8,8-heptamethyl-3a,5,6,7,8,8b-hexahydro-4H-indeno[4,5-d][1,3]dioxole at a ratio (a:b:c:d) of or of about 5:20:20:1 or 10:40:40:1. In some embodiments, the fragrance composition includes (a) 1,1,2,3,3-pentamethyl-2,5,6,7-tetrahydroinden-4-one, (b) 7,7,8,9,9-pentamethyl-6,6a,7,8,9,9a-hexahydro-5H-cyclopenta[h]quinazoline, (c) Indeno[4,5-d]-1,3-dioxin,4,4a,5,6,7,8,9,9b-octahydro-7,7,8,9,9-pentamethyl, and (d) 2,2,6,6,7,8,8-heptamethyl-3a,5,6,7,8,8b-hexahydro-4H-indeno[4,5-d][1,3]dioxole at a ratio (a:b:c:d) of or of about 10:40:40:1.

In some embodiments, the concentration in wt % described herein (e.g., above) is with respect to the total weight of the composition.

In some embodiments, the fragrance compositions for sleep improvement described herein further include a solvent. Solvents contemplated for use herein are described in more detail below.

In certain aspects, the present disclosure provides a fragrance composition that is composed of (i) at least 3 heteroatom musk compounds and (ii) at least 1 acyclic musk compound or 7,7,8,9,9-pentamethyl-6,7,8,9-tetrahydro-5H-cyclopenta[h]quinazoline (Sinfonide®), and optionally, a solvent.

In certain aspects, the present disclosure provides a fragrance composition that is composed of (i) at least 3 heteroatom musk compounds and (ii) at least 1 acyclic musk compound, 7,7,8,9,9-pentamethyl-6,7,8,9-tetrahydro-5H-cyclopenta[h]quinazoline, or 2,2,6,6,7,8,8-heptamethyl-3a,5,6,7,8,8b-hexahydro-4H-indeno[4,5-d][1,3]dioxole; and optionally, a solvent.

A solvent suitable for use in the fragrance composition is suitable for use in a consumer product, that when combined with other components of the end product, will not render the consumer product unfit for its intended consumer user. The solvents preferably do not alter or significantly alter the olfactory properties of the fragrance ingredients. Preferably, the solvent is selected from Dipropylene glycol (DPG), isopropyl myristate, ethanol, triethyl citrate or combinations thereof. Non-limiting examples of other suitable solvents used are known in the art and include but are not limited to: diethyl phthalate, benzyl benzoate, 2-(2-ethoxy)-1-ethanol, ethyl citrate, water/ethanol mixtures, limonene or other terpenes, isoparaffins such as those sold under the trademark Isopar® (ExxonMobil Chemicals, Houston, Texas), and glycol ethers and glycol either esters such as those known under the trademark Dowanol® (Dow Chemical Company, Midland, Michigan) and solvent as disclosed at para. [0120] of US 2021/0008082A1 (Takasago).

In certain embodiments, the heteroatom musk compounds, the acyclic musk compound and/or 7,7,8,9,9-pentamethyl-6,7,8,9-tetrahydro-5H-cyclopenta[h]quinazoline of the present disclosure can each be independently formulated in a fragrance composition at a concentration form about 0.001 wt % to about 100 wt %, or form about 0.01 wt % to about 90 wt %, or from about 0.1 wt % to about 80 wt %, or form about 1 wt % to about 70 wt %, or from 1 wt % to about 60 wt %, or form about 1 wt % to about 50 wt %, or from about 1 wt % to about 45 wt %.

In certain embodiments, the heteroatom musk compounds, the acyclic musk compound, 7,7,8,9,9-pentamethyl-6,7,8,9-tetrahydro-5H-cyclopenta[h]quinazoline, or 2,2,6,6,7,8,8-heptamethyl-3a,5,6,7,8,8b-hexahydro-4H-indeno[4,5-d][1,3]dioxole of the present disclosure can each be independently formulated in a fragrance composition at a concentration form about 0.001 wt % to about 100 wt %, or form about 0.01 wt % to about 90 wt %, or from about 0.1 wt % to about 80 wt %, or form about 1 wt % to about 70 wt %, or from 1 wt % to about 60 wt %, or form about 1 wt % to about 50 wt %, or from about 1 wt % to about 45 wt %.

In certain embodiments of the fragrance composition as described herein above, the mass ratio of (i) to (ii) is from 55:1 to 45:1, or 52:1 to 47:1. In other embodiments, the fragrance composition comprises: (i) from 95 wt % to 99 wt % of the heteroatom musk compounds; and (ii) from 1 wt % to 5 wt % of the acyclic musk compound or 7,7,8,9,9-pentamethyl-6,7,8,9-tetrahydro-5H-cyclopenta[h]quinazoline, wherein the wt % is based on the total weight of the composition. In some embodiments, the fragrance composition comprises: (i) from 95 wt % to 99 wt % of the heteroatom musk compounds; and (ii) from 1 wt % to 5 wt % of the acyclic musk compound, 7,7,8,9,9-pentamethyl-6,7,8,9-tetrahydro-5H-cyclopenta[h]quinazoline, or 2,2,6,6,7,8,8-heptamethyl-3a,5,6,7,8,8b-hexahydro-4H-indeno[4,5-d][1,3]dioxole, wherein the wt % is based on the total weight of the composition.

In some embodiments, the heteroatom musk compounds that can effectively increase the quantity and/or quality of sleep can include, but are not limited to, Indeno[4,5-d]-1,3-dioxin, 4,4a,5,6,7,8,9,9b-octahydro-7,7,8,9,9-pentamethyl (Nebulone®); 1,1,2,3,3-pentamethyl-2,5,6,7-tetrahydroinden-4-one (Cashmeran®); 7,7,8,9,9-pentamethyl-6,6a,7,8,9,9a-hexahydro-5H-cyclopenta[h]quinazoline (Ambertonic™); and combinations thereof. Other suitable examples of heteroatom musk compounds are well known to those skilled in the art.

In certain embodiments, the present disclosure provides a fragrance composition comprising the heteroatom musk compounds and the acyclic musk compound, wherein: (i) the heteroatom musk compounds are Indeno[4,5-d]-1,3-dioxin,4,4a,5,6,7,8,9,9b-octahydro-7,7,8,9,9-pentamethyl; 1,1,2,3,3-pentamethyl-2,5,6,7-tetrahydroinden-4-one; and 7,7,8,9,9-pentamethyl-6,6a, 7,8,9,9a-hexahydro-5H-cyclopenta[h]quinazoline; and (ii) the acyclic musk compound is 1-Propanol,2-[1-(3,3-dimethylcyclohexyl)ethoxy]-2-methyl-,1-propanoate (Helvimor). Other suitable examples of acyclic musk arc well-known to those skilled in the art.

In particular embodiments, the fragrance composition consists of 40 wt % to 45 wt % of Indeno[4,5-d]-1,3-dioxin,4,4a,5,6,7,8,9,9b-octahydro-7,7,8,9,9-pentamethyl; 5 wt % to 15 wt % of 1,1,2,3,3-pentamethyl-2,5,6,7-tetrahydroinden-4-one; 40 wt % to 45 wt % of 7,7,8,9,9-pentamethyl-6,6a,7,8,9,9a-hexahydro-5H-cyclopenta[h]quinazoline; and 0.1 wt % to 5 wt % of 1-Propanol,2-[1-(3,3-dimethylcyclohexyl)ethoxy]-2-methyl-,1-propanoate, wherein wt % is based on the total weight of the composition.

In other embodiments, the fragrance composition comprises the heteroatom musk compounds and 7,7,8,9,9-pentamethyl-6,7,8,9-tetrahydro-5H-cyclopenta[h]quinazoline (Sinfonide®), wherein the heteroatom musk compounds are Indeno[4,5-d]-1,3-dioxin,4,4a,5,6,7,8,9,9b-octahydro-7,7,8,9,9-pentamethyl; 1,1,2,3,3-pentamethyl-2,5,6,7-tetrahydroinden-4-one; and 7,7,8,9,9-pentamethyl-6,6a,7,8,9,9a-hexahydro-5H-cyclopenta[h]quinazoline.

In particular embodiments, the composition consists of 40 wt % to 45 wt % of Indeno[4,5-d]-1,3-dioxin,4,4a,5,6,7,8,9,9b-octahydro-7,7,8,9,9-pentamethyl; 5 wt % to 15 wt % of 1,1,2,3,3-pentamethyl-2,5,6,7-tetrahydroinden-4-one; 40 wt % to 45 wt % of 7,7,8,9,9-pentamethyl-6,6a,7,8,9,9a-hexahydro-5H-cyclopenta[h]quinazoline; and 0.1 wt % to 5 wt % of 7,7,8,9,9-pentamethyl-6,7,8,9-tetrahydro-5H-cyclopenta[h]quinazoline.

In other embodiments, the fragrance composition comprises the heteroatom musk compounds and 2,2,6,6,7,8,8-heptamethyl-3a,5,6,7,8,8b-hexahydro-4H-indeno[4,5-d][1,3]dioxole), wherein the heteroatom musk compounds are Indeno[4,5-d]-1,3-dioxin,4,4a,5,6,7,8,9,9b-octahydro-7,7,8,9,9-pentamethyl; 1,1,2,3,3-pentamethyl-2,5,6,7-tetrahydroinden-4-one; and 7,7,8,9,9-pentamethyl-6,6a,7,8,9,9a-hexahydro-5H-cyclopenta[h]quinazoline.

In particular embodiments, the composition consists of 40 wt % to 45 wt % of Indeno[4,5-d]-1,3-dioxin,4,4a,5,6,7,8,9,9b-octahydro-7,7,8,9,9-pentamethyl; 5 wt % to 15 wt % of 1,1,2,3,3-pentamethyl-2,5,6,7-tetrahydroinden-4-one; 40 wt % to 45 wt % of 7,7,8,9,9-pentamethyl-6,6a,7,8,9,9a-hexahydro-5H-cyclopenta[h]quinazoline; and 0.1 wt % to 5 wt % of 2,2,6,6,7,8,8-heptamethyl-3a,5,6,7,8,8b-hexahydro-4H-indeno[4,5-d][1,3]dioxole.

In certain embodiments, the present disclosure provides fragrance compositions that can improve sleep. Preferably, the sleep improvement comprises at least one or more sleep benefits. In particular embodiments, the fragrance composition leads to sleep improvement comprising at least one or more sleep benefits selected from the listing comprising of improvement in sleep quality, increase in total sleep time, decrease in wake after sleep onset (WASO), decrease in proportion of time awake after sleep onset (% Wake), increase in deep sleep (N3/N4) duration, increase in proportion of time spent in deep sleep (N3/N4), increase in REM sleep duration, increase in proportion of time spent in REM Sleep, increase in light sleep (N1/N2) duration, increase in proportion of time spent in light sleep (N1/N2), increase in sleep efficiency, increase in sleep maintenance, decrease in number of awakenings during sleep, decrease in sleep onset, increase in feeling of being well-rested, increase in feeling of being refreshed upon awakening and/or after wakening, increase in feeling of being recharged, increase in feeling of being ready for the day, decrease in feeling of daytime sleepiness, or a combination thereof. Preferably, the sleep benefits are biometrically measured or perceived.

In other embodiments, the present disclosure provides fragrance compositions that can improve sleep, wherein the sleep improvement comprises at least one or more sleep benefits selected from the list including: decrease in time to fall asleep, decrease in time spent awake during the night (WASO), improvement in sleep efficiency, improvement in sleep maintenance, increase time spent in deep sleep, increase proportion of time spent in deep sleep stage, improvement in Sleep Quality, improvement in feeling of restfulness or combinations thereof, preferably the sleep benefits are biometrically measured or perceived.

In certain embodiments, the fragrance composition of the present disclosure may include at least one or more additional fragrance ingredients from various categories so long as the addition does not change or substantively change the ability of the composition to increase the quantity of sleep and/or improve the quality of sleep. Preferably, the fragrance composition may include at least 1, at least 2, at least 3, at least 4, at least 5, at least 6, at least 7, at least 8, at least 9 or at least 10 additional fragrance ingredients. The additional fragrance ingredients, when combined with the musk compounds, constitute the total fragrance composition. In this respect, the balance of the 100 wt % relative to the total weight of the fragrance composition is made up of: (i) at least 3 Heteroatom musk compounds; (ii) at least 1 acyclic musk compound or 7,7,8,9,9-pentamethyl-6,7,8,9-tetrahydro-5H-cyclopenta[h]quinazoline; and (iii) one or more additional fragrance ingredients. In some embodiments, the additional fragrance ingredients, when combined with the compounds having the backbone structure of formula (I), constitute the total fragrance composition. In some embodiments, the balance of the 100 wt % relative to the total weight of the fragrance composition is made up of: (i) one or more compounds having a backbone structure of formula (I) and (ii) one or more additional fragrance ingredients. In some embodiments, the wt % of the one or more compounds having a backbone structure of formula (I) is any wt % described herein. In some embodiments, the balance of the 100 wt % relative to the total weight of the fragrance composition is made up of: (i) one or more compounds having a backbone structure of formula (I), where the total concentration of the one or more compounds is at least or greater than 0.05 wt % and (ii) one or more additional fragrance ingredients. In some embodiments, the balance of the 100 wt % relative to the total weight of the fragrance composition is made up of: (i) one or more compounds having a backbone structure of formula (I), (ii) at least one acyclic musk compound, and (iii) one or more additional fragrance ingredients. In some embodiments, the wt % of the one or more compounds having the backbone structure of formula (I) is any wt % described herein and the wt % of the at least one acyclic musk compound is any wt % described herein such that that total wt % when combined with the one or more ingredients is 100%. In some embodiments, the balance of the 100 wt % relative to the total weight of the fragrance composition is made up of: (i) one or more compounds having a backbone structure of formula (I), where the total concentration of the one or more compounds is at least or greater than 0.05 wt %, (ii) at least one acyclic musk compound at a total concentration of at least 0.0025 wt %, and (iii) one or more additional fragrance ingredients. In some embodiments, the additional fragrance ingredients, when combined with the one or more heteroatom musk compounds constitute the total fragrance composition. In some embodiments, the balance of the 100 wt % relative to the total weight of the fragrance composition is made up of: (i) one or more heteroatom musk compounds and (ii) one or more additional fragrance ingredients. In some embodiments, the wt % of the one or more heteroatom musk compounds is any wt % described herein. In some embodiments, the balance of the 100 wt % relative to the total weight of the fragrance composition is made up of: (i) one or more heteroatom musk compounds, where the total concentration of the one or more compounds is at least or greater than 0.05 wt % and (ii) one or more additional fragrance ingredients. In some embodiments, the balance of the 100 wt % relative to the total weight of the fragrance composition is made up of: (i) one or more heteroatom musk compounds, (ii) at least one acyclic musk compound, and (iii) one or more additional fragrance ingredients. In some embodiments, the wt % of the one or more heteroatom musk compounds is any wt % described herein and the wt % of the at least one acyclic musk compound is any wt % described herein such that that total wt % when combined with the one or more ingredients is 100%. In some embodiments, the balance of the 100 wt % relative to the total weight of the fragrance composition is made up of: (i) one or more heteroatom musk compounds, where the total concentration of the one or more compounds is at least or greater than 0.05 wt %, (ii) at least one acyclic musk compound at a total concentration of at least 0.0025 wt %, and (iii) one or more additional fragrance ingredients.

In certain embodiments, the additional fragrance ingredients can be, but are not limited to, one or more aldehydic compound(s), one or more animalic compound(s), one or more balsamic compound(s), one or more citrus compound(s), one or more floral compound(s), one or more fruity compound(s), one or more gourmand compound(s), one or more green compound(s), one or more herbal compound(s), one or more marine compound(s), one or more mossy compound(s), one or more piney compound(s), one or more powdery compound(s), one or more spicy compound(s), one or more woody compound(s), one or more licorice compound(s) or combinations thereof.

Suitable examples of additional fragrance ingredients are described in US 2020/0048578A1 (Givaudan), US 2018/0325786A1 (IFF), and U.S. Pat. No. 4,534,891 (IFF). Further non-limiting examples of such additional fragrance ingredients are selected from the group consisting of: ALDEHYDE C 10 DECYLIC; ALDEHYDE C 11 UNDECYLENIC; ALDEHYDE C 110 UNDECYLIC; ALDEHYDE C 12 LAURIC; ALDEHYDE C 12 MNA PURE; ALDEHYDE C 8 OCTYLIC FOOD GRADE; ALDEHYDE C 9 ISONONYLIC; ALDEHYDE C 9 NONYLIC FOOD GRADE; ALDEHYDE C 90 NONENYLIC 1%/TEC; ALDEHYDE C12 (DODECANAL); ALDEHYDE ISO C 11; mandarine aldehydes; trans-4-decenal, DECENAL-4-TRANS 10%/TEC; DIHYDROFARNESAL; dodecanal; MYRALDENE; TANGERINOL; Amberketal®; AMBERKETAL IPM; Ambermax; Ambrocenide® AMBROFIX; AMBROFIX FLAKES; Belambre; BOISAMBRENE FORTE; CEDRYL ACETATE LIQUID; CEDRYL METHYL ETHER; CETALOX; ISO E SUPER; KARANAL; KEPHALIS; TIMBEROL; TRIMOFIX O; ANIMALIS 1745 SUBST. PMF 2; cade oils, essences, extracts, replacers substitutes; GUAIACOL; INDOFLOR; Indole; Indolene; ANETHOLE; ANISE STAR OIL; ANISIC ALDEHYDE; ANISYL ACETATE; DIHYDRO ANETHOLE; ESTRAGOLE; fennel sweet oils, essences, extracts, bases, replacers or substitutes; FENNEL SWEET DQ (AC) N 41632TT; FENNEL OIL SWEET; and FENNEL OIL SWEET TECH; Benzoin oils, essences, extracts, replacers or substitutes; BENZYL ALCOHOL; BENZYL CINNAMATE; Olibanum oils, essences, extracts, replacers or substitutes; OLIBANUM OIL SOMALIA ORPUR; PHENYL ETHYL PHENYL ACETATE; Armoise oils, essences, extracts, replacers or substitutes; Camphor and Camphor oils, essences, extracts, replacers or substitutes; Eucalyptol and Eucalyptol oils, essences, extracts, replacers or substitutes; Lavandin oils, essences, extracts, replacers or substitutes; Lavender oils, extracts, essences, replacers or substitutes; Rosemary oils, essences, extracts, replacers or substitutes; and Thuja oils, essences, extracts, replacers or substitutes; ACETAL CD; AMYL CINNAMIC ALDEHYDE; AMYL SALICYLATE; AURANTIOL PURE BENZYL ACETATE; BENZYL SALICYLATE; BOURGEONAL; CITRONELLOL; CITRONELLYL ACETATE; CRESYL METHYL ETHER PARA; CYCLAMEN ALDEHYDE EXTRA; CYCLOHEXAL; CYCLOHEXYL SALICYLATE; DIMETHYL ANTHRANILATE; DIMETHYL PHENYL THYL CARBINOL; DUPICAL; ETHYL LINALOOL; FLOROSA; FLOROSA HC; GERANIOL; Geranium oils, essences, extracts, replacers or substitutes; GERANODYLE; GERANYL ACETATE; GERANYL BUTYRATE; HEDIONE; HEDIONE HC; HEXENYL-3-CIS SALICYLATE; HEXYL CINNAMIC ALDEHYDE; HEXYL CINNAMIC ALDEHYDE DQ AC XI 41505TT; HEXYL SALICYLATE; HYDROXYCITRONELLAL; ISOBUTYL PHENYL ACETATE; ISOBUTYL SALICYLATE; JASMATONE; Jasmin oils, essences, extracts, replacers or substitutes; JASMONE CIS; JASMONYL; JASMOPYRANE FORTE; LILIAL and lilial substitutes; LINALOOL; MEFROSOL; METHYL ANTHRANILATE; METHYL ANTHRANILATE EXTRA; METHYL BENZOATE; METHYL PHENYL ACETATE; Neroli oils, essences, extracts, replacers or substitutes; NEROLINE CRYSTALS; NEROLIONE; Orange oils, essences, extracts, replacers or substitutes; ORANGER CRYSTALS; ORANGER FLEUR CREME 1103/20; PELARGOL; PEONILE; PETALIA; PHENYL ETHYL ACETATE; PHENYL ETHYL ALCOHOL; PHENYL ETHYL ISOVALERATE; PHENYL ETHYL SALICYLATE CRYSTALS; ROSACETOL; ROSALVA; Rose oils, essences, extracts, replacers or substitutes; SUPER MUGUET; TERPINEOL PURE; TETRAHYDRO LINALOOL; VERDANTIOL; YARA YARA; Ylang oils, essences, extracts, replacers or substitutes; ACETATE C 6 HEXYLIC; AGRUMEX; ALLYL AMYL GLYCOLATE; ALLYL CAPROATE; ALLYL CYCLOHEXYL PROPIONATE; ALLYL OENANTHATE; AMYL BUTYRATE; APHERMATE; Apple oils, essences, extracts, replacers or substitutes; Banana oils, essences, extracts, replacers or substitutes; BENZYL BUTYRATE; BENZYL ISOBUTYRATE; BENZYL PROPIONATE; BUTYL ACETATE; BUTYRIC ACID; Cassis oils, essences, extracts, replacers or substitutes; COGNAC WHITE OIL EXTRA DQ (AC) 41547TT; CYCLOGALBANATE; DAMASCENONE; DAMASCONE ALPHA; DAMASCONE BETA; DAMASCONE DELTA; DECALACTONE DELTA; DECALACTONE GAMMA; Dewfruit oils, essences, extracts, replacers or substitutes; DIETHYL MALONATE; DIMETHYL BENZYL CARBINYL ACETATE; DIMETHYL BENZYL CARBINYL BUTYRATE; DODECALACTONE DELTA; DODECALACTONE GAMMA; ETHYL ACETOACETATE; ETHYL BUTYRATE; ETHYL CAPROATE; ETHYL CAPRYLATE; ETHYL ISOAMYL KETONE; ETHYL ISOBUTYRATE; ETHYL METHYL-2-BUTYRATE; ETHYL OENANTHATE; ETHYL PELARGONATE; ETHYL PROPIONATE; ETHYL SAFRANATE; FLOROCYCLENE; FRAISTONE; FRUCTONE; FRUITATE; GARDOCYCLENE; GIVESCONE; Guave oils, essences, extracts, replacers or substitutes; HEXENYL-3-CIS BUTYRATE; HEXENYL-3-CIS ISOBUTYRATE; HEXYL BUTYRATE; HEXYL ISOBUTYRATE; ISOAMYL ACETATE EXTRA; ISOAMYL BUTYRATE FR; JASMACYCLENE; MANZANATE; Melon oils, essences, extracts, replacers or substitutes; METHOXY PHENYL BUTANONE; METHYL HEPTENONE PURE; METHYL HEXYL KETONE; METHYL-2-PENTENOIC ACID; 2-NECTARYL; OCTALACTONE GAMMA; PEACH PURE; PHENOXY ETHYL ISOBUTYRATE; PHENYL ETHYL ISOBUTYRATE; PRUNOLIDE; RASPBERRY KETONE (N 112); and STRAWBERRY PURE; AMYL VINYL CARBINOL; OCIMENE; ACETOIN; Acetyl pyrazine; BENZALDEHYDE; BUTYL BUTYRO LACTATE; Chocolate oils, essences, extracts, replacers or substitutes; CORYLONE DRIED; CYCLOTENE; Ethyl maltol; Homofuronol; Hydroxy ethyl methyl thiazol; ISOBUTAVAN; and MALTYL ISOBUTYRATE; ACETAL E; ALCOHOL C 6 HEXYLIC; ALDEHYDE C 6 HEXYLIC FOOD GRADE; BUTYL QUINOLINE SECONDARY; CYCLAL C; DIPHENYL OXIDE; ELINTAAL; ETHYL DECADIENOATE; ETHYL DIMETHYL Pyrazine; Galbanone; GARDENOL; Hexenal-2-trans; HEXENOL-2-TRANS; HEXENOL-3-CIS; HEXENYL-3-CIS ACETATE; HEXENYL-3-CIS BENZOATE; HEXENYL-3-CIS PROPIONATE; ISOCYCLOCITRAL; Isohexylmethoxy pyrazine; LIFFAROME; LIGANTRAAL; MACEAL; METHYL OCTYNE CARBONATE; NEOFOLIONE; Nonadicnal; NONADIENOL-2,6; Nonenal-6-cis; NONENOL-6-CIS; Petitgrain oils, essences, extracts, replacers or substitutes; Phenoxyacetaldehyde; Phenyl acetaldehyde; PYRALONE; RESEDAL; ROSE OXIDE; ROSYRANE SUPER; STEMONE; TRICYCLAL; TRIFERNAL; UNDECATRIENE; UNDECAVERTOL; Violet nitrile; VIRIDINE; Basil oils, essences, extracts, replacers or substitutes; Camomile oils, essences, extracts, replacers or substitutes; CITRONELLAL; Clary sage oils, essences, extracts, replacers or substitutes; CYPRISATE; Eucalyptus oils, extracts, essences, replacers or substitutes; HERBOXANE; PINOACETALDEHYDE; TANAISONE; Thyme oils, essences, extracts, replacers or substitutes; THYMOL CRYSTALS; ADOXAL; Azurone; CALONE 1951; FENNALDEHYDE; FLORALOZONE; FLORHYDRAL; MELONAL; SCENTENAL; TROPIONAL; and VERNALDEHYDE; Buchu leaf oils, essences, extracts, replacers or substitutes; CARVONE LAEVO; Cornmint oils, essences, extracts, replacers or substitutes; FRESKOMENTHE; ISOMENTHONE DL; MENTHOL LAEVO; MENTHOL-DL; MENTHONE; MENTHYL ACETATE; Peppermint oils, essences, extracts, replacers or substitutes; and Spearmint oils, essences, extracts, replacers or substitutes; AMBRETTOLIDE; CASHMERAN; COSMONE; Cyclopentadecanolide; ETHYLENE BRASSYLATE; GALAXOLIDE; GALAXOLIDE S; HABANOLIDE; MUSCENONE; MUSK C14; SERENOLIDE; SILVANONE SUPRA; SYLKOLIDE; VELVIONE; CETONE V; DIHYDRO IONONE BETA; IONONE BETA; IRISONE ALPHA; IRISONE PURE; ISORALDEINE 70; ISORALDEINE 95; ORIVONE; Anjeruk; Corps cassis; Corps pamplemousse; Dimethyl sulphide; GARDAMIDE; Labienoxime; Mercaptans; METHYL ISOPROPYL THIAZOLE; Nardozeste oils, essences, extracts, replacers or substitutes; NEOCASPIRENE EXTRA; NONIVAMIDE 1% TRIACETIN; Oxane; PARADISAMIDE; Paramenthone; ACETOPHENONE; AUBEPINE PARA CRESOL; BICYCLO NONALACTONE; COUMARIN; Ethyl laitone; ETHYL VANILLIN; HELIOTROPIN; Vanilla oils, essences, extracts, replacers or substitutes; VANILLIN; Vanolia oils, essences, extracts, replacers or substitutes; VERATRIC ALDEHYDE; BORNEOL; BORNYL ACETATE LIQUID; BUTYL CYCLOHEXANOL PARA; BUTYL CYCLOHEXYL ACETATE PARA; Cedar wood oils, essences, extracts, replacers or substitutes; CONIFERAN; EBANOL; EVERNYL; FENCHYL ACETATE; Guaiac wood oils, essences, extracts, replacers or substitutes; ISONONANYL ACETATE; JAVANOL; KOHINOOL; MENTHANYL ACETATE; METHYL CEDRYL KETONE; NOPYL ACETATE; OSYROL; OXYOCTALINE FORMATE; Patchouli oils, essences, extracts, replacers or substitutes; PINENE ALPHA; PINENE BETA; RADJANOL; RADJANOL SUPER; Turpentine oils, essences, extracts, replacers or substitutes; VERTOFIX COEUR; and Vetiver oils, essences, extracts, replacers or substitutes; ALDEHYDE C12; and MENTHYL ACETATE.

In some embodiments, a fragrance composition described herein may be formulated with an existing accord, sketch, or full fragrance. In some embodiments, the accord, sketch, or full fragrance may not have a sleep improving effect, such as described herein. In some embodiments, formulating a fragrance composition for sleep improvement described herein with an accord, sketch, or full fragrance lacking a sleep improvement effect, results in the accord, sketch, or full fragrance having a sleep improving effect. For example, adding a fragrance composition for sleep improvement described herein to an existing accord, sketch, or full fragrance results in the accord, sketch, or full fragrance having a sleep improving effect. Thus, in some cases, the fragrance composition for sleep improvement described herein can endow fragrances having no impact on sleep with a sleep improving effect.

In certain embodiments, the fragrance composition of the present disclosure is substantially free or essentially free of one or more musk compounds, with the proviso that the one or more musk compounds do not comprise heteroatom musk compounds and/or acyclic musk compounds. In particular embodiments, the fragrance composition is substantially free or essentially free of macrocyclic musk compounds, which preferably includes Ambretone®, Ambrettolide, Cosmone®, Cyclopentadecanolide, Ethylene Brassylate, Habanolide®, L-Muscone, Muscenone, Musk C14, Musk T®, Silvanone® Supra, and/or Velvione®.

The fragrance composition of the present disclosure may comprise one or more fragrance co-ingredients. In general, these co-ingredients belong to chemical classes such as, but not limited to: alcohols, aldehydes, ketones, esters, ethers, acetals, oximes, acetates, nitriles, terpenes, saturated and unsaturated hydrocarbons, of natural or synthetic origins.

Neat Fragrance. In certain embodiments, fragrance compositions of the present disclosure comprise a neat fragrance. A “neat fragrance” refers to a fragrance component that is free from extraneous matter and is unencapsulated and/or unbound from other compounds that would cause delay in the release of the fragrance ingredients. When the fragrance component is a neat fragrance, the fragrance component is present in the amount of 0.001 wt % to 100 wt % relative to the total weight of the fragrance composition.

In some embodiments, the one or more compounds having the backbone structure of formula (I) are a neat fragrance. In some embodiments, the one or more heteroatom musk compounds are a neat fragrance. In some embodiments, the acyclic musk compound is a neat fragrance.

Encapsulated Fragrance. In certain embodiments, the sleep benefits of the fragrance compositions of the present disclosure can be further enhanced by employing a delivery system to such fragrance compounds. Typically, microcapsules are used to encapsulate fragrances and deliver them to a target area in a time-delayed or controlled manner. As used herein, the term “encapsulated fragrance” refers to a fragrance composition which is encapsulated in microcapsule in order to stabilize the release of the fragrance compounds over a prolonged period of time. Without wishing to be bound by theory, Applicant submits that the fragrance compositions can be applied to pillow-case and/or bedding from a variety of consumer products (e.g., fabric spray, laundry detergent, fabric softener, scent booster, etc.). The fragrance materials are then released from the microcapsule throughout the night as the subject rubs against the pillow-case and/or bedding causing the microcapsules to rupture. As a result, the released fragrance composition will act to continuously improve sleep quality and/or quantity throughout the night.

The microcapsules preferably have an average particle size from 1 and 100 microns, preferably from 1 to 50 microns or more preferably from 1 to 20 microns. The microcapsules may be prepared from natural materials like fungal chitosan (WO 2016/185171A1), silk fibroin particles (US 2015/0164117A1), and biomolecules used as emulsifiers in microcapsule preparation (WO 2016/193435A1; WO 2017/102812A1; US 2018/0078468A1; WO 2018/019894A1; WO 2018/019896A1; and WO 2017/102812A1). Multilayered coacervate between gelatin and gum Arabic capsules may be used in the present invention (U.S. Pat. No. 4,946,624; WO 2012/001604A1; US 2015/0250689A1; and WO 2018/002214A1). Protein microcapsules are also useful within the scope of the present invention (US 2017/0189283A1). Preferably, the environmentally friendly microcapsules where the shell has a biodegradability of at least 60 wt % within 60 days according to OECD301F are also within the scope of the present invention (WO 2021/122633A1).

In some embodiments, the one or more compounds having the backbone structure of formula (I) arc encapsulated. In some embodiments, the one or more heteroatom musk compounds are encapsulated. In some embodiments, the acyclic musk compound is encapsulated. In certain embodiments of the present disclosure, the fragrance ingredients are neat fragrances (i.e., unencapsulated fragrances), encapsulated fragrances or a combination thereof. The one or more compounds having the backbone structure of formula (I), the one or more heteroatom musk compounds, and the acyclic musk compound may be considered fragrance ingredients of the fragrance compositions.

### Use of Fragrance Compositions in Consumer Products

The fragrance composition of the present disclosure according to any embodiments described herein can be advantageously formulated as part of a consumer product for sleep improvement during the night, preferably for improving at least one sleep benefit to a subject. Such consumer products can be prepared in any suitable form by any process chosen by the formulator. The concentration of the fragrance composition admixed with the consumer product to provide at least one sleep benefit to a subject can change based on a number of variables, for example, the specific type of consumer product, the physical form of the consumer product (e.g., liquid, gas or solid), and what other fragrance components are already present in the consumer product and the concentrations thereof.

In some embodiments, the consumer products of the present disclosure can be, but are not limited to, an air care product (e.g., candle, incense stick, aerosol, air freshener, liquid electric air freshener, fragrance diffuser, smart diffuser, gel air freshener, or plug-in air freshener), a fabric care product (e.g., laundry detergent, fabric softener, pillow spray, fabric cleaner, scent booster, laundry unit dose or dryer sheet), a personal care product (e.g., lotion, cream, wipe, body wash, hand soap, soap, skin patch, etc.), a pet care product, a sanitary product (e.g., towel, toilet paper, tissue paper, wet tissue paper, handkerchief, wet towel, etc.), a fine fragrance (e.g., parfum, eau de parfum, cologne, eau de toilette, etc.), a hair care product (e.g., shampoo, rinse, conditioner, leave-in shampoo, hair styling agent, etc.), or a beauty care product (e.g., skin cream, cleaning cream, night cream, hand cream, lotion, after-shave lotion, body lotion, lip cream, talcum powder, anti-wrinkle and/or anti-aging cosmetics, massage oil, etc.). In some embodiments, the consumer product is a product used for sleep or a bedtime routine. For example, the consumer product may be bedding, such as sheets (e.g., bed sheets, pillowcases, etc.), coverings (e.g., comforters, quilts, duvets, blankets, etc.), or the bed item itself (e.g., mattress, pillow, bedframe, etc.). In some embodiments, the consumer product is a bedtime or sleep accessory. For example, the consumer product may be a pillow insert, mattress insert, pillow sachet, eye mask, or other product designed to include the sleep improving fragrance composition in the material of the product. In some embodiments, an air care product includes a device for delivering the fragrance compositions, e.g., as described above. In some embodiments, the device is a wearable device. In some embodiments, the device is a smart device, e.g., a smart bed, smart mattress, smart pillow, smart wearable device.

A broad range of concentrations of the fragrance composition can be employed to provide at least one sleep benefit in a subject. In certain embodiments of the present disclosure, the fragrance composition can be admixed with a consumer product and the composition can be present in the consumer product in an amount of from about 1 to about 9000 ppm, or from about 5 to 7500 ppm, or from about 10 to about 5000 ppm, or from about 50 to 2500 ppm or from about 100 to 1000 ppm, or from about 250 to 500 ppm, and any value therein between.

In certain embodiments of the present disclosure, the fragrance composition can be admixed with a consumer product wherein the composition is present in an amount from about 0.0001 wt % to about 90 wt %, or from about 0.001 wt % to about 75 wt %, or from about 1 wt % to 50 wt %, and values therein between. In some embodiments, the fragrance composition is present at an amount effective to improve the at least one sleep benefit. In some embodiments, the effective amount is dependent on the amount, e.g., total concentration, of compounds having the structure of formula (I). In some embodiments, the effective amount is dependent on the amount, e.g., total concentration, of heteroatom musk compounds. In some embodiments, the effective amount is an amount, e.g., total concentration, of at least or greater than 0.05 wt %. In some embodiments, the effective amount is an amount, e.g., total concentration, of at least or greater than 0.1 wt %. In some embodiments, the effective amount is an amount, e.g., total concentration, of at least or greater than 1 wt %. In some embodiments, the consumer product can include one or more additional bases, solvents, other fragrant compounds, perfuming co-ingredients, builders, chelating agents, dye transfer inhibiting agents, dispersants, enzymes and enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, hueing dyes, fragrances, fragrance delivery systems, structure elasticizing agents, carriers, structurants, hydrotropes, processing aids, solvents in addition to said solubilizing agent, a fabric softener active selected from the group consisting of a silicone polymer, a polysaccharide clay, a fatty ester, a dispersible polyolefin, a polymer latex, pigments and combinations thereof.

The fragrance compositions disclosed herein are particularly suitable for use in a fabric care product, preferably as a fabric spray, a laundry detergent, a fabric softener, and a scent booster, and more preferably as a pillow and/or bedding spray. In certain embodiments, the fabric spray compositions of the present disclosure are aqueous fabric sprays. Preferably, at least 60 wt % of the composition is water, more preferably at least 70 wt %. In certain aspects, the fabric spray composition of the present disclosure comprises a neat fragrance, preferably present at a level selected from less than 10%, less than 8%, and less than 5% by weight of the spray composition. In yet further embodiments of the present disclosure, the fabric spray composition comprises a combination of neat and encapsulated fragrances.

Fabric spray compositions of the present invention preferably comprises anti-malodor ingredient(s). Anti-malodor agent may be present at a level selected from less than 20%, less than 10% and less than 5% by weight of the fabric spray composition. Any suitable anti-malodor agent may be used. Non-limiting examples of anti-malodor agent may be selected from the group consisting of: uncomplexed cyclodextrin; odor blockers; reactive aldehydes; flavanoids; zeolites; activated carbon; a mixture of zinc ricinoleate or a solution thereof and a substituted monocyclic organic compound; and mixtures thereof. Without wishing to be bound be theory, Applicant submits that use of an anti-malodor agent with the fragrance composition helps to trap, absorb or destroy any unpleasant odor molecules from the pillow-case and/or bedding to further enhance the sleep benefits.

In certain embodiments, the subject disclosure relates to a method of incorporating a fragrance composition providing sleep improvement effects into a consumer product. According to this embodiment, the method can include (a) providing at least one consumer product, and (b) combining the consumer product with a fragrance composition as described herein. In certain embodiment, such a composition can be administered before the subject's typical bedtime.

In yet other embodiments, the composition of the present disclosure is useful for sleep improvement, which can be advantageously formulated into a consumer product intended to apply to any substrate. As used herein, the term “substrate” means any surface to which the composition of the present invention can be applied to without causing any undue adverse effect. For example, this can include a wide range of surfaces including human or animal skin or hair, fabric (pillow spray), air (air freshener), furnishings, paper, dishes, hard surfaces and related materials. Preferred substrates include fabric such as, for example, bedding, laundry, blanket and pillow-case.

### Method for Improving Sleep Benefits

In certain embodiments, the present disclosure is directed to a method for improving at least one sleep benefit to a subject, wherein the method comprises providing a fragrance composition as described herein or a consumer product as described herein to the subject in an amount effective to improve the at least one sleep benefit. Preferably, the fragrance composition or the consumer product is: (i) sprayed or applied onto a subject (e.g., a portion of a body, face or hair); (ii) sprayed or applied onto upholstery or fabric, preferably bedding, laundry, blanket or pillow-case; and/or (iii) dispersed or diffused into the air (in a room). Preferably, the at least one sleep benefit is preferably selected from the group consisting of improvement in sleep quality, increase in total sleep time, decrease in wake after sleep onset (WASO), decrease in proportion of time awake after sleep onset (% Wake), increase in deep sleep (N3/N4) duration, increase in proportion of time spent in deep sleep (N3/N4), increase in REM sleep duration, increase in proportion of time spent in REM Sleep, increase in light sleep (N1/N2) duration, increase in proportion of time spent in light sleep (N1/2), increase in sleep efficiency, increase in sleep maintenance, decrease in number of awakenings during sleep, decrease in sleep onset, increase in feeling of being well-rested, increase in feeling of being refreshed upon awakening and/or after awakening, increase in feeling of being recharged, increase in feeling of being ready for the day, decrease in feeling of daytime sleepiness, or a combination thereof, preferably wherein the sleep benefit is biometrically measured or perceived. In other embodiments, the method for improving at least one sleep benefit to a subject, wherein the method comprises incorporating into a consumer's sleep ritual in advance of or immediately prior to bedtime or while in bed by providing a fragrance composition as described herein or a consumer product as described herein to the subject in an amount effective to improve the at least one sleep benefit.

In some embodiments, the fragrance composition may be provided by a device. For example, in some embodiments, the fragrance composition may be contained in a wearable scent delivery device and provided to the subject therefrom. In some embodiments, the fragrance composition is used in connection with a smart device, such as a smart bed, smart mattress, smart pillow, smart wearable device, etc, to provide the fragrance to the subject. In some embodiments, the smart device further collects data, e.g., biometric data from the subject, and uses the data to modulate (e.g., start, stop, increase, decrease) fragrance delivery. The fragrance composition may be present in any suitable form for use with such devices.

In certain embodiments, the fragrance composition is administered to a subject through gaseous or volatile form. In certain non-limiting embodiments, the fragrance composition can be administered intranasally or by inhalation. In certain embodiments, the subject can inhale the fragrance composition directly or indirectly. In other specific embodiments, the fragrance composition can be released into the area surrounding the subject and the subject inhales the composition. In a particular embodiment, the composition is released into the air by a consumer product, such as but not limited to an air freshener or a candle, or by beddings and/or pillow-case treated with one or more fabric care products, such as fabric spray, laundry detergent, fabric softener, scent booster and the like. In some embodiments, the consumer product is a bedtime or sleep accessory. In some embodiments, the consumer product is a device, e.g., a smart device.

In certain embodiments of the present disclosure, the amount of the fragrance composition released from the consumer product can be less than the total concentration of the fragrance composition admixed with the consumer product. In certain embodiments, the amount of the fragrance composition released by the consumer product, and therefore available for administration to the subject, can be between about 1% to about 100% of the amount of fragrance composition admixed with the consumer product. In further embodiments, the amount of fragrance composition released can be between about 5% and about 90%, between about 10% and about 80%, between about 20% and about 70%, between about 30% and about 60% and between about 40% and about 50% of the amount of the fragrance composition admixed with the consumer product.

In other embodiments, the presently disclosed subject matter can include a consumer product comprising a sufficient amount of the fragrance composition presently disclosed to provide a concentration of the fragrance composition of at least about 1 ng per cubic foot of air, at least about 5 ng per cubic foot of air, at least 10 ng per cubic foot of air, at least 20 ng per cubic foot of air, at least 30 ng per cubic foot of air, or at least 50 ng per cubic foot of air.

The present disclosure also provides for a method of improving at least one sleep benefit to a subject in need thereof comprising administering to the subject any of the disclosed fragrance compositions or consumer products in an amount effective to improve at least one sleep benefit. Preferably, the subject is exposed to such fragrance composition or consumer product prior to bedtime, at bedtime, and/or during the night. In a particular embodiment, the subject can be exposed to the fragrance composition or consumer product for at least about 15 minutes, at least about 30 minutes, at least about 1 hour, at least about 2 hours, at least about 3 hours, at least about 4 hours, at least about 5 hours, at least about 6 hours or at least about 7 hours.

It is contemplated that the fragrance compositions described herein may be used in a variety of settings, ranging from residential to commercial spaces. For example, the fragrance compositions described herein may be used in private homes, e.g., a subject's bedroom, as well as in commercial settings, such as hotels, e.g., a hotel room.

### Method for Monitoring Sleep Benefits

The sleep benefits of a subject exposed to a fragrance composition can be monitored through the use of, without limitation, a remote sensor method that uses the SleepScore Max device (SleepScore Labs, Carlsbad, California) which is a non-contact monitoring device that measure the subject's respiratory signal (i.e., breathing), and motion to detect sleep behaviors. The sleep monitoring method of the present disclosure represents a significant technological advancement over traditional and simple consumer wearable sleep and fitness monitoring devices sold under the brand names, Fitbit Inspire HR®, Fitbit Charge 5®, Fibit Versa 2®, Fitbit Ionic®, Jawbone Up3®, ŌURA Ring Gen 3®, and other similar devices. The main drawback of these wearable sleep monitoring devices is that they may interfere with the subject's sleep pattern, and/or may have limited sensors (e.g., heart rate sensors (i.e., sleeping heart rate), motion detectors (measure of restlessness), etc.) and therefore can only provide minimal and/or vague sleep data and/or metrics. As such the conclusion draw based on data generated from these devices are not particularly robust and/or may not be truly supportive of different sleep benefits.

Accordingly, the sleep monitoring of the present disclosure is considered comparable versus the gold-standard sleep assessment technique, polysomnography (PSG). The SleepScore Max device has been shown to have a high degree of performance on sleep/wake measurements (Chinoy, E. D. et al., Performance of Seven Consumer Sleep-Tracking Devices Compared with Polysomnography, Sleep J., 2021, pp. 1-16). The sleep monitoring method of the present disclosure allows for measurements of time spent in each of the sleep stages (light, deep and REM), total sleep duration, time spent awake during the night after initially falling asleep (WASO), number of awakenings or waking episodes, time taken to fall asleep, total wake time, time in bed, start time of sleep routine, end time of sleep routine (wake up time), and overall sleep quality measures such as Sleep Efficiency, Sleep Maintenance, SleepScore, MindScore and BodyScore.

The invention is described in greater detail by the below non-limiting examples. Without further elaboration, it is believed that one skilled in the art can, based on the description herein, utilize the present invention to its fullest extent. All publications cited herein are incorporated by reference in their entirety.

### EXEMPLARY EMBODIMENTS

Among the provided embodiments are:

1. A fragrance composition for sleep improvement comprising at least 4 fragrance ingredients comprising: (i) at least 3 heteroatom musk compounds; and (ii) at least 1 acyclic musk compound or 7,7,8,9,9-pentamethyl-6,7,8,9-tetrahydro-5H-cyclopenta[h]quinazoline; and optionally, a solvent selected from Dipropylene glycol (DPG), isopropyl myristate, ethanol, triethyl citrate or combination thereof.
2. The fragrance composition of embodiment 1, wherein the mass ratio of (i) to (ii) is from 55:1 to 45:1 or 52:1 to 47:1.
3. The fragrance composition of embodiment 1, comprising: from 95 wt % to 99 wt % of the heteroatom musk compounds; and from 1 wt % to 5 wt % of the acyclic musk compound or 7,7,8,9,9-pentamethyl-6,7,8,9-tetrahydro-5H-cyclopenta[h]quinazoline; wherein wt % is based on the total weight of the composition.
4. The fragrance composition of embodiment 1, wherein the heteroatom musk compounds are Indeno[4,5-d]-1,3-dioxin, 4,4a,5,6,7,8,9,9b-octahydro-7,7,8,9,9-pentamethyl; 1,1,2,3,3-pentamethyl-2,5,6,7-tetrahydroinden-4-one; and 7,7,8,9,9-pentamethyl-6,6a,7,8,9,9a-hexahydro-5H-cyclopenta[h]quinazoline.
5. The fragrance composition of embodiment 1, wherein the composition comprises the heteroatom musk compounds and the acyclic musk compound, wherein: (i) the heteroatom musk compounds are Indeno[4,5-d]-1,3-dioxin, 4,4a,5,6,7,8,9,9b-octahydro-7,7,8,9,9-pentamethyl; 1,1,2,3,3-pentamethyl-2,5,6,7-tetrahydroinden-4-one; and 7,7,8,9,9-pentamethyl-6,6a,7,8,9,9a-hexahydro-5H-cyclopenta[h]quinazoline; and (ii) the acyclic musk compound is 1-Propanol, 2-[1-(3,3-dimethylcyclohexyl)ethoxy]-2-methyl-, 1-propanoate.
6. The fragrance composition of embodiment 5, wherein the composition consists of 40 wt % to 45 wt % of Indeno[4,5-d]-1,3-dioxin, 4,4a,5,6,7,8,9,9b-octahydro-7,7,8,9,9-pentamethyl; 5 wt % to 15 wt % of 1,1,2,3,3-pentamethyl-2,5,6,7-tetrahydroinden-4-one; 40 wt % to 45 wt % of 7,7,8,9,9-pentamethyl-6,6a,7,8,9,9a-hexahydro-5H-cyclopenta[h]quinazoline; and 0.1 wt % to 5 wt % of 1-Propanol, 2-[1-(3,3-dimethylcyclohexyl)ethoxy]-2-methyl-, 1-propanoate, wherein wt % is based on the total weight of the composition.
7. The fragrance composition of embodiment 1, wherein the composition comprises the heteroatom musk compounds and 7,7,8,9,9-pentamethyl-6,7,8,9-tetrahydro-5H-cyclopenta[h]quinazoline, wherein the heteroatom musk compounds are Indeno[4,5-d]-1,3-dioxin, 4,4a,5,6,7,8,9,9b-octahydro-7,7,8,9,9-pentamethyl; 1,1,2,3,3-pentamethyl-2,5,6,7-tetrahydroinden-4-one; and 7,7,8,9,9-pentamethyl-6,6a,7,8,9,9a-hexahydro-5H-cyclopenta[h]quinazoline.
8. The fragrance composition of embodiment 7, wherein the composition consists of 40 wt % to 45 wt % of Indeno[4,5-d]-1,3-dioxin, 4,4a,5,6,7,8,9,9b-octahydro-7,7,8,9,9-pentamethyl; 5 wt % to 15 wt % of 1,1,2,3,3-pentamethyl-2,5,6,7-tetrahydroinden-4-one; 40 wt % to 45 wt % of 7,7,8,9,9-pentamethyl-6,6a,7,8,9,9a-hexahydro-5H-cyclopenta[h]quinazoline; and 0.1 wt % to 5 wt % of 7,7,8,9,9-pentamethyl-6,7,8,9-tetrahydro-5H-cyclopenta[h]quinazoline.
9. The fragrance composition of embodiment 1, wherein the sleep improvement comprises at least one or more sleep benefits selected from the list comprising of improvement in sleep quality, increase in total sleep time, decrease in wake after sleep onset (WASO), decrease in proportion of time awake after sleep onset (% Wake), increase in deep sleep (N3/N4) duration, increase in proportion of time spent in deep sleep (N3/N4), increase in REM sleep duration, increase in proportion of time spent in REM Sleep, increase in light sleep (N1/N2) duration, increase in proportion of time spent in light sleep (N1/N2), increase in sleep efficiency, increase in sleep maintenance, decrease in number of awakenings during sleep, decrease in sleep onset, increase in feeling of being well-rested, increase in feeling of being refreshed upon awakening and/or after wakening, increase in feeling of being recharged, increase in feeling of being ready for the day, decrease in feeling of daytime sleepiness, or a combination thereof, preferably the sleep benefits arc biometrically measured or perceived.
10. The fragrance composition of embodiment 1, wherein the fragrance ingredients are neat fragrances (i.e., unencapsulated fragrances), encapsulated fragrances or a combination thereof, preferably wherein the encapsulated fragrances are encapsulated by microcapsules having a biodegradability of at least 60 wt % within 60 days according to OECD 301F.
11. The fragrance composition of embodiment 1, further comprising at least 1, at least 2, at least 3, at least 4, at least 5, at least 6, at least 7, at least 8, at least 9 or at least 10 additional fragrance ingredients selected from the group consisting of ALDEHYDE C 10 DECYLIC; ALDEHYDE C 11 UNDECYLENIC; ALDEHYDE C 110 UNDECYLIC; ALDEHYDE C 12 LAURIC; ALDEHYDE C 12 MNA PURE; ALDEHYDE C 8 OCTYLIC FOOD GRADE; ALDEHYDE C 9 ISONONYLIC; ALDEHYDE C 9 NONYLIC FOOD GRADE; ALDEHYDE C 90 NONENYLIC 1%/TEC; ALDEHYDE C12 (DODECANAL); ALDEHYDE ISO C 11; mandarine aldehydes; trans-4-decenal, DECENAL-4-TRANS 10%/TEC; DIHYDROFARNESAL; dodecanal; MYRALDENE; TANGERINOL; Amberketal; AMBERKETAL IPM; Ambermax; Ambrocenide; AMBROFIX; AMBROFIX FLAKES; Belambre; BOISAMBRENE FORTE; CEDRYL ACETATE LIQUID; CEDRYL METHYL ETHER; CETALOX; ISO E SUPER; KARANAL; KEPHALIS; TIMBEROL; TRIMOFIX O; ANIMALIS 1745 SUBST. PMF 2; cade oils, essences, extracts, replacers substitutes; GUAIACOL; INDOFLOR; Indole; Indolene; ANETHOLE; ANISE STAR OIL; ANISIC ALDEHYDE; ANISYL ACETATE; DIHYDRO ANETHOLE; ESTRAGOLE; fennel sweet oils, essences, extracts, bases, replacers or substitutes; FENNEL SWEET DQ (AC) N 41632TT; FENNEL OIL SWEET; and FENNEL OIL SWEET TECH; Benzoin oils, essences, extracts, replacers or substitutes; BENZYL ALCOHOL; BENZYL CINNAMATE; Olibanum oils, essences, extracts, replacers or substitutes; OLIBANUM OIL SOMALIA ORPUR; PHENYL ETHYL PHENYL ACETATE; Armoise oils, essences, extracts, replacers or substitutes; Camphor and Camphor oils, essences, extracts, replacers or substitutes; Eucalyptol and Eucalyptol oils, essences, extracts, replacers or substitutes; Lavandin oils, essences, extracts, replacers or substitutes; Lavender oils, extracts, essences, replacers or substitutes; Rosemary oils, essences, extracts, replacers or substitutes; and Thuja oils, essences, extracts, replacers or substitutes; ACETAL CD; AMYL CINNAMIC ALDEHYDE; AMYL SALICYLATE; AURANTIOL PURE BENZYL ACETATE; BENZYL SALICYLATE; BOURGEONAL; CITRONELLOL; CITRONELLYL ACETATE; CRESYL METHYL ETHER PARA; CYCLAMEN ALDEHYDE EXTRA; CYCLOHEXAL; CYCLOHEXYL SALICYLATE; DIMETHYL ANTHRANILATE; DIMETHYL PHENYL THYL CARBINOL; DUPICAL; ETHYL LINALOOL; FLOROSA; FLOROSA HC; GERANIOL; Geranium oils, essences, extracts, replacers or substitutes; GERANODYLE; GERANYL ACETATE; GERANYL BUTYRATE; HEDIONE; HEDIONE HC; HEXENYL-3-CIS SALICYLATE; HEXYL CINNAMIC ALDEHYDE; HEXYL CINNAMIC ALDEHYDE DQ AC XI 41505TT; HEXYL SALICYLATE; HYDROXYCITRONELLAL; ISOBUTYL PHENYL ACETATE; ISOBUTYL SALICYLATE; JASMATONE; Jasmin oils, essences, extracts, replacers or substitutes; JASMONE CIS; JASMONYL; JASMOPYRANE FORTE; LILIAL and lilial substitutes; LINALOOL; MEFROSOL; METHYL ANTHRANILATE; METHYL ANTHRANILATE EXTRA; METHYL BENZOATE; METHYL PHENYL ACETATE; Neroli oils, essences, extracts, replacers or substitutes; NEROLINE CRYSTALS; NEROLIONE; Orange oils, essences, extracts, replacers or substitutes; ORANGER CRYSTALS; ORANGER FLEUR CREME 1103/20; PELARGOL; PEONILE; PETALIA; PHENYL ETHYL ACETATE; PHENYL ETHYL ALCOHOL; PHENYL ETHYL ISOVALERATE; PHENYL ETHYL SALICYLATE CRYSTALS; ROSACETOL; ROSALVA; Rose oils, essences, extracts, replacers or substitutes; SUPER MUGUET; TERPINEOL PURE; TETRAHYDRO LINALOOL; VERDANTIOL; YARA YARA; Ylang oils, essences, extracts, replacers or substitutes; ACETATE C 6 HEXYLIC; AGRUMEX; ALLYL AMYL GLYCOLATE; ALLYL CAPROATE; ALLYL CYCLOHEXYL PROPIONATE; ALLYL OENANTHATE; AMYL BUTYRATE; APHERMATE; Apple oils, essences, extracts, replacers or substitutes; Banana oils, essences, extracts, replacers or substitutes; BENZYL BUTYRATE; BENZYL ISOBUTYRATE; BENZYL PROPIONATE; BUTYL ACETATE; BUTYRIC ACID; Cassis oils, essences, extracts, replacers or substitutes; COGNAC WHITE OIL EXTRA DQ (AC) 41547TT; CYCLOGALBANATE; DAMASCENONE; DAMASCONE ALPHA; DAMASCONE BETA; DAMASCONE DELTA; DECALACTONE DELTA; DECALACTONE GAMMA; Dewfruit oils, essences, extracts, replacers or substitutes; DIETHYL MALONATE; DIMETHYL BENZYL CARBINYL ACETATE; DIMETHYL BENZYL CARBINYL BUTYRATE; DODECALACTONE DELTA; DODECALACTONE GAMMA; ETHYL ACETOACETATE; ETHYL BUTYRATE; ETHYL CAPROATE; ETHYL CAPRYLATE; ETHYL ISOAMYL KETONE; ETHYL ISOBUTYRATE; ETHYL METHYL-2-BUTYRATE; ETHYL OENANTHATE; ETHYL PELARGONATE; ETHYL PROPIONATE; ETHYL SAFRANATE; FLOROCYCLENE; FRAISTONE; FRUCTONE; FRUITATE; GARDOCYCLENE; GIVESCONE; Guave oils, essences, extracts, replacers or substitutes; HEXENYL-3-CIS BUTYRATE; HEXENYL-3-CIS ISOBUTYRATE; HEXYL BUTYRATE; HEXYL ISOBUTYRATE; ISOAMYL ACETATE EXTRA; ISOAMYL BUTYRATE FR; JASMACYCLENE; MANZANATE; Melon oils, essences, extracts, replacers or substitutes; METHOXY PHENYL BUTANONE; METHYL HEPTENONE PURE; METHYL HEXYL KETONE; METHYL-2-PENTENOIC ACID; 2-NECTARYL; OCTALACTONE GAMMA; PEACH PURE; PHENOXY ETHYL ISOBUTYRATE; PHENYL ETHYL ISOBUTYRATE; PRUNOLIDE; RASPBERRY KETONE (N 112); and STRAWBERRY PURE; AMYL VINYL CARBINOL; OCIMENE; ACETOIN; Acetyl pyrazine; BENZALDEHYDE; BUTYL BUTYRO LACTATE; Chocolate oils, essences, extracts, replacers or substitutes; CORYLONE DRIED; CYCLOTENE; Ethyl maltol; Homofuronol; Hydroxy ethyl methyl thiazol; ISOBUTAVAN; and MALTYL ISOBUTYRATE; ACETAL E; ALCOHOL C 6 HEXYLIC; ALDEHYDE C 6 HEXYLIC FOOD GRADE; BUTYL QUINOLINE SECONDARY; CYCLAL C; DIPHENYL OXIDE; ELINTAAL; ETHYL DECADIENOATE; ETHYL DIMETHYL Pyrazine; Galbanone; GARDENOL; Hexenal-2-trans; HEXENOL-2-TRANS; HEXENOL-3-CIS; HEXENYL-3-CIS ACETATE; HEXENYL-3-CIS BENZOATE; HEXENYL-3-CIS PROPIONATE; ISOCYCLOCITRAL; Isohexylmethoxy pyrazine; LIFFAROME; LIGANTRAAL; MACEAL; METHYL OCTYNE CARBONATE; NEOFOLIONE; Nonadienal; NONADIENOL-2,6; Nonenal-6-cis; NONENOL-6-CIS; Petitgrain oils, essences, extracts, replacers or substitutes; Phenoxyacetaldehyde; Phenyl acetaldehyde; PYRALONE; RESEDAL; ROSE OXIDE; ROSYRANE SUPER; STEMONE; TRICYCLAL; TRIFERNAL; UNDECATRIENE; UNDECAVERTOL; Violet nitrile; VIRIDINE; Basil oils, essences, extracts, replacers or substitutes; Camomile oils, essences, extracts, replacers or substitutes; CITRONELLAL; Clary sage oils, essences, extracts, replacers or substitutes; CYPRISATE; Eucalyptus oils, extracts, essences, replacers or substitutes; HERBOXANE; PINOACETALDEHYDE; TANAISONE; Thyme oils, essences, extracts, replacers or substitutes; THYMOL CRYSTALS; ADOXAL; Azurone; CALONE 1951; FENNALDEHYDE; FLORALOZONE; FLORHYDRAL; MELONAL; SCENTENAL; TROPIONAL; and VERNALDEHYDE; Buchu leaf oils, essences, extracts, replacers or substitutes; CARVONE LAEVO; Cornmint oils, essences, extracts, replacers or substitutes; FRESKOMENTHE; ISOMENTHONE DL; MENTHOL LAEVO; MENTHOL-DL; MENTHONE; MENTHYL ACETATE; Peppermint oils, essences, extracts, replacers or substitutes; and Spearmint oils, essences, extracts, replacers or substitutes; AMBRETTOLIDE; CASHMERAN; COSMONE; Cyclopentadecanolide; ETHYLENE BRASSYLATE; GALAXOLIDE; GALAXOLIDE S; HABANOLIDE; MUSCENONE; MUSK C14; SERENOLIDE; SILVANONE SUPRA; SYLKOLIDE; VELVIONE; CETONE V; DIHYDRO IONONE BETA; IONONE BETA; IRISONE ALPHA; IRISONE PURE; ISORALDEINE 70; ISORALDEINE 95; ORIVONE; Anjeruk; Corps cassis; Corps pamplemousse; Dimethyl sulphide; GARDAMIDE; Labienoxime; Mercaptans; METHYL ISOPROPYL THIAZOLE; Nardozeste oils, essences, extracts, replacers or substitutes; NEOCASPIRENE EXTRA; NONIVAMIDE 1% TRIACETIN; Oxane; PARADISAMIDE; Paramenthone; ACETOPHENONE; AUBEPINE PARA CRESOL; BICYCLO NONALACTONE; COUMARIN; Ethyl laitone; ETHYL VANILLIN; HELIOTROPIN; Vanilla oils, essences, extracts, replacers or substitutes; VANILLIN; Vanolia oils, essences, extracts, replacers or substitutes; VERATRIC ALDEHYDE; BORNEOL; BORNYL ACETATE LIQUID; BUTYL CYCLOHEXANOL PARA; BUTYL CYCLOHEXYL ACETATE PARA; Cedar wood oils, essences, extracts, replacers or substitutes; CONIFERAN; EBANOL; EVERNYL; FENCHYL ACETATE; Guaiac wood oils, essences, extracts, replacers or substitutes; ISONONANYL ACETATE; JAVANOL; KOHINOOL; MENTHANYL ACETATE; METHYL CEDRYL KETONE; NOPYL ACETATE; OSYROL; OXYOCTALINE FORMATE; Patchouli oils, essences, extracts, replacers or substitutes; PINENE ALPHA; PINENE BETA; RADJANOL; RADJANOL SUPER; Turpentine oils, essences, extracts, replacers or substitutes; VERTOFIX COEUR; and Vetiver oils, essences, extracts, replacers or substitutes; ALDEHYDE C12; and MENTHYL ACETATE.
12. The fragrance composition of embodiment 1, wherein the composition is substantially free or essentially free of one or more macrocyclic musk compounds.
13. A consumer product comprising the fragrance composition of embodiment 1, wherein the consumer product is an air care product, home care product, personal care product, a sanitary product, a pet care product, a sanitary product, a fine fragrance, a hair care product or a beauty care product.
14. A method for improving at least one sleep benefit to a subject, wherein the method comprises: providing a fragrance composition of embodiment 1 or a consumer product of embodiment 13 to the subject in an amount effective to improve the at least one sleep benefit, preferably wherein the fragrance composition or the consumer product is: (i) sprayed or applied onto a subject; (ii) sprayed or applied onto upholstery or fabric, preferably bedding, laundry, blanket or pillow-case; and/or (iii) dispersed or diffused into the air.
15. The method of embodiment 14, wherein the at least one sleep benefit is selected from the group consisting of improvement in sleep quality, increase in total sleep time, decrease in wake after sleep onset (WASO), decrease in proportion of time awake after sleep onset (% Wake), increase in deep sleep (N3/N4) duration, increase in proportion of time spent in deep sleep (N3/N4), increase in REM sleep duration, increase in proportion of time spent in REM Sleep, increase in light sleep (N1/N2) duration, increase in proportion of time spent in light sleep (N1/2), increase in sleep efficiency, increase in sleep maintenance, decrease in number of awakenings during sleep, decrease in sleep onset, increase in feeling of being well-rested, increase in feeling of being refreshed upon awakening and/or after awakening, increase in feeling of being recharged, increase in feeling of being ready for the day, decrease in feeling of daytime sleepiness, or a combination thereof, preferably wherein the sleep benefit is biometrically measured or perceived.

### EXAMPLES

The following examples are provided to further illustrate the invention and are not to be construed as limitations of the invention, as many variations of the present invention are possible without departing from its spirit or scope.

### Example 1: Preparation of Fragrance and Unscented Control Compositions

Fragrance Examples 1 and 2 as provided below in Tables 1 and 2, respectively, are non-limiting examples of formulations of fragrance compositions according to the present disclosure. Unscented Example 1 as provided in Table 3 is a control not within the scope of the present disclosure. The following fragrance formulations are made by admixing the listed ingredients in the listed proportions at room temperature.

TABLE 1
Fragrance Example 1

| Fragrance Ingredient | CAS | Wt % |
|---|---|---|
| Indeno[4,5-d]-1,3-dioxin, | 365411-50-3 | 43.5% |
| 4,4a,5,6,7,8,9,9b-octahydro-7,7,8,9,9- | | |
| pentamethyl | | |
| 7,7,8,9,9-pentamethyl-6,6a,7,8,9,9a- | 1356400-59-3 | 43.5% |
| hexahydro-5H- | | |
| cyclopenta[h]quinazoline | | |
| 1,1,2,3,3-pentamethyl-2,5,6,7- | 33704-61-9 | 10.9% |
| tetrahydroinden-4-one | | |
| 1-Propanol, 2-[1-(3,3- | 141773-73-1 | 2.1% |
| dimethylcyclohexyl)ethoxy]-2- | | |
| methyl-,1-propanoate | | |
| | Total | 100% |

TABLE 2
Fragrance Example 2

| Fragrance Ingredient | CAS | Wt % |
|---|---|---|
| Indeno[4,5-d]-1,3-dioxin,4,4a,5,6,7,8,9,9b- | 365411-50-3 | 43.5% |
| octahydro-7,7,8,9,9-pentamethyl | | |
| 7,7,8,9,9-pentamethyl-6,6a,7,8,9,9a- | 1356400-59-3 | 43.5% |
| hexahydro-5H-cyclopenta[h]quinazoline | | |
| 1,1,2,3,3-pentamethyl-2,5,6,7- | 33704-61-9 | 10.9% |
| tetrahydroinden-4-one | | |
| 7,7,8,9,9-pentamethyl-6,7,8,9-tetrahydro- | 1315251-11-6 | 2.1% |
| 5H-cyclopenta[h]quinazoline | | |
| | Total | 100% |

TABLE 3
Unscented Example 1

| Ingredient | Wt % |
|---|---|
| CASTOR OIL HYDROGENATED PEG-40 | 1.5% |
| Isopropyl Myristate (IPM) | 0.5% |
| Alcohol 40 | 10% |
| Proxcl ™ GXL (preservative) | 0.05% |
| Distilled Water | 87.95% |

The fragrance examples were administered to the participants via a pillow spray application. The pillow spray application was formulated as described in Table 4. In order to create the pillow spray application, each of the fragrance compositions (Fragrance Example 1 or Example 2) were first mixed with Isopropyl Myristate (IPM) and then mixed with the CASTOR OIL HYDROGENATED PEG-4 according to the percentages defined in Table 4. The rest of ingredients were then added to make the final formulation. For the fragrance sample, each subject was provided with 20 mL of formulation in a 2 oz white HDPE plastic bottle with a fine mist sprayer cap (supplied by Brad Pak Enterprises, Garwood, NJ). The subject also received the unscented sample in a similar bottle. Both samples were blind coded for the studies.

TABLE 4
Pillow Spray Formulation

| Ingredient | Wt % |
|---|---|
| CASTOR OIL HYDROGENATED PEG-40 | 1.5% |
| Isopropyl Myristate (IPM) | 0.27% |
| Fragrance | 0.23% |
| Alcohol 40 | 10% |
| Proxel ™ GXL (preservative) | 0.05% |
| Distilled Water | 87.95% |

All the fragrance compositions used for the studies were reviewed and approved by IFF's Global Regulatory Affairs (GRA) as safe for use with human subjects in pillow mist application at the specific dose of 0.5%.

### Example 2: Sleep Improvement with Fragrance Compositions

The aim of this example is to show the sleep benefit of using fragrance compositions of the present disclosure. Two sleep studies were conducted. Participants in the studies were between 18-60 years old and overall healthy with self-reported mild sleep disturbances caused by lifestyle factors, but no record of clinical sleep disorders. Furthermore, the participants were without erratic sleep patterns or schedules. Study 1 (with Fragrance Example 1) included 51 participants, including 27 females and 24 males between the ages of 22-55. Study 2 (with Fragrance Example 2) included 52 participants, including 29 females and 23 males between the ages of 20-57. During the studies and three weeks prior to the start of the studies, the participants did not take any kind of sleep aids or medication affecting sleep. The studies were conducted in the participants own bedrooms, and the participants were encouraged to keep to their habitual sleep schedule throughout the duration of the study. All participants provided an informed consent before participation, and all study procedures including participant recruitment were reviewed and approved by the Western Institutional Review Board (WIRB).

All participants were provided with a SleepScore™ Max device (SleepScore Labs, Carlsbad, California) along with setup instructions and an anonymized user account. All participants were required to download the SleepScore™ Max app from the Apple® app store onto their smart phone, and then paired the SleepScore™ Max app to the SleepScore™ Max device. Once paired, the unit was placed between 1.3 to 3.9 feet (i.e., an arm's length) away from the participant. The bottom of the unit should be just above the top of the mattress, and no items are placed between the unit and the participants. Objects with moving parts (e.g., fans) near the unit were avoided to ensure minimal interference. The bedrooms were kept at room temperature (i.e., 25-28° C.) and 38-85% relative humidity. The SleepScore™ Max device was used to monitor sleep behaviours of the participants. Nightly summary data of the system were downloaded using the SleepScore™ data view platform.

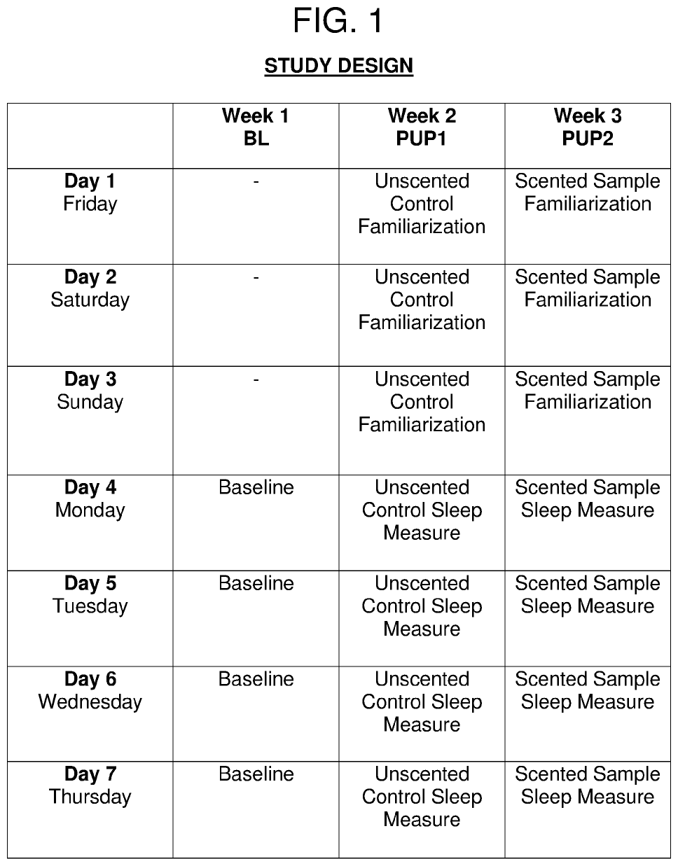

FIG. 1 shows the design used for the studies. The 3 nights/days familiarization period at the start of the study was used by the participants to familiarize themselves with the fragrance example, unscented control and the application format. Each study were started on a Monday of any given week and ran for a total of 3 weeks and were divided into 3 periods: (i) baseline period (“BL”; week 1); (ii) Product Use Period 1 (“PUP1”; week 2); and (iii) Product Use Period 2 (“PUP2”; week 3). The order of presentation between unscented control and scented samples were counterbalanced across the participants.

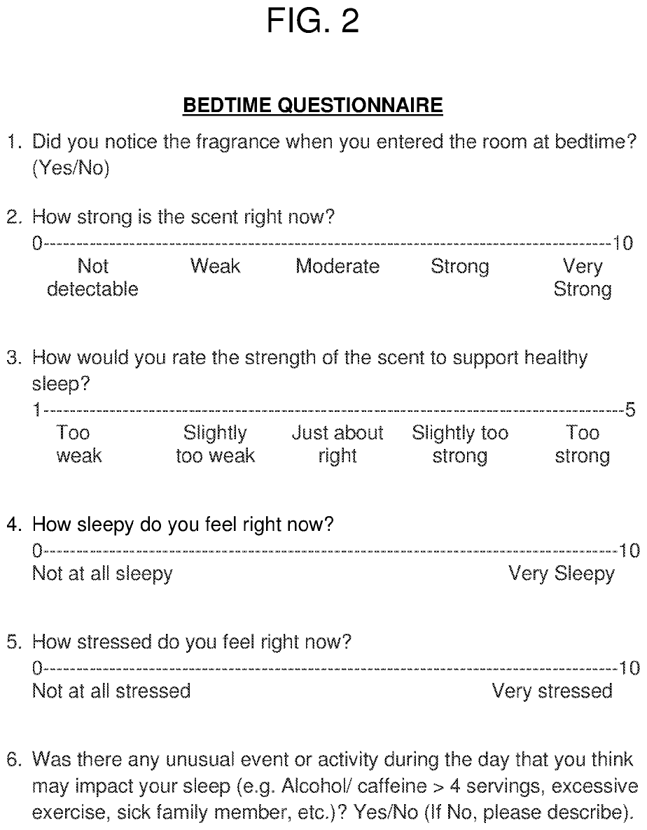

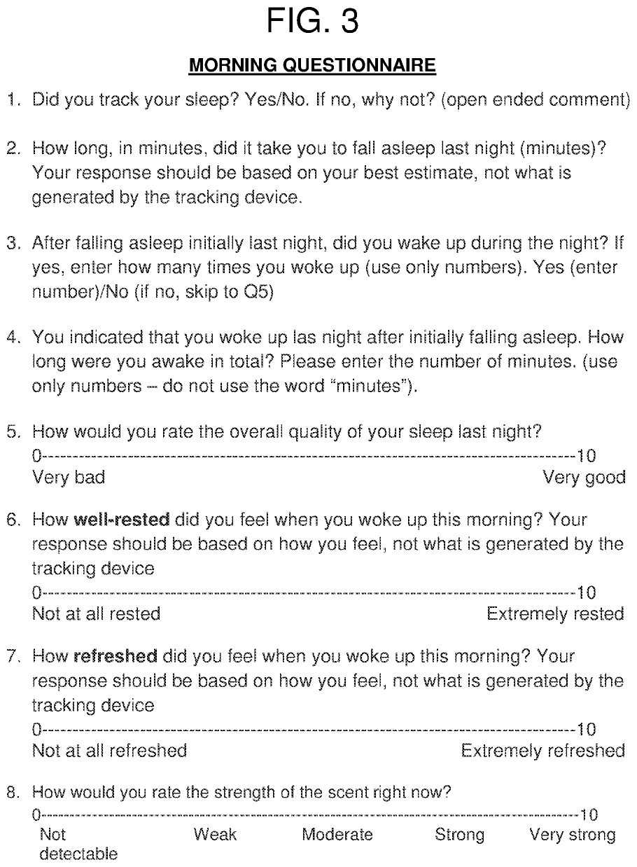

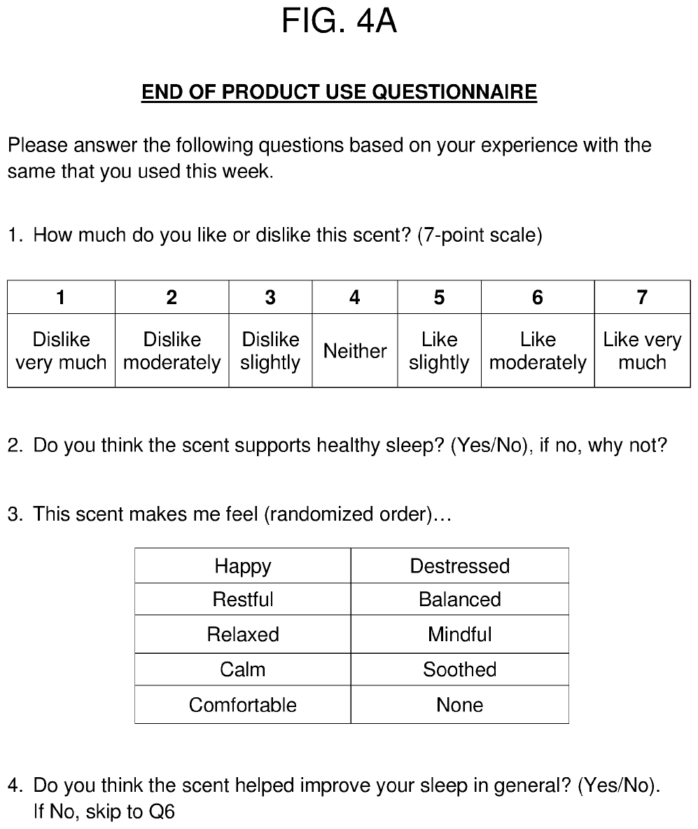

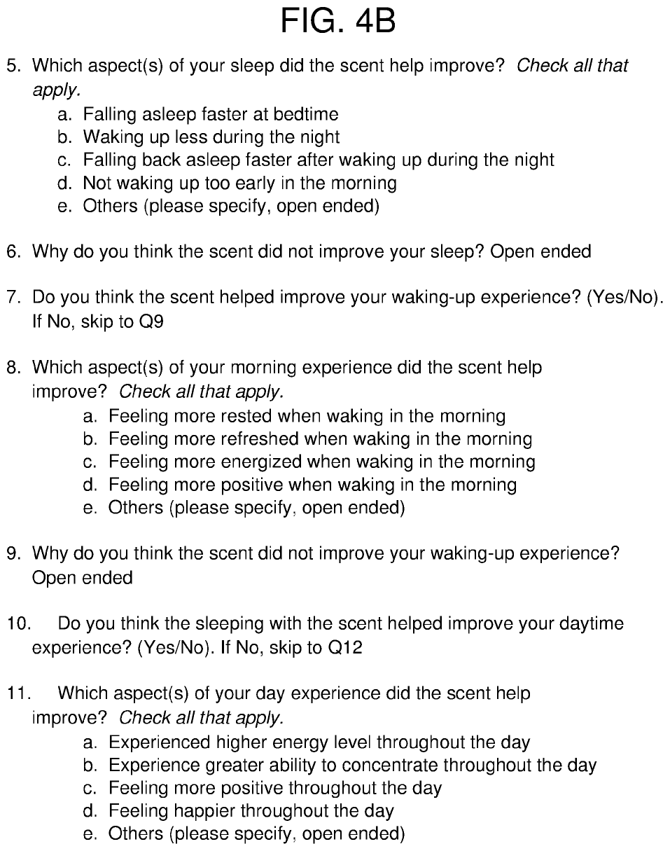

On any given night of the study, the participants were required to apply 3 sprays across the pillow-case just before bedtime and complete the bedtime questionnaire as provided in FIG. 2. Before turning off the lights, the participants were required to turn on the sleep tracking via the SleepScore™ Max app on their smart phone. In the morning, participants were required to turn off the sleep tracking as soon as they got out of bed. Participants were also required to complete the morning questionnaire as provided in FIG. 3 once they are fully awake but before they started their morning routine. All questionnaires are completed electronically via a web-based data collection software (Compusense®). The bedtime questionnaire was set to expire at 2 am in the morning and morning questionnaire was set to expire at 12 pm, after which the participants were unable to complete the questionnaires. Participants did not have access to their responses from previous day(s) when completing the questionnaire. In addition, participants were required to fill out the questionnaires based on their own sleep experience without reference to the sleep measurements displayed on the SleepScore™ Max app. Participants were also required to complete a product use questionnaire as provided in FIGS. 4A and 4B. The product use questionnaire surveys the participants experience of the product used in the prior nights.

With continued reference to FIG. 1, during the BL period the participants were required to track their sleep using the SleepScore™ Max device and complete the bedtime and morning questionnaires. During PUP1 and PUP2 periods, the participants were required to track their sleep using the SleepScore™ Max device and completed the bedtime and morning questionnaires. The participants were also required to use the Control Example 1 or the Fragrance Examples 1 and/or 2, as per the instructions in FIG. 1. The first three nights (Friday to Sunday) were considered as familiarization nights. The PUP periods ran from Friday night through Thursday night the following week. The studies were conducted blind such that the participants did not know if they were receiving the Control Example or the Fragrance Examples.

The results of the studies were curated to remove outliers before performing any statistical analyses. All data from familiarization nights were excluded from statistical analysis. Nightly objective sleep data, as well as bedtime and morning self-reports, were analyzed in R (version 4.1) using multilevel regression analyses, considering the nested structure of the data (nights within subjects). An alpha level of 0.05 was used in one-tailed test. The following regression model was used:

$${SleepParameter}_{ij} = {Const}_{0 i} + β * {TestPeriod}_{ij}$$

coded as 0 for the observations during control or baseline use, and 1 for nights during active scent use. For both the self-report and objective data, analyses included within-subjects comparison of nights or days in the Fragrance Examples use and Control Example use periods on which participants tracked their sleep and, reported uses on previous night in full compliance the provided instructions. A secondary analysis was also conducted using the same approach but using BL as the control condition. In case the distribution of the sleep onset latencies (SOL) and/or the amount of wake time after sleep onset (WASO) was skewed and failed to meet the normality assumption required for the statistical test, log transformations were applied before analysis.

Table 5 summarizes the biometrically measured parameters using the SleepScore™ Max device for Study 1. The results demonstrate the increase in quantity and/or quality of sleep of participants exposed to Fragrance Example 1 of the present disclosure as compared to Control Example 1. Similar results were observed for the self-reported measures (data not shown).

TABLE 5
Fragrance Example 1 vs Control Example 1 (Biometric Measures)

| | Control | Fragrance | |
|---|---|---|---|
| | Example 1 | Example 1 | |
| Objective Measure | Mean (SEM) | Mean (SEM) | p-value |
| Sleep Score ¹ | 78.81 (1.0) | 81.47 (0.9) | P < 0.05 |
| Body Score ² | 81.47 (0.9) | 83.57 (0.9) | p < 0.05 |
| Total Sleep Time | 373.5 (6.3) | 382.8 (5.6) | 0.404 |
| Sleep Onset Latency | 21.61 (1.4) | 18.08 (1.3) | p < 0.01 |
| (SOL) ³ | | | |
| WASO ⁴ | 35.31 (1.9) | 31.10 (1.8) | p < 0.05 |
| Sleep Efficiency ⁵ | 84.91 (0.6) | 86.99 (0.6) | p < 0.01 |
| Sleep Maintenance ⁶ | 89.43 (0.6) | 90.79 (0.5) | p < 0.05 |
| Deep Sleep Time ⁷ | 75.77 (2.3) | 81.85 (2.3) | p < 0.05 |
| % Deep ⁸ | 18.47 (0.6) | 20.06 (0.6) | p < 0.05 |

¹ Sleep Score (1-100) is an aggregate measure of your overall sleep quality and is based on all of the participants nightly sleep data and is normalized for age and gender.
² Body Score (1-100) is a metric that indicates how physically restorative the sleep. The score takes into account deep sleep and is normalized for age and gender.
³ Sleep Onset Latency (minutes) is the time taken to fall asleep.
⁴ WASO (minutes) is the time spent awake during the night after initially falling asleep (WASO).
⁵ Sleep Efficiency (0-100) is the percentage of time spent in bed asleep during the night.
⁶ Sleep Maintenance (0-100) is the percentage of time spent in bed asleep during the night after excluding the time for sleep onset from time in bed.
⁷ Deep Sleep Time (minutes) is the total time spent in deep sleep stage during the night.
⁸ % Deep (0-100) is the percentage of the total sleep time spent in deep sleep stage.

The results as presented in Table 5 show the beneficial effects on sleep from exposure to Fragrance Example 1. Participants fell asleep faster (−2.7 mins, −19%, p<0.01) and spent less time awake during the night (−4.9 mins, 19%, p<0.05) when exposed to the Fragrance Example 1 vs the Control Example 1. Consequently, the participants improved their sleep efficiency (+1.8%, p<0.01) and sleep maintenance (+1.1%, p<0.05). Participants also spent more time in deep sleep, both in absolute time (+4.9 minutes, +6%, p<0.05) and relative measure (+1.5%, p<0.05%). As a result, there was an overall improvement in Sleep Score (+2, +3%, p<0.05) and Body Score (+1.8, +2%, p<0.05) observed with the Fragrance Example 1 vs the Control Example 1.

Table 6 summarizes the biometrically measured parameters using the SleepScore™ Max device for Study 2. Table 7 summarizes the self-reported measures for Study 2. The results demonstrate the increase in quantity and quality of sleep of participants exposed to Fragrance Example 2 of the present disclosure as compared to Control Example 1.

TABLE 6
Fragrance Example 2 vs Control Example 1 (Biometric Measures)

| | Control | Fragrance | |
|---|---|---|---|
| | Example 1 | Example 2 | |
| Objective Measure | Mean (SEM) | Mean (SEM) | p-value |
| Sleep Score ¹ | 78.78 (1.0) | 79.29 (0.9) | 0.624 |
| Total Sleep Time | 374.6 (5.5) | 377.1 (5.6) | 0.703 |
| Sleep Onset Latency | 22.52 (1.4) | 19.13 (1.2) | p < 0.05 |
| (SOL) ² | | | |
| WASO ³ | 39.76 (2.1) | 38.53 (2.1) | 0.485 |
| Sleep Efficiency ⁴ | 84.13 (0.7) | 85.05 (0.6) | 0.179 |
| Sleep Maintenance ⁵ | 88.81 (0.6) | 89.13 (0.6) | 0.684 |

¹ Sleep Score (1-100) is an aggregate measure of your overall sleep quality and is based on all of the participants nightly sleep data and is normalized for age and gender.
² Sleep Onset Latency (minutes) is the time taken to fall asleep.
³ WASO (minutes) is the time spent awake during the night after initially falling asleep (WASO).
⁴ Sleep Efficiency (0-100) is the percentage of time spent in bed asleep during the night.
⁵ Sleep Maintenance (0-100) is the percentage of time spent in bed asleep during the night after excluding the tiem for sleep onset from time in bed.

TABLE 7
Fragrance Example 2 vs Control Example
1 (Self-Reported Measures)

| | Control | Fragrance | |
|---|---|---|---|
| | Example 1 | Example 2 | |
| Objective Measure | Mean (SEM) | Mean (SEM) | p-value |
| Sleepiness @ bedtime | 7.5 (0.1) | 7.6 (0.1) | p < 0.05 |
| Sleep Quality ¹ | 7.2 (0.1) | 7.4 (0.1) | p < 0.05 |
| Feeling Well-Rested ² | 6.9 (0.1) | 7.2 (0.1) | p < 0.01 |
| Feeling Refreshed ³ | 6.9 (0.1) | 7.1 (0.1) | p < 0.05 |

¹ Sleep Quality (0-10) is a self-reporting metric scored on a scale from 0-10, with 0 representing poor quality of sleep and 10 representing excellent quality of sleep.
² Feel Well-Rested (0-10) is a self-reporting metric scored on a scale from 0-10, with 0 representing feeling not well-rested and 10 representing feeling very well-rested.
³ Feeling Refreshed (0-10) is a self-reporting metric scored on a scale from 0-10, with 0 representing feeling not refreshed and 10 representing feeling very refreshed.

The results as presented in Table 6 show the beneficial effects on sleep from exposure to Fragrance Example 2. Participants fell asleep faster (−2.4 mins, −15%, p<0.05). Consequently, the participants reported an overall improvement in sleep quality (+0.3, +4%, p<0.05) as well as feeling more well-rested (+0.3, +4%, p<0.01) and more refreshed (+0.2, +4%, p<0.05) in the morning when exposed to the Fragrance Example 2 vs the Control Example 1.

### Example 3: Sleep Improvement with Exemplary Fragrance Compositions

The impact of a third exemplary fragrance, Fragrance Example 3 (see, Table 8, formulated as described in Example 1), on sleep was assessed according to the methods described in Examples 1 and 2. Fragrance Example 3 was tested in a pillow spray at half the dose tested for Fragrance Examples 1 and 2 (see, Example 1) and compared against an unscented control pillow spray (Unscented Example 2, see, Table 10). The study included 51 participants, including 32 females and 19 males between the ages of 20-60.

TABLE 8
Fragrance Example 3

| Fragrance Ingredient | CAS | Wt % |
|---|---|---|
| Indeno[4,5-d]-1,3-dioxin,4,4a,5,6,7,8,9,9b- | 365411-50-3 | 44% |
| octahydro-7,7,8,9,9-pentamethyl | | |
| 7,7,8,9,9-pentamethyl-6,6a,7,8,9,9a- | 1356400-59-3 | 44% |
| hexahydro-5H-cyclopenta[h]quinazoline | | |
| 1,1,2,3,3-pentamethyl-2,5,6,7- | 33704-61-9 | 11% |
| tetrahydroinden-4-one | | |
| 2,2,6,6,7,8,8-heptamethyl-3a,5,6,7,8,8b- | 823178-41-2 | 1% |
| hexahydro-4H-indeno[4,5-d][1,3]dioxole | | |
| | Total | 100% |

TABLE 9
Scented Pillow Spray Formulation

| Ingredient | Wt % |
|---|---|
| CASTOR OIL HYDROGENATED PEG-40 | 0.75% |
| Isopropyl Myristate (IPM) | 0.14% |
| Fragrance Example 3 | 0.11% |
| Alcohol 40 | 10% |
| Proxel ™ GXL (preservative) | 0.05% |
| Distilled Water | 88.95% |

TABLE 10
Unscented Example 2 Pillow Spray

| Ingredient | Wt % |
|---|---|
| CASTOR OIL HYDROGENATED PEG-40 | 0.75% |
| Isopropyl Myristate (IPM) | 0.25% |
| Alcohol 40 | 10% |
| Proxel ™ GXL (preservative) | 0.05% |
| Distilled Water | 88.95% |

Table 11 summarizes the biometrically measured parameters using the SleepScore™ Max device for the study. The results as presented in Table 11 show that a low dose, e.g., as compared to Examples 1 and 2, of exemplary compounds described herein can beneficially impact sleep.

TABLE 11
Fragrance Example 3 vs Unscented
Example 2 (Biometric Measures)

| | Unscented | Fragrance | |
|---|---|---|---|
| | Example 2 | Example 3 | |
| Objective Measure | Mean (SEM) | Mean (SEM) | p-value |
| Sleep Score ¹ | 81.16 (0.89) | 82.33 (0.80) | 0.132 |
| Body Score ² | 81.62 (0.92) | 83.68 (0.79) | p < 0.05 |
| Total Sleep Time | 380.1 (5.79) | 386.5 (5.50) | 0.124 |
| Sleep Onset Latency | 21.67 (1.79) | 19.03 (1.50) | 0.149 |
| (SOL) ³ | | | |
| WASO ⁴ | 30.23 (1.82) | 31.90 (1.84) | 0.267 |
| Sleep Efficiency ⁵ | 86.93 (0.59) | 87.51 (0.54) | 0.332 |
| Sleep Maintenance ⁶ | 91.83 (0.56) | 91.91 (0.51) | 0.433 |
| Deep Sleep Time ⁷ | 74.92 (2.28) | 79.22 (2.00) | 0.097 |

¹ Sleep Score (1-100) is an aggregate measure of your overall sleep quality and is based on all of the participants nightly sleep data and is normalized for age and gender.
² Body Score (1-100) is a metric that indicates how physically restorative the sleep. The score takes into account deep sleep and is normalized for age and gender.
³ Sleep Onset Latency (minutes) is the time taken to fall asleep.
⁴ WASO (minutes) is the time spent awake during the night after initially falling asleep (WASO).
⁵ Sleep Efficiency (0-100) is the percentage of time spent in bed asleep during the night.
⁶ Sleep Maintenance (0-100) is the percentage of time spent in bed asleep during the night after excluding the time for sleep onset from time in bed.
⁷ Deep Sleep Time (minutes) is the total time spent in deep sleep stage during the night.

Exposure to Fragrance Example 3 resulted in improvements in Body Score (+1.8, +2%, p<0.05) compared to Unscented Example 2, suggesting that participants experienced an increase in time during deep sleep. Table 11 shows a trend in participants having an increased time in deep sleep.

Fragrance Example 2 (see, Table 2) was also tested in pillow spray at 0.11 wt % (half the dose tested in Examples 1 and 2; see, Table 4) and compared to Control Example 1 according to the methods described in Example 2. The study included 32 participants, including 24 females and 8 males between the ages of 23-60. The results are shown in Table 12.

TABLE 12
Fragrance Example 2 vs Control Example 1 (Biometric Measures)

| | Control | Fragrance | |
|---|---|---|---|
| | Example 1 | Example 2 | |
| Objective Measure | Mean (SEM) | Mean (SEM) | p-value |
| Sleep Score ¹ | 83.02 (1.06) | 85.47 (0.96) | p < 0.05 |
| Mind Score² | 79.94 (1.33) | 83.51 (0.97) | p < 0.05 |
| Total Sleep Time | 400.6 (7.33) | 411.2 (8.11) | p = 0.196 |
| REM Sleep Time³ | 78.67 (3.07) | 83.97 (2.56) | p < 0.05 |
| Sleep Efficiency⁴ | 86.15 (0.75) | 87.80 (0.61) | p < 0.05 |
| Sleep Maintenance⁵ | 91.09 (0.67) | 92.54 (0.50) | p < 0.05 |

¹ Sleep Score (1-100) is an aggregate measure of your overall sleep quality and is based on all of the participants nightly sleep data and is normalized for age and gender.
²Mind Score (1-100) is a metric that indicates how mentally refreshing the sleep. The score takes into account REM sleep and is normalized for age and gender.
³REM Sleep Time (minutes) is the total time spent in REM sleep stage during the night.
⁴Sleep Efficiency (0-100) is the percentage of time spent in bed asleep during the night.
⁵Sleep Maintenance (0-100) is the percentage of time spent in bed asleep during the night after excluding the time for sleep onset from time in bed.

As shown in Table 12, lower doses of Fragrance Example 2 (compared to the dose tested in Examples 1 and 2) also improve sleep benefits, with improvements observed in REM Sleep Time, Sleep Efficiency, and Sleep Maintenance. An overall improvement in sleep quality was evidenced by an increase in Sleep Score and Mind Score. Consistent with objective measures, participants also self-reported fewer interruptions, improved sleep quality, and feeling refreshed when using Fragrance Example 2 at the low dose (p<0.05 for all self-report measures).

These data demonstrate that combinations of exemplary compounds described herein provide sleep improvement across a range of concentrations.

### Example 4: Robustness of Sleep Improving Compositions

The ability of a sleep improving fragrance composition to maintain its sleep-improving benefits when formulated with additional ingredients lacking sleep benefits was assessed.

First, an existing Exemplary Full Fragrance (EFF1), which contained 7,7,8,9,9-pentamethyl-6,7,8,9-tetrahydro-5H-cyclopenta[h]quinazoline, was tested according to the method of Example 2 to determine whether it had an impact on sleep. EFF1 was formulated into a pillow spray as shown in Table 13, resulting in a concentration of 7,7,8,9,9-pentamethyl-6,7,8,9-tetrahydro-5H-cyclopenta[h]quinazoline at 0.00475 wt % in the pillow spray. The study included 54 participants, including 27 females and 27 males between the ages of 21-60.

TABLE 13
Pillow Spray Formulation for EFF1

| Ingredient | Wt % |
|---|---|
| CASTOR OIL HYDROGENATED PEG-40 | 1.5% |
| EFF1 | 0.5% |
| Alcohol 40 | 10% |
| Proxel ™ GXL (preservative) | 0.05% |
| Distilled Water | 87.95% |

Table 14 summarizes the biometrically measured parameters using the SleepScore™ Max device for EFF1 and Control Example 1.

TABLE 14
EFF1 vs Control Example 1 (Biometric Measures)

| | Control Example 1 | EFF1 | |
|---|---|---|---|
| Objective Measure | Mean (SEM) | Mean (SEM) | p-value |
| Sleep Score ¹ | 81.92 (0.84) | 81.10 (0.85) | 0.182 |
| Mind Score² | 79.07 (1.03) | 78.32 (1.04) | 0.291 |
| Total Sleep Time | 387.6 (5.19) | 381.8 (5.37) | 0.144 |
| Sleep Onset Latency | 21.86 (1.48) | 20.98 (1.32) | 0.217 |
| (SOL) ³ | | | |
| WASO ⁴ | 32.43 (2.08) | 32.84 (1.81) | 0.219 |
| Sleep Efficiency ⁵ | 86.37 (0.58) | 86.34 (0.56) | 0.478 |
| Sleep Maintenance ⁶ | 90.89 (0.52) | 91.00 (0.53) | 0.347 |
| REM Sleep Time ⁷ | 76.91 (2.24) | 74.29 (2.17) | 0.189 |
| % REM ⁸ | 18.18 (0.45) | 17.86 (0.45) | 0.322 |

¹ Sleep Score (1-100) is an aggregate measure of your overall sleep quality and is based on all of the participants nightly sleep data and is normalized for age and gender.
²Mind Score (1-100) is a metric that indicates how mentally refreshing the sleep. The score takes into account REM sleep and is normalized for age and gender.
³ Sleep Onset Latency (minutes) is the time taken to fall asleep.
⁴ WASO (minutes) is the time spent awake during the night after initially falling asleep (WASO).
⁵ Sleep Efficiency (0-100) is the percentage of time spent in bed asleep during the night.
⁶ Sleep Maintenance (0-100) is the percentage of time spent in bed asleep during the night after excluding the time for sleep onset from time in bed.
⁷ REM Sleep Time (minutes) is the total time spent in REM sleep stage during the night.
⁸ % REM (0-100) is the percentage of the total sleep time spent in REM sleep stage.

The results as presented in Table 14 indicate that EFF1 does not have a beneficial impact on sleep. The impact of formulating EFF1 with Fragrance Example 1 on sleep was next assessed.

Fragrance Example 1, described in Example 1 (see, Table 1), was formulated with EFF1 into a pillow spray as shown in Table 15 to form a mixed composition (MXC).

TABLE 15
Pillow Spray Formulation: Mixed Composition (MXC)

| Ingredient | Wt % |
|---|---|
| CASTOR OIL HYDROGENATED PEG-40 | 3% |
| Isopropyl Myristate (IPM) | 0.27% |
| Fragrance Example 1 | 0.23% |
| EFF1 | 0.5% |
| Alcohol 40 | 10% |
| Proxel ™ GXL (preservative) | 0.05% |
| Distilled Water | 85.95% |

The sleep study was conducted similarly to that described in Example 2. Thirty-one 31 participants between the ages of 18-60 years old (2 male, 29 female) with self-reported mild sleep disturbances caused by lifestyle factors, but no record of clinical sleep disorders were included in the study. Participants had normal smell, no allergies, and were not on medications that affected sleep. Furthermore, the participants were without erratic sleep patterns or schedules. During the studies and three weeks prior to the start of the studies, the participants did not take any kind of sleep aids or medication affecting sleep.

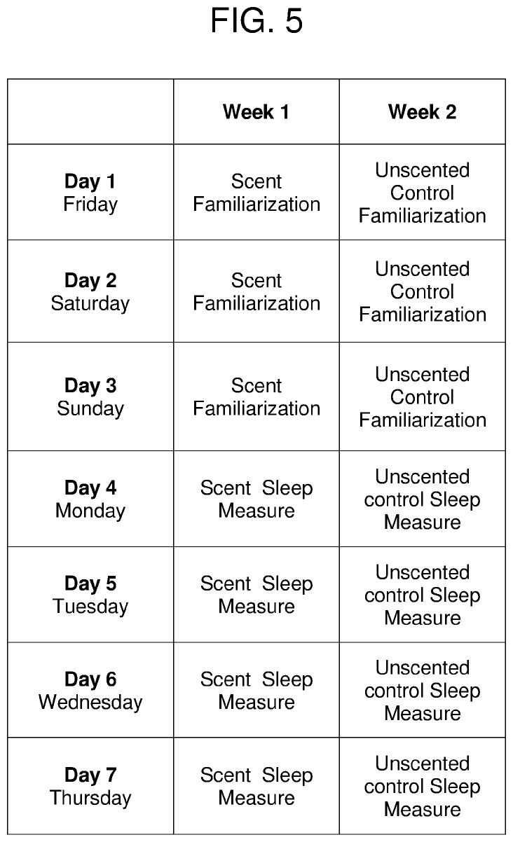

FIG. 5 shows the design used for the study. The 3 nights/days familiarization period at the start of the study was used by the participants to familiarize themselves with the MXC or the unscented control (Control Example 1) and the application format. The study took place over two weeks, with the first three days of each week dedicated to familiarization with the MXC or the Control Example 1. Sleep measurements were taken over the final four days of each week. The order of presentation between the unscented control and the MXC sample were counterbalanced across the participants.

Table 16 summarizes the biometrically measured parameters using the SleepScore™ Max device for MXC and Control Example 1.

TABLE 16
MXC vs Control Example 1 (Biometric Measures)

| | Control Example 1 | MXC | |
|---|---|---|---|
| Objective Measure | Mean (SEM) | Mean (SEM) | p-value |
| Sleep Score ¹ | 80.05 (1.42) | 82.46 (1.43) | p < 0.05 |
| Mind Score² | 75.11 (1.61) | 79.74 (1.63) | p < 0.01 |
| Total Sleep Time | 385.6 (7.58) | 401.6 (8.61) | p < 0.05 |
| Sleep Onset Latency | 23.59 (2.48) | 19.72 (2.21) | 0.149 |
| (SOL) ³ | | | |
| WASO ⁴ | 41.61 (3.72) | 35.99 (3.04) | 0.384 |
| Sleep Efficiency ⁵ | 84.20 (1.06) | 85.48 (1.1) | 0.106 |
| Sleep Maintenance ⁶ | 89.00 (0.89) | 89.98 (0.84) | 0.218 |
| REM Sleep Time ⁷ | 68.46 (2.86) | 80.28 (3.35) | p < 0.001 |
| % REM ⁸ | 15.84 (0.56) | 18.04 (0.62) | p < 0.001 |

¹ Sleep Score (1-100) is an aggregate measure of your overall sleep quality and is based on all of the participants nightly sleep data and is normalized for age and gender.
²Mind Score (1-100) is a metric that indicates how mentally refreshing the sleep. The score takes into account REM sleep and is normalized for age and gender.
³ Sleep Onset Latency (minutes) is the time taken to fall asleep.
⁴ WASO (minutes) is the time spent awake during the night after initially falling asleep (WASO).
⁵ Sleep Efficiency (0-100) is the percentage of time spent in bed asleep during the night.
⁶ Sleep Maintenance (0-100) is the percentage of time spent in bed asleep during the night after excluding the time for sleep onset from time in bed.
⁷ REM Sleep Time (minutes) is the total time spent in REM sleep stage during the night.
⁸ % REM (0-100) is the percentage of the total sleep time spent in REM sleep stage.

As shown in Table 16, addition of Fragrance Example 1 to EFF1 resulted in broad improvements in sleep parameters, with improvements in Total Sleep Time and REM Sleep Time. An overall improvement in sleep quality was evidenced by an increase Sleep Score and Mind Score. Consistent with objective measures, participants also self-reported fewer interruptions (−0.3, −18%, p<0.05) during the night and longer sleep duration (+16.8 minutes, +4.2%, p<0.01).

These data demonstrate that fragrances with sleep improving activity remain robust when formulated with fragrances lacking sleep improving benefits. Thus, compounds and compositions described herein may be formulated with ingredients lacking sleep improving benefits to produce a sleep improving fragrance composition.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present disclosure have been illustrated and described, it would be obvious to those skilled in the art that various other changes and modifications can be made without departing from the spirit and scope of the disclosure. It is therefore intended to cover in the appended claims all such changes and modifications that are within the scope of this disclosure.

What is claimed is:

1. A fragrance composition for sleep improvement comprising one or more compounds comprising a backbone structure of formula (I): 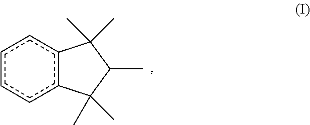
wherein:
each open position of the backbone structure is, independently, optionally substituted; [symbol]
is a single bond or double bond; and
the six-membered ring of formula (I) comprises 0-3 double bonds; and
wherein the one or more compounds comprising the backbone structure of formula (I) are present at a total concentration of greater than 0.05 wt % of the total weight of the composition.

2. The fragrance composition of claim 1, wherein the backbone structure of formula (I) has the structure of:

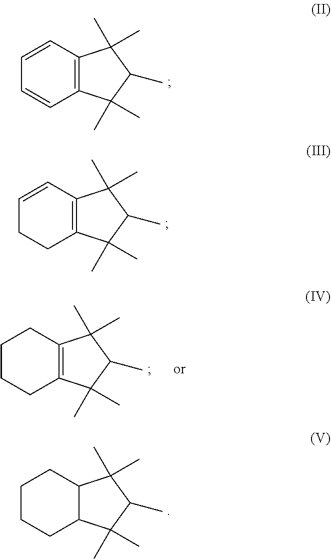

3. The fragrance composition of claim 1 or claim 2, wherein at least one of the one or more compounds comprising the backbone structure of formula (I) is a heteroatom musk compound.

4. The fragrance composition of any one of claims 1-3, wherein the fragrance composition comprises at least 2, 3, 4, or 5 compounds comprising the backbone structure of formula (I), optionally at least 3 compounds comprising the backbone structure of formula (I).

5. The fragrance composition of any one of claims 1-4, wherein the composition comprises the one or more compounds comprising the backbone structure of formula (I) at a total concentration in the range of about 0.1 wt % to about 100 wt % of the total weight of the composition.

6. A fragrance composition for sleep improvement comprising one or more heteroatom musk compounds, wherein the one or more heteroatom musk compounds are present at a total concentration greater than 0.05 wt % of the total weight of the composition.

7. The fragrance composition of claim 6, wherein at least one of the one or more heteroatom musk compounds comprises a backbone structure of formula (I): 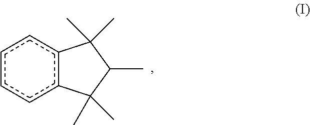
wherein:
each open position of the backbone structure is, independently, optionally substituted; [symbol]
is a single bond or double bond; and
the six-membered ring of formula (I) comprises 0-3 double bonds.

8. The fragrance composition of claim 6 or claim 7, wherein at least 2, 3, 4, or 5 of the one more heteroatom musk compounds comprise the backbone structure of formula (I), optionally, wherein at least 3 heteroatom musk compounds comprise the backbone structure of formula (I).

9. The fragrance composition of any one of claims 6-8, wherein the composition comprises one or more heteroatom musk compounds at a total concentration in the range of about 0.1 wt % to about 100 wt % of the total weight of the composition.

10. The fragrance composition of any one of claims 1-9, further comprising at least one acyclic musk compound.

11. The fragrance composition of claim 10, wherein the at least one acyclic musk compound is present at a total concentration of at least 0.0025 wt % of the total weight of the composition.

12. The fragrance composition of claim 10 or claim 11, wherein the mass ratio of the one or more heteroatom musk compounds or the one or more compounds comprising the backbone structure of formula (I) to the at least one acyclic musk compound is between about 55:1 to 45:1 or 52:1 to 47:1.

13. The fragrance composition of any one of claims 1-5 and 10-12, wherein the one or more compounds comprising the backbone structure of formula (I) arc one or more of 7,7,8,9,9-pentamethyl-6,6a,7,8,9,9a-hexahydro-5H-cyclopenta[h]quinazoline; Indeno[4,5-d]-1,3-dioxin,4,4a,5,6,7,8,9,9b-octahydro-7,7,8,9,9-pentamethyl; 1,1,2,3,3-pentamethyl-2,5,6,7-tetrahydroinden-4-one; 7,7,8,9,9-pentamethyl-6,7,8,9-tetrahydro-5H-cyclopenta[h]quinazoline; 2,2,6,6,7,8,8-heptamethyl-3a,5,6,7,8,8b-hexahydro-4H-indeno[4,5-d][1,3]dioxole; 4,6,6,7,8,8-Hexamethyl-1,3,4,6,7,8-hexahydrocyclopenta[g]isochromene; 2,2,6,6,7,8,8-heptamethyldecahydro-2H-indeno[4,5-b]furan; 2,6,6,7,8,8-hexamethyldecahydro-2H-indeno[4,5-b]furan; or stereoisomers of any of the foregoing.

14. The fragrance composition of any one of claims 6-12, wherein the one or more heteroatom musk compounds are one or more of 7,7,8,9,9-pentamethyl-6,6a,7,8,9,9a-hexahydro-5H-cyclopenta[h]quinazoline; Indeno[4,5-d]-1,3-dioxin,4,4a,5,6,7,8,9,9b-octahydro-7,7,8,9,9-pentamethyl; 1,1,2,3,3-pentamethyl-2,5,6,7-tetrahydroinden-4-one; 7,7,8,9,9-pentamethyl-6,7,8,9-tetrahydro-5H-cyclopenta[h]quinazoline; 2,2,6,6,7,8,8-heptamethyl-3a,5,6,7,8,8b-hexahydro-4H-indeno[4,5-d][1,3]dioxole; 4,6,6,7,8,8-Hexamethyl-1,3,4,6,7,8-hexahydrocyclopenta[g]isochromene; 2,2,6,6,7,8,8-heptamethyldecahydro-2H-indeno[4,5-b]furan; 2,6,6,7,8,8-hexamethyldecahydro-2H-indeno[4,5-b]furan; or stereoisomers of any of the foregoing.

15. The fragrance composition of any one of claims 10-14, wherein the at least one acyclic musk compound is 1-Propanol, 2-[1-(3,3-dimethylcyclohexyl)ethoxy]-2-methyl-, 1-propanoate; 1-(3,3-dimethylcyclohexyl)ethyl acetate; 2-(1-(3,3-dimethylcyclohexyl)ethoxy)-2-oxoethyl propionate; 2-(1-(3,3-dimethylcyclohexyl)ethoxy)-2-methylpropyl cyclopropanecarboxylate; 2-((3,5-dimethylhex-3-en-2-yl)oxy)-2-methylpropyl cyclopropanecarboxylate; or any combination thereof.

16. The fragrance composition of any one of claims 1-15, further comprising a solvent selected from Dipropylene glycol (DPG), isopropyl myristate, ethanol, triethyl citrate, or any combination thereof.

17. The fragrance composition of any one of claims 1-5 and 10-16, wherein the one or more compounds comprising the backbone structure of formula (I) are a neat fragrance, encapsulated, or a combination thereof.

18. The fragrance composition of any one of claims 6-17, wherein the one or more heteroatom musk compounds are a neat fragrance, encapsulated, or a combination thereof.

19. The fragrance composition of any one of claims 10-18, wherein the at least one acyclic musk compound is a neat fragrance, encapsulated, or a combination thereof.

20. A fragrance composition for sleep improvement comprising at least 4 fragrance ingredients comprising:
(i) at least 3 heteroatom musk compounds; and
(ii) at least 1 acyclic musk compound, 7,7,8,9,9-pentamethyl-6,7,8,9-tetrahydro-5H-cyclopenta[h]quinazoline, or 2,2,6,6,7,8,8-heptamethyl-3a,5,6,7,8,8b-hexahydro-4H-indeno[4,5-d][1,3]dioxole; and
optionally, a solvent selected from Dipropylene glycol (DPG), isopropyl myristate, ethanol, triethyl citrate or any combination thereof.

21. The fragrance composition of claim 20, wherein the mass ratio of (i) to (ii) is from 55:1 to 45:1 or 52:1 to 47:1.

22. The fragrance composition of claim 20 or claim 21, comprising:
(i) from 95 wt % to 99 wt % of the heteroatom musk compounds; and
(ii) from 1 wt % to 5 wt % of the acyclic musk compound 7,7,8,9,9-pentamethyl-6,7,8,9-tetrahydro-5H-cyclopenta[h]quinazoline, or 2,2,6,6,7,8,8-heptamethyl-3a,5,6,7,8,8b-hexahydro-4H-indeno[4,5-d][1,3]dioxole;
wherein wt % is based on the total weight of the composition.

23. The fragrance composition of any one of claims 20-22, wherein the heteroatom musk compounds are Indeno[4,5-d]-1,3-dioxin,4,4a,5,6,7,8,9,9b-octahydro-7,7,8,9,9-pentamethyl; 1,1,2,3,3-pentamethyl-2,5,6,7-tetrahydroinden-4-one; and 7,7,8,9,9-pentamethyl-6,6a,7,8,9,9a-hexahydro-5H-cyclopenta[h]quinazoline.

24. The fragrance composition of any one of claims 20-23, wherein the composition comprises the heteroatom musk compounds and the acyclic musk compound, wherein:
(i) the heteroatom musk compounds are Indeno[4,5-d]-1,3-dioxin,4,4a,5,6,7,8,9,9b-octahydro-7,7,8,9,9-pentamethyl; 1,1,2,3,3-pentamethyl-2,5,6,7-tetrahydroinden-4-one; and 7,7,8,9,9-pentamethyl-6,6a,7,8,9,9a-hexahydro-5H-cyclopenta[h]quinazoline; and
(ii) the acyclic musk compound is 1-Propanol, 2-[1-(3,3-dimethylcyclohexyl)ethoxy]-2-methyl-, 1-propanoate.

25. The fragrance composition of claim 24, wherein the composition comprises 40 wt % to 45 wt % of Indeno[4,5-d]-1,3-dioxin,4,4a,5,6,7,8,9,9b-octahydro-7,7,8,9,9-pentamethyl; 5 wt % to 15 wt % of 1,1,2,3,3-pentamethyl-2,5,6,7-tetrahydroinden-4-one; 40 wt % to 45 wt % of 7,7,8,9,9-pentamethyl-6,6a,7,8,9,9a-hexahydro-5H-cyclopenta[h]quinazoline; and 0.1 wt % to 5 wt % of 1-Propanol, 2-[1-(3,3-dimethylcyclohexyl)ethoxy]-2-methyl-, 1-propanoate, wherein wt % is based on the total weight of the composition.

26. The fragrance composition of any one of claims 20-23, wherein the composition comprises the heteroatom musk compounds and 7,7,8,9,9-pentamethyl-6,7,8,9-tetrahydro-5H-cyclopenta[h]quinazoline, wherein the heteroatom musk compounds are Indeno[4,5-d]-1,3-dioxin,4,4a,5,6,7,8,9,9b-octahydro-7,7,8,9,9-pentamethyl; 1,1,2,3,3-pentamethyl-2,5,6,7-tetrahydroinden-4-one; and 7,7,8,9,9-pentamethyl-6,6a,7,8,9,9a-hexahydro-5H-cyclopenta[h]quinazoline.

27. The fragrance composition of claim 26, wherein the composition comprises 40 wt % to 45 wt % of Indeno[4,5-d]-1,3-dioxin,4,4a,5,6,7,8,9,9b-octahydro-7,7,8,9,9-pentamethyl; 5 wt % to 15 wt % of 1,1,2,3,3-pentamethyl-2,5,6,7-tetrahydroinden-4-one; 40 wt % to 45 wt % of 7,7,8,9,9-pentamethyl-6,6a,7,8,9,9a-hexahydro-5H-cyclopenta[h]quinazoline; and 0.1 wt % to 5 wt % of 7,7,8,9,9-pentamethyl-6,7,8,9-tetrahydro-5H-cyclopenta[h]quinazoline.

28. The fragrance composition of any one of claims 20-23, wherein the composition comprises the heteroatom musk compounds and 2,2,6,6,7,8,8-heptamethyl-3a,5,6,7,8,8b-hexahydro-4H-indeno[4,5-d][1,3]dioxole, wherein the heteroatom musk compounds are Indeno[4,5-d]-1,3-dioxin,4,4a,5,6,7,8,9,9b-octahydro-7,7,8,9,9-pentamethyl; 1,1,2,3,3-pentamethyl-2,5,6,7-tetrahydroinden-4-one; and 7,7,8,9,9-pentamethyl-6,6a,7,8,9,9a-hexahydro-5H-cyclopenta[h]quinazoline.

29. The fragrance composition of claim 28, wherein the composition comprises 40 wt % to 45 wt % of Indeno[4,5-d]-1,3-dioxin,4,4a,5,6,7,8,9,9b-octahydro-7,7,8,9,9-pentamethyl; 5 wt % to 15 wt % of 1,1,2,3,3-pentamethyl-2,5,6,7-tetrahydroinden-4-one; 40 wt % to 45 wt % of 7,7,8,9,9-pentamethyl-6,6a,7,8,9,9a-hexahydro-5H-cyclopenta[h]quinazoline; and 0.1 wt % to 5 wt % of 2,2,6,6,7,8,8-heptamethyl-3a,5,6,7,8,8b-hexahydro-4H-indeno[4,5-d][1,3]dioxole.

30. The fragrance composition of any one of claims 20-29, wherein the fragrance ingredients are neat fragrances, encapsulated fragrances, or a combination thereof, preferably wherein the encapsulated fragrances are encapsulated by microcapsules having a biodegradability of at least 60 wt % within 60 days according to OECD 301F.

31. The fragrance composition of any one of claims 1-30, wherein the sleep improvement comprises at least one or more sleep benefits selected from the list comprising of improvement in sleep quality, increase in total sleep time, decrease in wake after sleep onset (WASO), decrease in proportion of time awake after sleep onset (% Wake), increase in deep sleep (N3/N4) duration, increase in proportion of time spent in deep sleep (N3/N4), increase in REM sleep duration, increase in proportion of time spent in REM Sleep, increase in light sleep (N1/N2) duration, increase in proportion of time spent in light sleep (N1/N2), increase in sleep efficiency, increase in sleep maintenance, decrease in number of awakenings during sleep, decrease in sleep onset, increase in feeling of being well-rested, increase in feeling of being refreshed upon awakening and/or after wakening, increase in feeling of being recharged, increase in feeling of being ready for the day, or decrease in feeling of daytime sleepiness.

32. The fragrance composition of any one of claims 1-31, further comprising at least 1, at least 2, at least 3, at least 4, at least 5, at least 6, at least 7, at least 8, at least 9 or at least 10 additional fragrance ingredients selected from the group consisting of ALDEHYDE C 10 DECYLIC; ALDEHYDE C 11 UNDECYLENIC; ALDEHYDE C 110 UNDECYLIC; ALDEHYDE C 12 LAURIC; ALDEHYDE C 12 MNA PURE; ALDEHYDE C 8 OCTYLIC FOOD GRADE; ALDEHYDE C 9 ISONONYLIC; ALDEHYDE C 9 NONYLIC FOOD GRADE; ALDEHYDE C 90 NONENYLIC 1%/TEC; ALDEHYDE C12 (DODECANAL); ALDEHYDE ISO C 11; mandarine aldehydes; trans-4-decenal, DECENAL-4-TRANS 10%/TEC; DIHYDROFARNESAL; dodecanal; MYRALDENE; TANGERINOL; Amberketal; AMBERKETAL IPM; Ambermax; Ambrocenide; AMBROFIX; AMBROFIX FLAKES; Belambre; BOISAMBRENE FORTE; CEDRYL ACETATE LIQUID; CEDRYL METHYL ETHER; CETALOX; ISO E SUPER; KARANAL; KEPHALIS; TIMBEROL; TRIMOFIX O; ANIMALIS 1745 SUBST. PMF 2; cade oils, essences, extracts, replacers substitutes; GUAIACOL; INDOFLOR; Indole; Indolene; ANETHOLE; ANISE STAR OIL; ANISIC ALDEHYDE; ANISYL ACETATE; DIHYDRO ANETHOLE; ESTRAGOLE; fennel sweet oils, essences, extracts, bases, replacers or substitutes; FENNEL SWEET DQ (AC) N 41632TT; FENNEL OIL SWEET; and FENNEL OIL SWEET TECH; Benzoin oils, essences, extracts, replacers or substitutes; BENZYL ALCOHOL; BENZYL CINNAMATE; Olibanum oils, essences, extracts, replacers or substitutes; OLIBANUM OIL SOMALIA ORPUR; PHENYL ETHYL PHENYL ACETATE; Armoise oils, essences, extracts, replacers or substitutes; Camphor and Camphor oils, essences, extracts, replacers or substitutes; Eucalyptol and Eucalyptol oils, essences, extracts, replacers or substitutes; Lavandin oils, essences, extracts, replacers or substitutes; Lavender oils, extracts, essences, replacers or substitutes; Rosemary oils, essences, extracts, replacers or substitutes; and Thuja oils, essences, extracts, replacers or substitutes; ACETAL CD; AMYL CINNAMIC ALDEHYDE; AMYL SALICYLATE; AURANTIOL PURE BENZYL ACETATE; BENZYL SALICYLATE; BOURGEONAL; CITRONELLOL; CITRONELLYL ACETATE; CRESYL METHYL ETHER PARA; CYCLAMEN ALDEHYDE EXTRA; CYCLOHEXAL; CYCLOHEXYL SALICYLATE; DIMETHYL ANTHRANILATE; DIMETHYL PHENYL THYL CARBINOL; DUPICAL; ETHYL LINALOOL; FLOROSA; FLOROSA HC; GERANIOL; Geranium oils, essences, extracts, replacers or substitutes; GERANODYLE; GERANYL ACETATE; GERANYL BUTYRATE; HEDIONE; HEDIONE HC; HEXENYL-3-CIS SALICYLATE; HEXYL CINNAMIC ALDEHYDE; HEXYL CINNAMIC ALDEHYDE DQ AC XI 41505TT; HEXYL SALICYLATE; HYDROXYCITRONELLAL; ISOBUTYL PHENYL ACETATE; ISOBUTYL SALICYLATE; JASMATONE; Jasmin oils, essences, extracts, replacers or substitutes; JASMONE CIS; JASMONYL; JASMOPYRANE FORTE; LILIAL and lilial substitutes; LINALOOL; MEFROSOL; METHYL ANTHRANILATE; METHYL ANTHRANILATE EXTRA; METHYL BENZOATE; METHYL PHENYL ACETATE; Neroli oils, essences, extracts, replacers or substitutes; NEROLINE CRYSTALS; NEROLIONE; Orange oils, essences, extracts, replacers or substitutes; ORANGER CRYSTALS; ORANGER FLEUR CREME 1103/20; PELARGOL; PEONILE; PETALIA; PHENYL ETHYL ACETATE; PHENYL ETHYL ALCOHOL; PHENYL ETHYL ISOVALERATE; PHENYL ETHYL SALICYLATE CRYSTALS; ROSACETOL; ROSALVA; Rose oils, essences, extracts, replacers or substitutes; SUPER MUGUET; TERPINEOL PURE; TETRAHYDRO LINALOOL; VERDANTIOL; YARA YARA; Ylang oils, essences, extracts, replacers or substitutes; ACETATE C 6 HEXYLIC; AGRUMEX; ALLYL AMYL GLYCOLATE; ALLYL CAPROATE; ALLYL CYCLOHEXYL PROPIONATE; ALLYL OENANTHATE; AMYL BUTYRATE; APHERMATE; Apple oils, essences, extracts, replacers or substitutes; Banana oils, essences, extracts, replacers or substitutes; BENZYL BUTYRATE; BENZYL ISOBUTYRATE; BENZYL PROPIONATE; BUTYL ACETATE; BUTYRIC ACID; Cassis oils, essences, extracts, replacers or substitutes; COGNAC WHITE OIL EXTRA DQ (AC) 41547TT; CYCLOGALBANATE; DAMASCENONE; DAMASCONE ALPHA; DAMASCONE BETA; DAMASCONE DELTA; DECALACTONE DELTA; DECALACTONE GAMMA; Dewfruit oils, essences, extracts, replacers or substitutes; DIETHYL MALONATE; DIMETHYL BENZYL CARBINYL ACETATE; DIMETHYL BENZYL CARBINYL BUTYRATE; DODECALACTONE DELTA; DODECALACTONE GAMMA; ETHYL ACETOACETATE; ETHYL BUTYRATE; ETHYL CAPROATE; ETHYL CAPRYLATE; ETHYL ISOAMYL KETONE; ETHYL ISOBUTYRATE; ETHYL METHYL-2-BUTYRATE; ETHYL OENANTHATE; ETHYL PELARGONATE; ETHYL PROPIONATE; ETHYL SAFRANATE; FLOROCYCLENE; FRAISTONE; FRUCTONE; FRUITATE; GARDOCYCLENE; GIVESCONE; Guave oils, essences, extracts, replacers or substitutes; HEXENYL-3-CIS BUTYRATE; HEXENYL-3-CIS ISOBUTYRATE; HEXYL BUTYRATE; HEXYL ISOBUTYRATE; ISOAMYL ACETATE EXTRA; ISOAMYL BUTYRATE FR; JASMACYCLENE; MANZANATE; Melon oils, essences, extracts, replacers or substitutes; METHOXY PHENYL BUTANONE; METHYL HEPTENONE PURE; METHYL HEXYL KETONE; METHYL-2-PENTENOIC ACID; 2-NECTARYL; OCTALACTONE GAMMA; PEACH PURE; PHENOXY ETHYL ISOBUTYRATE; PHENYL ETHYL ISOBUTYRATE; PRUNOLIDE; RASPBERRY KETONE (N 112); and STRAWBERRY PURE; AMYL VINYL CARBINOL; OCIMENE; ACETOIN; Acetyl pyrazine; BENZALDEHYDE; BUTYL BUTYRO LACTATE; Chocolate oils, essences, extracts, replacers or substitutes; CORYLONE DRIED; CYCLOTENE; Ethyl maltol; Homofuronol; Hydroxy ethyl methyl thiazol; ISOBUTAVAN; and MALTYL ISOBUTYRATE; ACETAL E; ALCOHOL C 6 HEXYLIC; ALDEHYDE C 6 HEXYLIC FOOD GRADE; BUTYL QUINOLINE SECONDARY; CYCLAL C; DIPHENYL OXIDE; ELINTAAL; ETHYL DECADIENOATE; ETHYL DIMETHYL Pyrazine; Galbanone; GARDENOL; Hexenal-2-trans; HEXENOL-2-TRANS; HEXENOL-3-CIS; HEXENYL-3-CIS ACETATE; HEXENYL-3-CIS BENZOATE; HEXENYL-3-CIS PROPIONATE; ISOCYCLOCITRAL; Isohexylmethoxy pyrazine; LIFFAROME; LIGANTRAAL; MACEAL; METHYL OCTYNE CARBONATE; NEOFOLIONE; Nonadienal; NONADIENOL-2,6; Nonenal-6-cis; NONENOL-6-CIS; Petitgrain oils, essences, extracts, replacers or substitutes; Phenoxyacetaldehyde; Phenyl acetaldehyde; PYRALONE; RESEDAL; ROSE OXIDE; ROSYRANE SUPER; STEMONE; TRICYCLAL; TRIFERNAL; UNDECATRIENE; UNDECAVERTOL; Violet nitrile; VIRIDINE; Basil oils, essences, extracts, replacers or substitutes; Camomile oils, essences, extracts, replacers or substitutes; CITRONELLAL; Clary sage oils, essences, extracts, replacers or substitutes; CYPRISATE; Eucalyptus oils, extracts, essences, replacers or substitutes; HERBOXANE; PINOACETALDEHYDE; TANAISONE; Thyme oils, essences, extracts, replacers or substitutes; THYMOL CRYSTALS; ADOXAL; Azurone; CALONE 1951; FENNALDEHYDE; FLORALOZONE; FLORHYDRAL; MELONAL; SCENTENAL; TROPIONAL; and VERNALDEHYDE; Buchu leaf oils, essences, extracts, replacers or substitutes; CARVONE LAEVO; Cornmint oils, essences, extracts, replacers or substitutes; FRESKOMENTHE; ISOMENTHONE DL; MENTHOL LAEVO; MENTHOL-DL; MENTHONE; MENTHYL ACETATE; Peppermint oils, essences, extracts, replacers or substitutes; and Spearmint oils, essences, extracts, replacers or substitutes; AMBRETTOLIDE; CASHMERAN; COSMONE; Cyclopentadecanolide; ETHYLENE BRASSYLATE; GALAXOLIDE; GALAXOLIDE S; HABANOLIDE; MUSCENONE; MUSK C14; SERENOLIDE; SILVANONE SUPRA; SYLKOLIDE; VELVIONE; CETONE V; DIHYDRO IONONE BETA; IONONE BETA; IRISONE ALPHA; IRISONE PURE; ISORALDEINE 70; ISORALDEINE 95; ORIVONE; Anjeruk; Corps cassis; Corps pamplemousse; Dimethyl sulphide; GARDAMIDE; Labienoxime; Mercaptans; METHYL ISOPROPYL THIAZOLE; Nardozeste oils, essences, extracts, replacers or substitutes; NEOCASPIRENE EXTRA; NONIVAMIDE 1% TRIACETIN; Oxane; PARADISAMIDE; Paramenthone; ACETOPHENONE; AUBEPINE PARA CRESOL; BICYCLO NONALACTONE; COUMARIN; Ethyl laitone; ETHYL VANILLIN; HELIOTROPIN; Vanilla oils, essences, extracts, replacers or substitutes; VANILLIN; Vanolia oils, essences, extracts, replacers or substitutes; VERATRIC ALDEHYDE; BORNEOL; BORNYL ACETATE LIQUID; BUTYL CYCLOHEXANOL PARA; BUTYL CYCLOHEXYL ACETATE PARA; Cedar wood oils, essences, extracts, replacers or substitutes; CONIFERAN; EBANOL; EVERNYL; FENCHYL ACETATE; Guaiac wood oils, essences, extracts, replacers or substitutes; ISONONANYL ACETATE; JAVANOL; KOHINOOL; MENTHANYL ACETATE; METHYL CEDRYL KETONE; NOPYL ACETATE; OSYROL; OXYOCTALINE FORMATE; Patchouli oils, essences, extracts, replacers or substitutes; PINENE ALPHA; PINENE BETA; RADJANOL; RADJANOL SUPER; Turpentine oils, essences, extracts, replacers or substitutes; VERTOFIX COEUR; and Vetiver oils, essences, extracts, replacers or substitutes; ALDEHYDE C12; and MENTHYL ACETATE.

33. The fragrance composition of any one of claims 1-32, wherein the composition is substantially free or essentially free of one or more macrocyclic musk compounds.

34. A consumer product comprising the fragrance composition of any one of claims 1-33, wherein the consumer product is an air care product, home care product, fabric care product, personal care product, a sanitary product, a pet care product, a fine fragrance, a hair care product or a beauty care product.

35. A method for improving at least one sleep benefit to a subject, comprising providing a fragrance composition of any one of claims 1-33 or a consumer product of claim 34 to a subject in an amount effective to improve at least one sleep benefit.

36. The method of claim 35, wherein the at least one sleep benefit is selected from the group consisting of improvement in sleep quality, increase in total sleep time, decrease in wake after sleep onset (WASO), decrease in proportion of time awake after sleep onset (% Wake), increase in deep sleep (N3/N4) duration, increase in proportion of time spent in deep sleep (N3/N4), increase in REM sleep duration, increase in proportion of time spent in REM Sleep, increase in light sleep (N1/N2) duration, increase in proportion of time spent in light sleep (N1/2), increase in sleep efficiency, increase in sleep maintenance, decrease in number of awakenings during sleep, decrease in sleep onset, increase in feeling of being well-rested, increase in feeling of being refreshed upon awakening and/or after awakening, increase in feeling of being recharged, increase in feeling of being ready for the day, decrease in feeling of daytime sleepiness, or any combination thereof.
